(19) United States
(12) Patent Application Publication
(10) Pub. No.: US 2026/0343542 A1
(43) Pub. Date: Oct. 29, 2026

(54) Default Beam Under Multiple Cell Scheduling

(71) Applicant: Ofinno, LLC, Reston, VA (US)

(72) Inventors: Ali Cagatay Cirik, Chantilly, VA (US); Esmael Hejazi Dinan, McLean, VA (US)

(73) Assignee: Ofinno, LLC, Reston, VA (US)

(21) Appl. No.: 19/705,381

(22) Filed: Jun. 11, 2026

Related U.S. Application Data
(63) Continuation of application No. PCT/US2024/059556, filed on Dec. 11, 2024.
(60) Provisional application No. 63/608,426, filed on Dec. 11, 2023.

(51) Int. Cl. H04W 72/1273; H04L 5/00; H04W 72/232

(52) U.S. Cl. CPC H04W 72/1273; H04L 5/0053; H04W 72/232

(57) ABSTRACT

A wireless device receives configuration parameters for a set of cells for multi-cell physical downlink shared channel (PDSCH) scheduling from a serving cell. The configuration parameters include a scheduled cell list parameter identifying possible co-scheduled cells arranged in ascending order of serving cell indexes, and a transmission configuration indication (TCI) list parameter defining a joint TCI table. Each entry in the joint TCI table provides a TCI index for each cell in the set, with the TCI indexes arranged according to the ascending order of the serving cell indexes. The wireless device receives downlink control information (DCI) having a TCI field whose bit length depends on the number of entries in the joint TCI table. The TCI field indicates an entry designating TCI states for one or more serving cells, and the device receives a PDSCH transmission.

### CROSS-REFERENCE TO RELATED APPLICATIONS

This application is a continuation of International Application No. PCT/US2024/059556, filed Dec. 11, 2024, which claims the benefit of U.S. Provisional Application No. 63/608,426, filed Dec. 11, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates an aspect of an example embodiment according to the present disclosure.

FIG. 18 illustrates an aspect of an example embodiment according to the present disclosure.

FIG. 19 illustrates an aspect of an example embodiment according to the present disclosure.

FIG. 20 illustrates a flowchart of an example embodiment according to the present disclosure.

FIG. 21 illustrates an aspect of an example embodiment according to the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect or implement the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

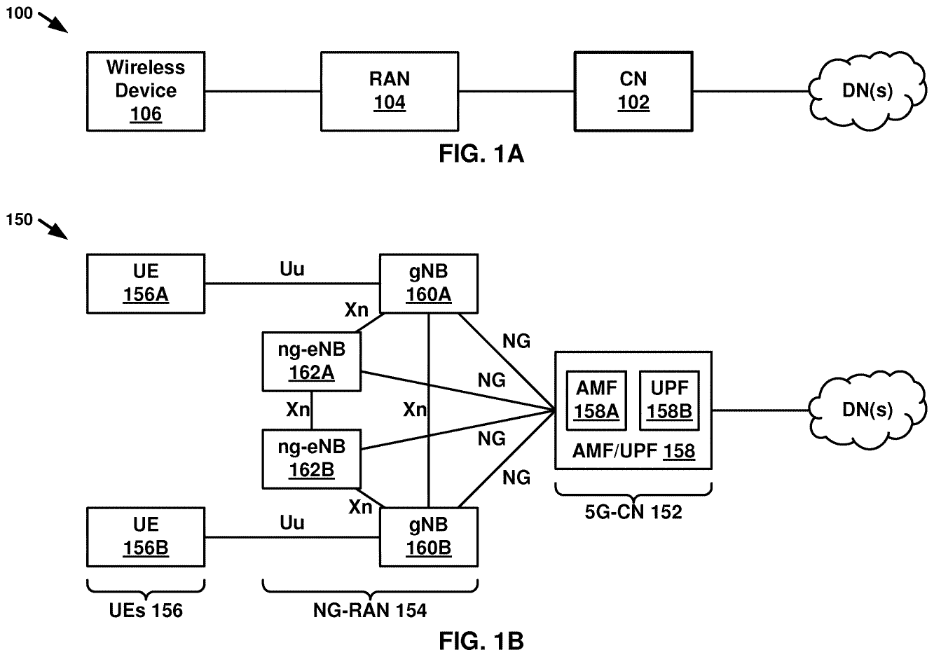

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNS), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

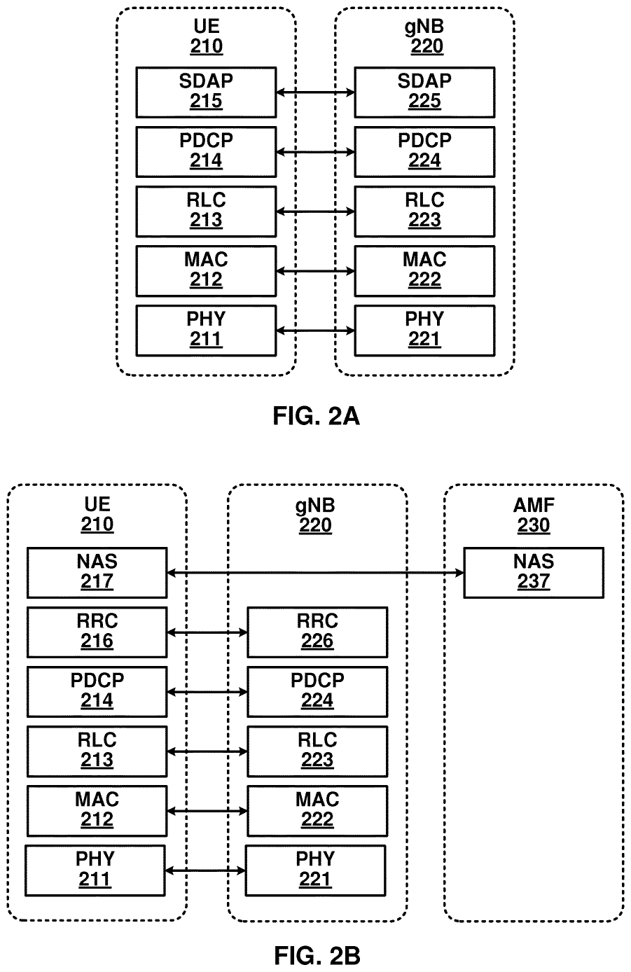

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

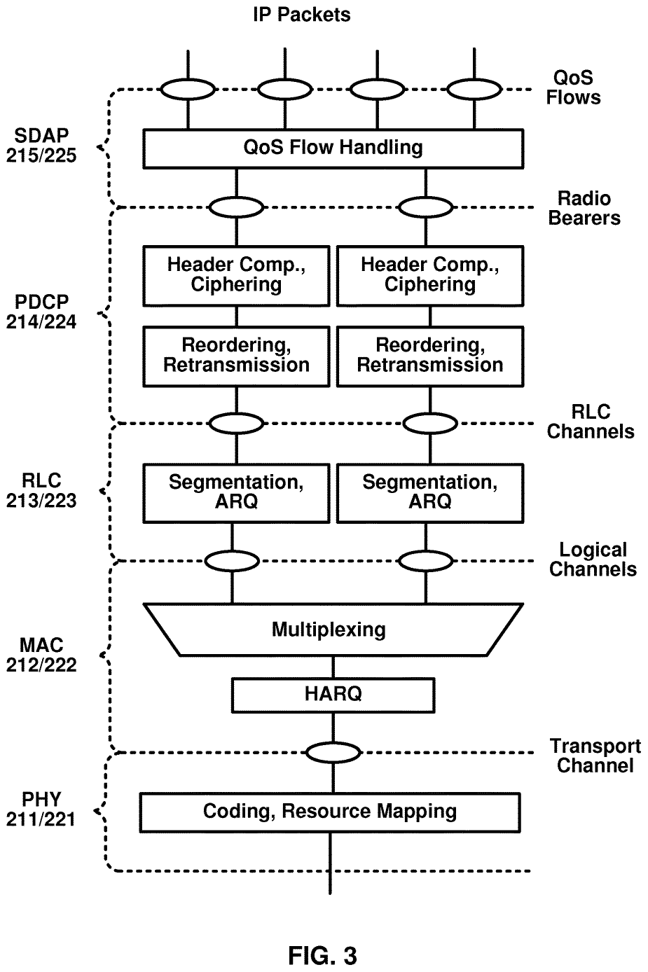

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

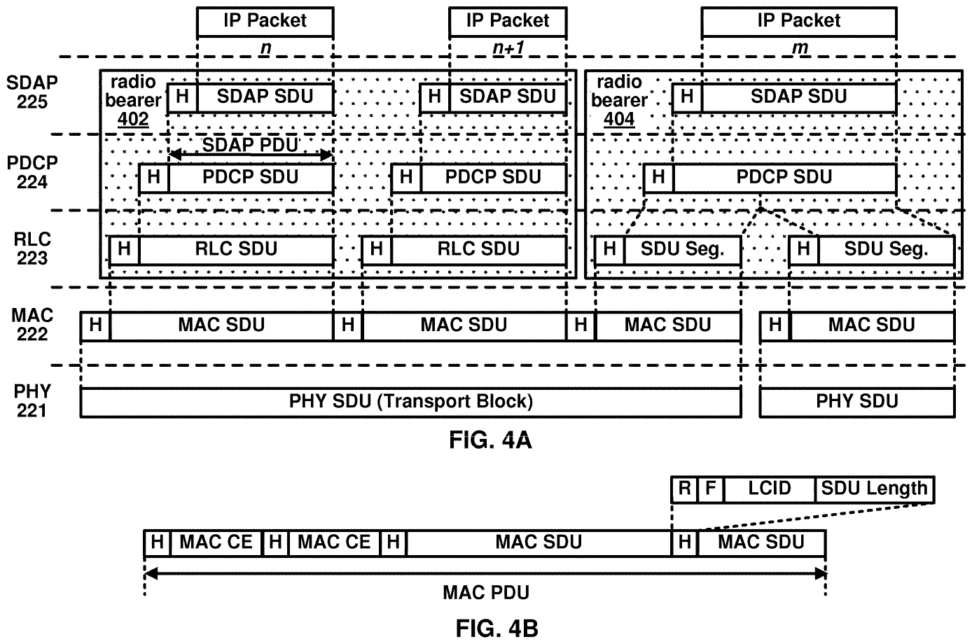

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

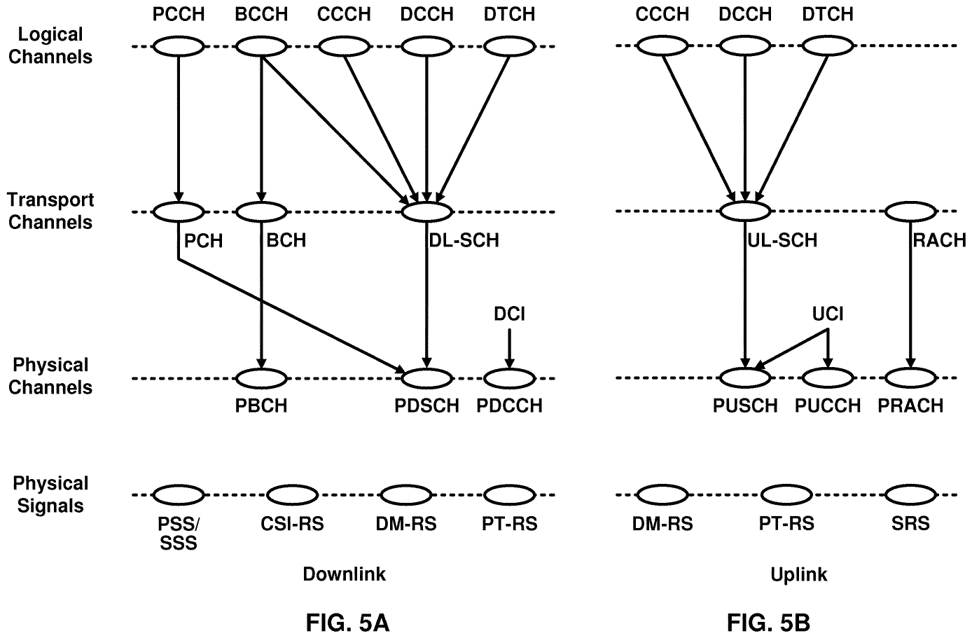

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

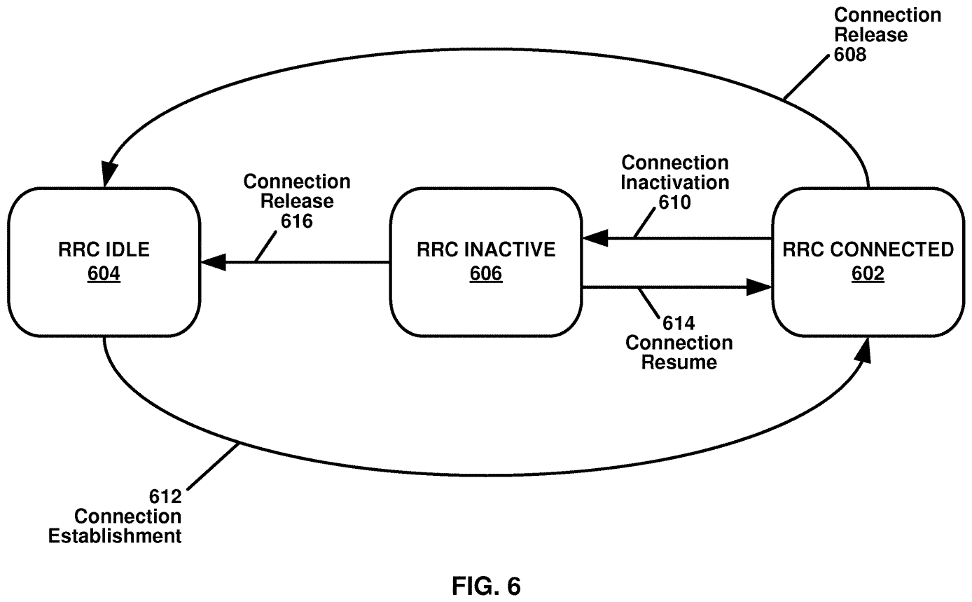

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

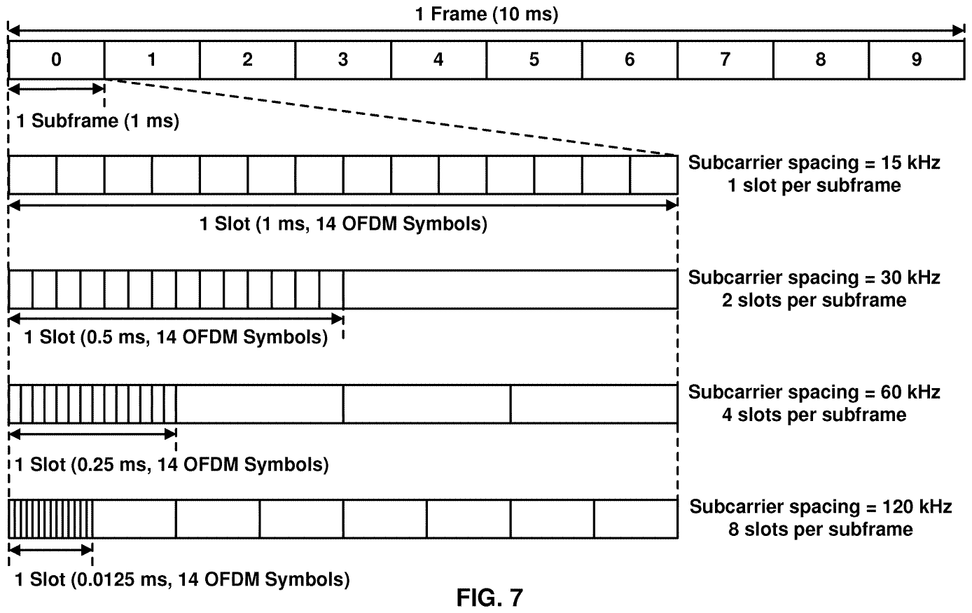

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 KHz/4.7 μs; 30 KHz/2.3 μs; 60 KHz/1.2 μs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 KHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

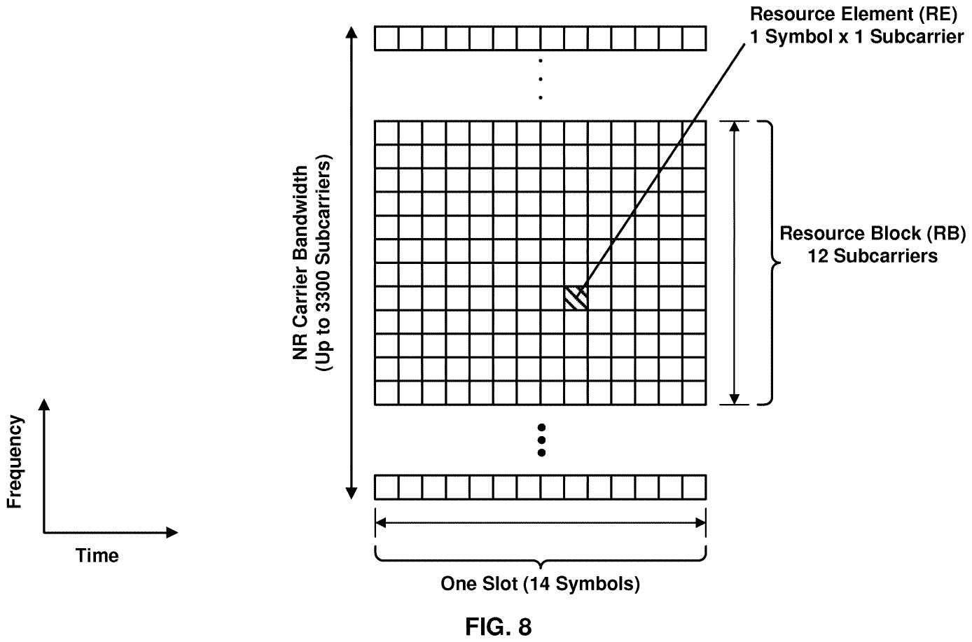

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 KHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

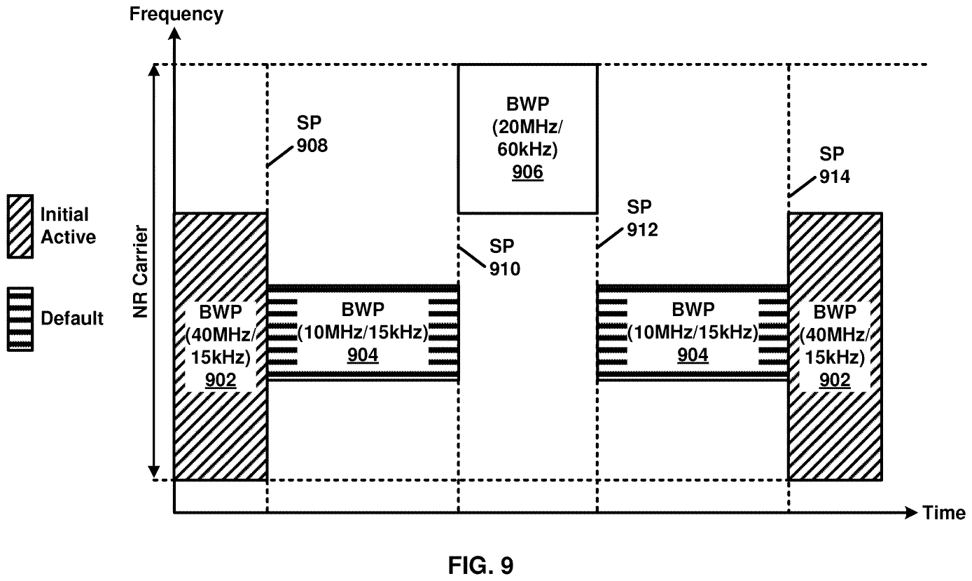

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 KHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

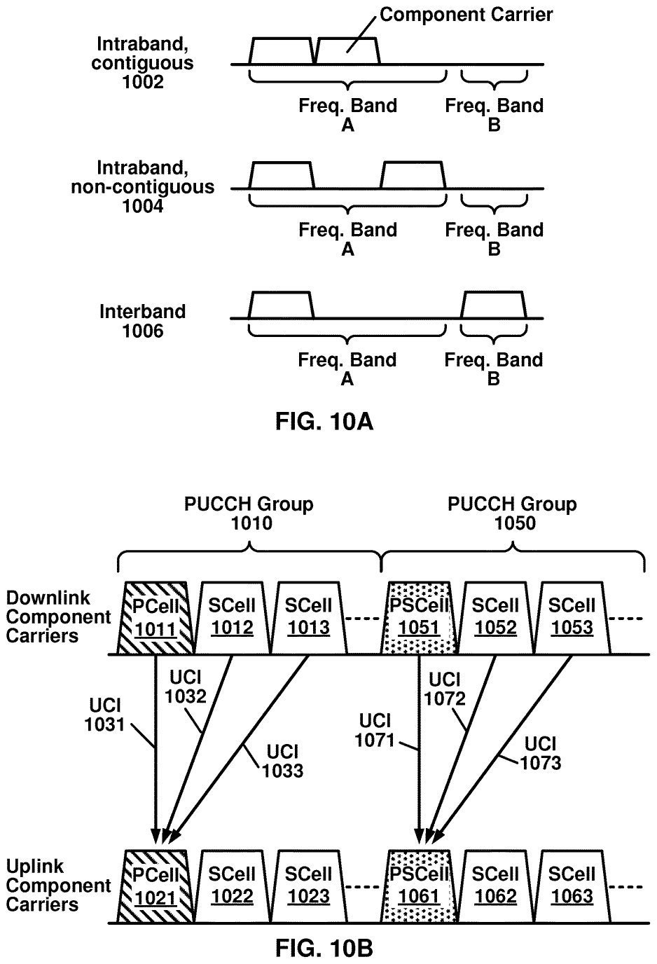

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

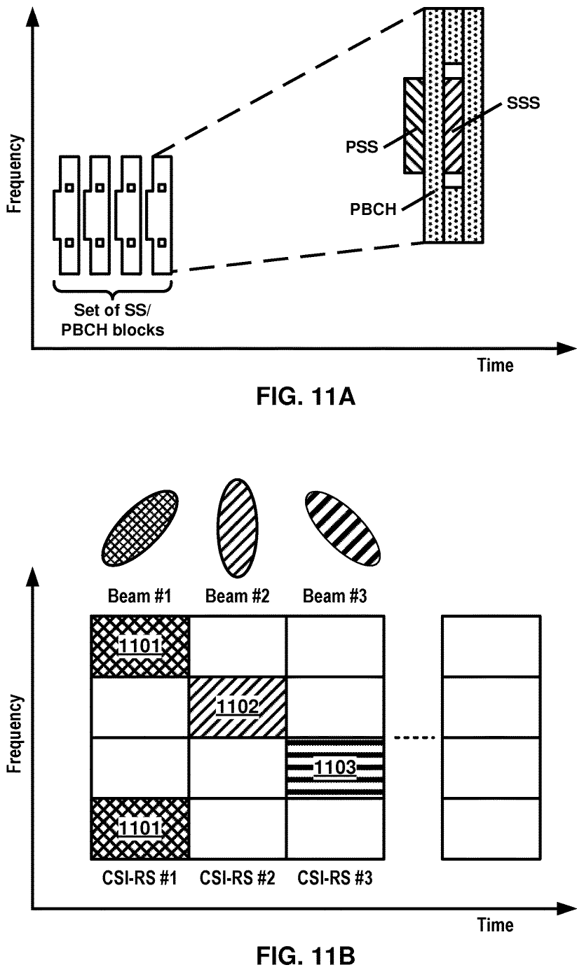

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1,beam #2,and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

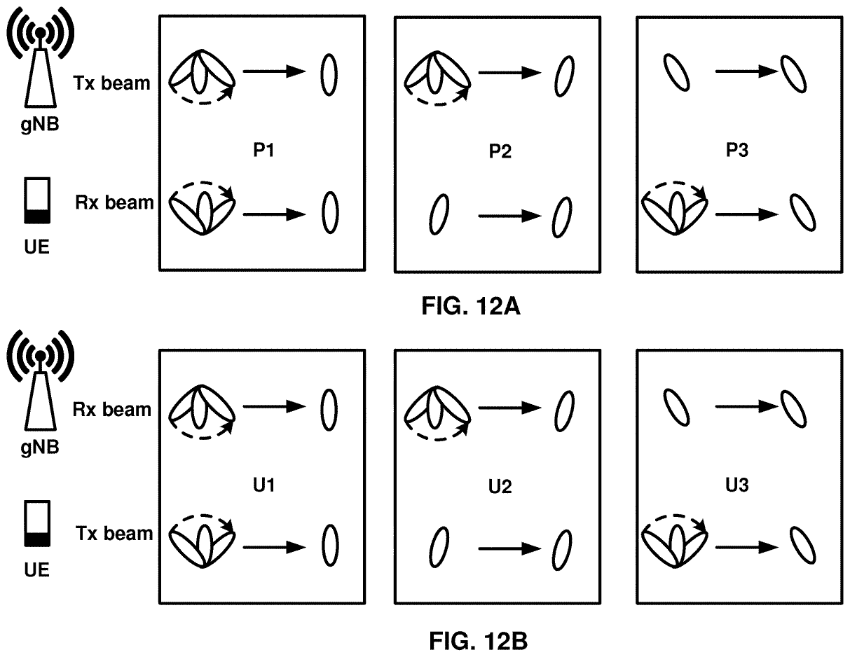

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSS) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

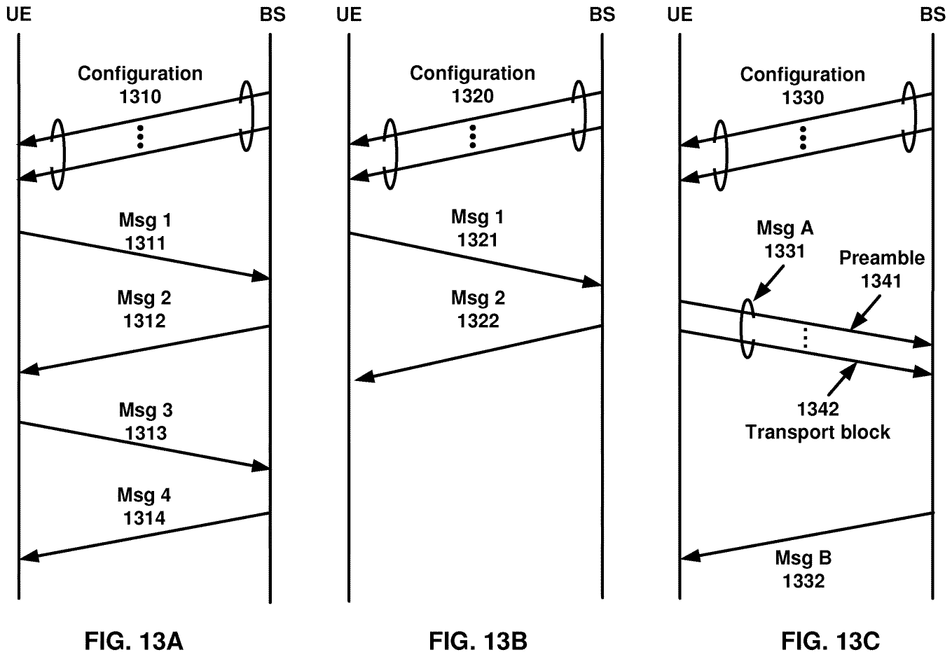

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

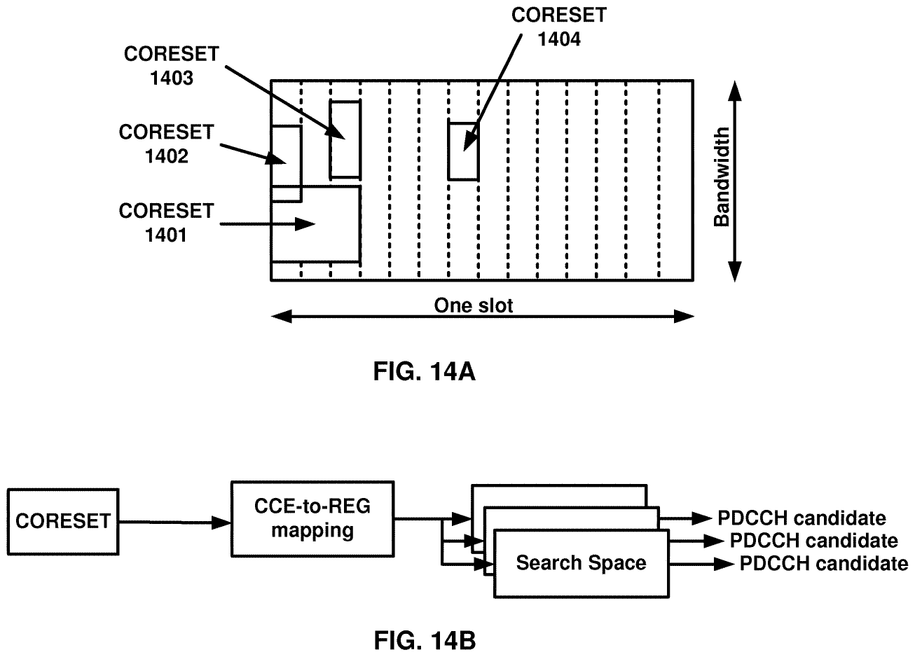

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

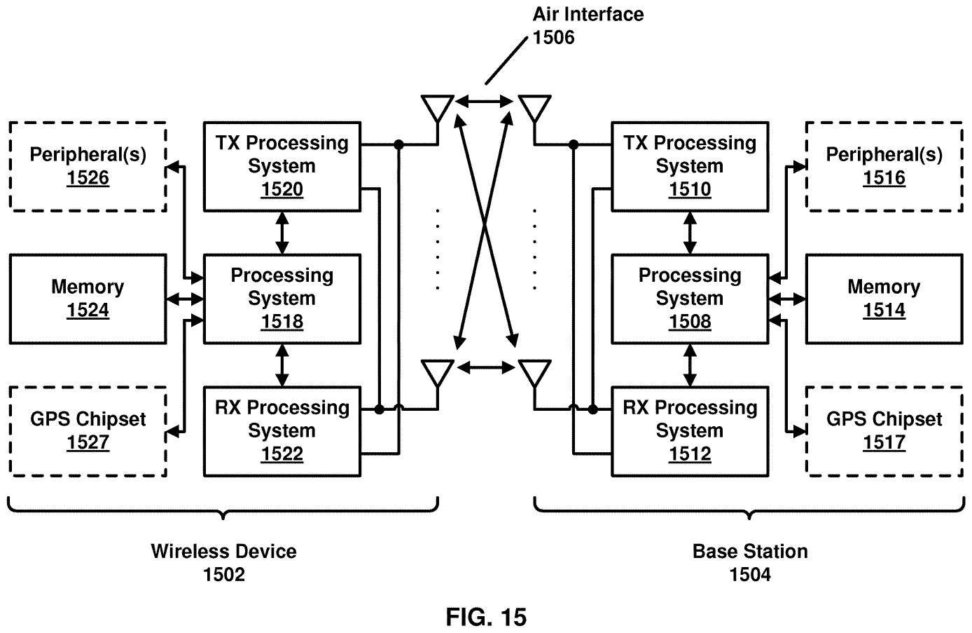

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 maybe associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

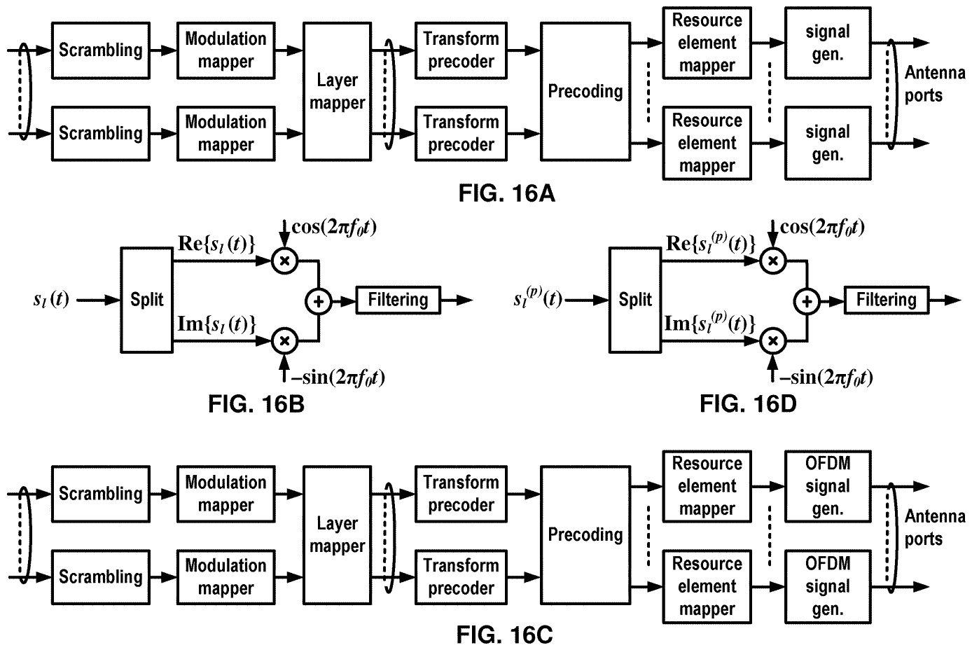

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry (or expiration) of a random access response window timer, the time difference between two time stamps may be used. When a timer is restarted, a process for measurement of time window may be restarted. Other example implementations may be provided to restart a measurement of a time window.

A wireless device may receive, e.g., from a base station, one or more messages (e.g., RRC message(s) comprising one or more configuration parameters.

The wireless device may receive, via a coreset of a first cell, a DCI (e.g., DCI format 1_3, DCI format 0_3) scheduling one or more PDSCH receptions or one or more PUSCH transmissions via one or more cells. For example, the DCI may schedule each PDSCH reception of the one or more PDSCH receptions via a respective cell of the one or more cells. For example, the DCI may schedule each PUSCH transmission of the one or more PUSCH transmissions via a respective cell of the one or more cells.

The one or more cells may be one or more scheduled cells. The first cell may be a scheduling cell.

The DCI may schedule a PDSCH reception of the one or more PDSCH receptions or a PUSCH transmission of the one or more PUSCH transmissions via a cell of the one or more cells.

In an example, the cell may be served by a multiple TRPs comprising a first TRP and a second TRP. The cell may be configured, by the RRC message(s), with a multi-TRP operation comprising the first TRP and the second TRP.

The one or more configuration parameters may indicate, for the cell (or for an active downlink BWP of the cell), at least two coreset pool indexes comprising a first coreset pool index and a second coreset pool index. The first coreset pool index may indicate (or be associated with) the first TRP. The second coreset pool index may indicate (or be associated with) the second TRP.

In an example, the one or more configuration parameters may comprise a higher layer parameter dl-OrJointTCI-StateList. The wireless device may receive a first control command (e.g., MAC-CE, DCI format 1_1/1_2) indicating a first TCI state for the first coreset pool index (or the first TRP). The wireless device may receive a second control command (e.g., MAC-CE, DCI format 1_1/1_2) indicating a second TCI state for the second coreset pool index (or the second TRP).

The wireless device may be indicated with the first TCI state (e.g., a first joint/downlink/uplink TCI state) for (or associated with) the first coreset pool index (or the first TRP) and the second TCI state (e.g., a second joint/downlink/uplink TCI state) for (or associated with) the second coreset pool index (or the second TRP).

In the existing technologies, when the wireless device receives, from the first TRP, a first DCI scheduling a first PDSCH/PUSCH reception/transmission, the wireless device may apply the first TCI state indicated for the first coreset pool index to the first PDSCH/PUSCH reception/transmission. When the wireless device receives, from the second TRP, a second DCI scheduling a second PDSCH/PUSCH reception/transmission, the wireless device may apply the second TCI state indicated for the second coreset pool index to the second PDSCH/PUSCH reception/transmission.

In an example, the first cell that the wireless device receives the DCI may be served by a single TRP. The cell may be served by the two TRPs. In this case, when the wireless device receives the DCI via the first cell served by a single TRP, the wireless device may not know whether to apply the first TCI state of the first TRP or the second TCI state of the second TRP to the PDSCH reception or the PUSCH transmission via the cell.

In an example, the one or more configuration parameters may not comprise a higher layer parameter dl-OrJointTCI-StateList. The DCI may comprise a TCI field. The TCI field may indicate a TCI codepoint for the cell. The wireless device may not know whether the TCI codepoint belongs to the first TRP or the second TRP. The wireless device may not know whether the TCI codepoint indicates a first TCI state among one or more first TCI states activated/indicated for the first coreset pool index (e.g., the first TRP) or a second TCI state among one or more second TCI states activated/indicated for the second coreset pool index (e.g., the second TRP)

When the base station and the wireless device are not aligned on the TCI state used for the PDSCH reception, the wireless device may not receive the PDSCH reception successfully. This may increase the error rate and reduce data rate leading to increased latency.

When the base station and the wireless device are not aligned on the TCI state used for the PUSCH transmission, the base station may not receive the PUSCH transmission successfully. This may increase the error rate and reduce data rate leading to increased latency.

The example embodiments enhance PDSCH reception or a PUSCH transmission via a cell when the wireless device receives a DCI scheduling one or more cells comprising the cell.

The wireless device may apply a TCI state of a coreset pool index among the two coreset pool indexes to the PDSCH reception or to the PUSCH transmission.

In an example embodiment, the TCI state may be, for example, the first TCI state indicated for the first coreset pool index. The TCI codepoint may indicate, for example, the first TCI state among the one or more first TCI states activated for the first coreset pool index.

In an example embodiment, the TCI state may be, for example, a TCI state indicated for the coreset pool index of the coreset that the wireless device receives the DCI. For example, the TCI state may be the first TCI state when the coreset pool index of the coreset is equal to the first coreset pool index. The TCI state may be the second TCI state when the coreset pool index of the coreset is equal to the second coreset pool index. The TCI codepoint may indicate, for example, a TCI state among one or more TCI states activated for the coreset pool index of the coreset that the wireless device receives the DCI.

In an example embodiment, the one or more configuration parameters may comprise a parameter (e.g., applyIndicatedTCIState, applyIndicatedTCIState-DCI-0-3, applyIndicatedTCIState-DCI-1-3) with a value (e.g., 0, 1, ‘first’, ‘second’) indicating which TCI state to apply to the PDSCH reception or to the PUSCH transmission. For example, when the parameter is set to a first value (e.g., 0, ‘first’), the wireless device may apply the first TCI state of the first coreset pool index to the PDSCH reception or to the PUSCH transmission. The TCI codepoint may indicate, for example, the first TCI state among the one or more first TCI states activated for the first coreset pool index. When the parameter is set to a second value (e.g., 1, ‘second’), the wireless device may apply the second TCI state of the second coreset pool index to the PDSCH reception or to the PUSCH transmission. The TCI codepoint may indicate, for example, the second TCI state among the one or more second TCI states activated for the second coreset pool index.

The example embodiments may reduce the error rate and increased data rate leading to reduced latency.

In the existing technologies, when a CSI-RS resource and a coreset (or a search space set of a coreset) overlap in time, the wireless device may apply one or more quasi co-location parameters (e.g., spatial receiving filter/beam, doppler spread, delay spread, channel properties, and the like) of the coreset to a reception of a CSI-RS via the CSI-RS resource.

The one or more quasi co-location parameters may be (or may be interchangeably used with) a TCI state.

At least one DM-RS antenna port of a PDCCH reception via the coreset may be quasi co-located with the CSI-RS.

In the existing technologies, when a CSI-RS resource and a coreset (or a search space set of a coreset) overlap in time, the base station may configure/activate/indicate the same quasi co-location parameters (e.g., spatial receiving filter/beam, doppler spread, delay spread, channel properties, and the like) for both the coreset and the CSI-RS resource. The base station may make sure the same quasi co-location parameters (e.g., spatial receiving filter/beam, doppler spread, delay spread, channel properties, and the like) for both the coreset and the CSI-RS resource.

The existing technologies may not be efficient, for example, when a CSI-RS resource and at least two coresets (or at least two search spaces set of at least two coresets) overlap in time. The at least two coresets may comprise a first coreset and a second coreset.

The first coreset and the second coreset may overlap in time, for example, for PDCCH repetition. The first coreset and the second coreset may be linked for PDCCH repetition. A first search space set of the first coreset and a second search space set of the second coreset may be linked for PDCCH repetition.

The first coreset and the second coreset may overlap in time, for example, when the one or more configuration parameters indicate the first coreset pool index for the first coreset and the second coreset pool index for the second coreset.

In an example, the wireless device may not know whether to apply one or more first quasi co-location parameters of the first coreset or one or more second quasi co-location parameters of the second coreset to a reception of a CSI-RS via the CSI-RS resource.

In an example, the base station may not make sure the same quasi co-location parameters (e.g., spatial receiving filter/beam, doppler spread, delay spread, channel properties, and the like) for each of the at least two coreset and the CSI-RS resource.

When the base station and the wireless device are not aligned on the quasi co-location parameters (or the TCI state) used for the CSI-RS, the wireless device may not receive/measure the CSI-RS accurately. This may increase channel estimation error and/or wrong scheduling decisions which may result in increased error rate and reduced data rate and increased latency.

The example embodiments may enhance CSI-RS reception when a CSI-RS resource overlaps in time with at least two coresets.

In an example embodiment, the wireless device may apply one or more quasi co-location parameters, of a default coreset among the first coreset and the second coreset, to reception of the CSI-RS via the CSI-RS resource.

In an example embodiment, the wireless device may apply one or more quasi co-location parameters, of a coreset with a lowest coreset index among a first coreset index of the first coreset and a second coreset index of the second coreset, to reception of the CSI-RS via the CSI-RS resource.

In an example embodiment, the wireless device may apply the one or more first quasi co-location parameters of the first coreset to reception of the CSI-RS via the CSI-RS resource. The wireless device may not apply the one or more second quasi co-location parameters of the second coreset to reception of the CSI-RS via the CSI-RS resource.

The example embodiments may reduce channel estimation error and/or wrong scheduling decisions which may result in reduced error rate and increased data rate and reduced latency.

A wireless device may be configured with a list of TCI states (e.g., TCI-State) within/by a higher layer parameter PDSCH-Config to decode PDSCH according to a detected PDCCH with DCI intended for the wireless device and a given cell (e.g., a given serving cell, a given non-serving/candidate/target cell). A number of TCI states in the list may depend on a UE capability parameter maxNumberConfiguredTCIstatesPerCC. Each TCI state (e.g., TCI-State) may contain/comprise/include/indicate/have respective parameters for configuring a quasi co-location relationship between one or two downlink reference signals and DM-RS port(s) of a PDSCH, a DM-RS port of a PDCCH, or CSI-RS port(s) of a CSI-RS resource. The quasi co-location relationship may be configured by a higher layer parameter qcl-Type1 for a first downlink reference signal of the one or more downlink reference signals. The quasi co-location relationship may be configured by a higher layer parameter qcl-Type2 for a second downlink reference signal of the one or more downlink reference signals. When two downlink reference signals comprising a first downlink reference signal and a second downlink reference signal are indicated by a TCI state, QCL types of the two downlink reference signals may not be the same, regardless of whether the first downlink reference signal and the second downlink reference signal are the same or different. A quasi co-location type corresponding to a downlink reference signal of the one or more downlink reference signals may be given by a higher layer parameter qcl-Type in a higher layer parameter QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

A wireless device may be configured with a list of TCI states (e.g., up to 128 TCI-State configurations) within/by a higher layer parameter dl-OrJointTCI-StateList in PDSCH-Config. A TCI state in the list of TCI states may provide/indicate a reference signal for a quasi co-location for i) DM-RS of a PDSCH, ii) DM-RS of a PDCCH in a BWP/cell, and/or iii) a CSI-RS. A TCI state in the list of TCI states may provide/indicate a reference signals for determining uplink transmission spatial filter for i) a dynamic-grant PUSCH, ii) a configured-grant based PUSCH, iii) a PUCCH resource in a BWP/cell, and/or, iv) an SRS.

A wireless device may receive an activation command (e.g., MAC-CE, DCI, Unified TCI States Activation/Deactivation MAC-CE, Enhanced Unified TCI States Activation/Deactivation MAC-CE, The Enhanced Unified TCI States Activation/Deactivation MAC-CE for Joint TCI State Mode, Enhanced Unified TCI States Activation/Deactivation MAC-CE for Separate TCI State Mode, and the like) used to map up to a number TCI states and/or pairs of TCI states (e.g., up to 8 TCI states and/or pairs of TCI states), with one TCI state for downlink channels/signals and/or one TCI state for uplink channels/signals, to codepoint(s) of a DCI field ‘Transmission Configuration Indication’ for one cell or for a set of cells/downlink BWPs, and/or up to a number of sets of TCI states (e.g., up to 8 sets of TCI states). Each set of the number of sets may be comprised of up to a number of TCI state(s) for downlink and uplink signals/channels (e.g., up to two TCI state(s)), or up to a number of TCI state(s) (e.g., up to two TCI state(s) for downlink channels/signals and up to a number of TCI state(s) (e.g., up to two TCI state(s) for uplink channels/signals to codepoint(s) of a DCI field ‘Transmission Configuration Indication’ for one cell or for a set of cells/downlink BWPs, and if applicable, for one cell or for a set of cells/uplink BWPs. When a set of TCI state IDs are activated, by the activation command, for a set of cells/downlink BWPs and if applicable, for a set of cells/uplink BWPs, where the applicable list of cells may be determined, by the wireless device, by an indicated cell in the activation command, the (same) set of TCI state IDs may be applied by the wireless device to/for all downlink and/or uplink BWPs in the indicated cells (or the applicable list of cells). If the activation command maps TCI-State(s) and/or TCI-UL-State(s) to only one (or to a single) TCI codepoint, the wireless device may apply the (indicated) TCI-State(s) and/or TCI-UL-State(s) to one cell or to a set of cells/downlink BWPs, and if applicable, to one cell or to a set of cells/uplink BWPs once the indicated mapping for the one single TCI codepoint is applied by the wireless device.

When tci-PresentInDCI is set as ‘enabled’ or tci-PresentDCI-1-2 is configured for a CORESET, a wireless device 1) configured with dl-OrJointTCI-StateList by one or more configuration parameters (e.g., RRC messages/parameters) and activated with TCI-State by the activation command, or 2) configured with ul-TCI-StateList by one or more configuration parameters (e.g., RRC messages/parameters) and activated with TCI-UL-State by the activation command may receive a DCI format (e.g., DCI format 1_1/1_2) providing/indicating TCI state(s) (e.g., TCI-State(s) and/or TCI-UL-State(s)) for a cell or all cells in the same cell list configured by a simultaneous TCI update parameter (e.g., simultaneousU-TCI-UpdateList1, simultaneousU-TCI-UpdateList2, simultaneousU-TCI-UpdateList3, simultaneousU-TCI-UpdateList4). The DCI format may be with or without a downlink assignment. The simultaneous TCI update parameter may be a higher layer parameter (e.g., RRC parameter).

When a wireless device configured with dl-OrJointTCI-StateList by one or more configuration parameters (e.g., RRC messages/parameters) transmits an uplink transmission (e.g., a PUCCH transmission, a PUSCH transmission) with a positive HARQ-ACK corresponding to the DCI format indicating the indicated TCI state(s) (e.g., TCI-State(s) and/or TCI-UL-State(s), and if the indicated TCI State(s) is/are different from the previously indicated TCI state(s), the indicated TCI-State(s) may be applied, by the wireless device, starting from a first/starting/earliest slot that is at least a number of symbols (e.g., beamAppTime symbols) after the last symbol of the uplink transmission. The first/starting/earliest slot and the number of symbols may be both determined, by the wireless device, based on an active BWP with the smallest subcarrier spacing among BWP(s) of the cells applying the indicated TCI-State(s) that are active at the end of the uplink transmission carrying/with the positive HARQ-ACK. The number of symbols may be indicated/provided to the wireless device by RRC messages (e.g., one or more configuration parameters).

When a wireless device supports two TCI states in a codepoint of a DCI field ‘Transmission Configuration Indication’, the wireless device may receive an activation command (e.g., MAC-CE, DCI) used to map up to 8 combinations of one or two TCI states to codepoint(s) of the DCI field ‘Transmission Configuration Indication’. The wireless device may not expect to receive more than 8 TCI states in the activation command.

When a wireless device is configured by a higher layer parameter cjtSchemePDSCH and di-OrJointTCI-StateList, and is indicated with two TCI states applied for a PDSCH reception and/or reports support for two joint TCI states for PDSCH-CJT:
if the wireless device is configured with a higher layer parameter cjtSchemeA, the wireless device may assume that PDSCH DM-RS port(s) of the PDSCH reception are quasi co-located (QCL-ed) with downlink reference signals of both of the two indicated TCI states with respect to QCL-TypeA.
if the wireless device is configured with a higher layer parameter cjtSchemeB, the wireless device may assume that PDSCH DM-RS port(s) of the PDSCH reception are quasi co-located (QCL-ed) with downlink reference signals of both of the two indicated TCI states with respect to QCL-TypeA except for QCL parameters {Doppler shift, Doppler spread} of a second indicated TCI state (e.g., second joint TCI state) of the two (indicated) TCI states.

When a wireless device is configured with a higher layer parameter dl-OrJointTCI-StateList or a higher layer parameter TCI-UL-State and is configured by/with a higher layer parameter PDCCH-Config that contains two different values (e.g., 0 and 1) of coresetPoolIndex in ControlResourceSet, an indicated TCI state is specific to a coresetPoolIndex value (e.g., 0 or 1), when the indicated TCI state is indicated by a DCI field ‘Transmission Configuration Indication’ in a DCI format 1_1/1_2 associated with the coresetPoolIndex value. The DCI format 1_1/1_2 may be associated with the coresetPoolIndex value when the DCI format 1_0/1_1/1_2 is received/detected, by the wireless device, in a CORESET associated with the coresetPoolIndex value.

When a wireless device is configured with a higher layer parameter di-OrJointTCI-StateList and is having two indicated TCI states, if the wireless device does not report its capability of two default beams in frequency range 2 and when an offset between the reception of a scheduling/activation DCI format 1_0/1_1/1_2 and a scheduled or activated PDSCH reception is less than a threshold (e.g. timeDurationForQCL) in frequency range 2, the wireless device may apply a first indicated TCI state of the two indicated TCI states to the scheduled or activated PDSCH reception.

When a wireless device is configured with a higher layer parameter dl-OrJointTCI-StateList and is having two indicated TCI states (e.g., two indicated joint/DL TCI states) comprising a first TCI state and a second TCI state:
Regardless of a time/scheduling offset between reception of a DCI format 1_0/1_1/1_2 and a PDSCH reception scheduled/activated by the DCI format 1_0/1_1/1_2, if the wireless device is in frequency range 1 (FR1), or the wireless device reports a capability of two default beams in frequency range 2 (FR2), or
If the wireless device does not report a capability of two default beams in FR2 and if a time/scheduling offset between reception of a DCI format 1_0/1_1/1_2 and a PDSCH reception scheduled/activated by the DCI format 1_0/1_1/1_2 is equal to or larger than a threshold (e.g., timeDurationForQCL)
The wireless device may be configured by a higher layer parameter applyIndicatedTCIState to indicate whether the first TCI state, the second TCI state, or both of the two indicated TCI states is/are applied to the PDSCH reception scheduled or activated by the DCI format 1_0. The higher layer parameter applyIndicatedTCIState may be one of values={‘first’, ‘second’, ‘both’}. The wireless device may be configured with the higher layer parameter applyIndicatedTCIState with a value set to ‘both’ only when the wireless device is configured with a higher layer parameter cjtSchemePDSCH and/or the wireless device reports support for two joint TCI states for PDSCH-CJT, or when the wireless device is configured with a higher layer parameter sfnSchemePdsch. When the value of the higher layer parameter applyIndicatedTCIState is set to ‘both’, the wireless device may apply both of the two indicated TCI states to the PDSCH reception scheduled or activated by the DCI format 1_0 on a search space set other than Type0/0A/2 CSS set on/of a CORESET with index zero (e.g., CORESET #0). The wireless device may receive the DCI format 1_0 on/via the search space set different from the Type0/0A/2 CSS set associated with the CORESET with index zero.
If the wireless device is not configured with applyIndicatedTCIState, the first indicated TCI-state is applied to PDSCH reception scheduled or activated by DCI format 1_0.
When the wireless device is configured with a higher layer parameter tciSelection-PresentInDCI and when the wireless device receives a DCI format 1_1/1_2 that schedules or activates a PDSCH reception in/via PDSCH transmission occasions(s), the wireless device may determine, for the PDSCH reception, indicated TCI state(s) (e.g., indicated joint/DL TCI state(s)) among the two indicated TCI states according to the following:
If the DCI format 1_1/1_2 indicates codepoint “00” for a TCI selection field, the wireless device may apply the first TCI state of the two indicated TCI states to all PDSCH DM-RS port(s) of the PDSCH transmission occasions(s) of the PDSCH reception scheduled or activated by the DCI format 1_1/1_2.
If the DCI format 1_1/1_2 indicates codepoint “01” for a TCI selection field, the wireless device may apply the second TCI state of the two indicated TCI states to all PDSCH DM-RS port(s) of the PDSCH transmission occasions(s) of the PDSCH reception scheduled or activated by the DCI format 1_1/1_2.
If the DCI format 1_1/1_2 indicates codepoint “10” for a TCI selection field, the wireless device may apply both of the two indicated TCI states to the PDSCH reception scheduled or activated by the DCI format 1_1/1_2.
If the wireless device is not configured with a higher layer parameter tciSelection-PresentInDCI and when the wireless device receives a DCI format 1_1/1_2 that schedules/activates a PDSCH reception, the wireless device may apply both of the two indicated TCI states to the PDSCH reception scheduled or activated by the DCI format 1_1/1_2. In an example, the wireless device may expect to be configured with a higher layer parameter tciSelection-PresentInDCI when/if the wireless device does not report/support a capability of using a default beam for SFN (e.g., sfn-DefaultDL-BeamSetup) for a DCI format, scheduling a PDSCH reception, without a TCI selection field. In an example, the base station may transmit, to the wireless device, one or more configuration parameters (e.g., in RRC message(s)) comprising the higher layer parameter tciSelection-PresentInDCI when/if the base station does not receive, from the wireless device, a report (e.g., a UE capability message) indicating support/capability of using a default beam for SFN (e.g., sfn-DefaultDL-Beam Setup) for a DCI format, scheduling a PDSCH reception, without a TCI selection field. In an example, the base station may or may not transmit, to the wireless device, one or more configuration parameters (e.g., in RRC message(s)) comprising a higher layer parameter tciSelection-PresentInDCI when/if the base station receives, from the wireless device, a report (e.g., a UE capability message) indicating support/capability of using a default beam for SFN (e.g., sfn-DefaultDL-Beam Setup) for a DCI format, scheduling a PDSCH reception, without a TCI selection field.
The higher layer parameter applyIndicatedTCIState for indicating whether the first TCI state, the second TCI state, or both of the two indicated TCI states is/are applied to a PDSCH reception scheduled/activated by a DCI format 1_0 may be provided/indicated, to the wireless device, per downlink BWP.

When a wireless device is configured/indicated, by a base station, with a higher layer parameter di-OrJointTCI-StateList or a higher layer parameter TCI-UL-State and is having two indicated TCI states (or two indicated uplink TCI states) comprising a first indicated TCI state and a second indicated TCI state:
the wireless device having a PUSCH transmission scheduled or activated by a DCI format 0_0 may apply the first indicated TCI state to the PUSCH transmission, the wireless device configured, by the base station, with a PUSCH transmission corresponding to a Type 1 configured grant may be expected to be configured with a higher layer parameter applyIndicatedTCIState.
If the higher layer parameter applyIndicatedTCIState is set to ‘first’, the wireless device may apply the first indicated TCI state to the PUSCH transmission. The wireless device may apply the first indicated TCI state to each PUSCH transmission occasion of the PUSCH transmission.
If the higher layer parameter applyIndicatedTCIState is set to ‘second’, the wireless device may apply the second indicated TCI state to the PUSCH transmission. The wireless device may apply the second indicated TCI state to each PUSCH transmission occasion of the PUSCH transmission.
If the higher layer parameter applyIndicatedTCIState is set to ‘both’, the wireless device may apply the both of the two indicated TCI states to the PUSCH transmission. If the higher layer parameter applyIndicatedTCIState is set to ‘both’ (or if both of the two indicated TCI states are indicated to be applied for the PUSCH transmission), the wireless device may apply:
the first indicated TCI state to PUSCH transmission occasion(s) or PUSCH antenna port(s), of the PUSCH transmission, associated with a first SRS resource set for codebook/non-codebook transmission, and
the second indicated TCI state to PUSCH transmission occasion(s) or PUSCH antenna port(s), of the PUSCH transmission, associated with a second SRS resource set for codebook/non-codebook transmission.
If the wireless device is configured/indicated, by the base station, by a higher layer parameter PDCCH-Config that contains/comprises two different values of a higher layer parameter coresetPoolIndex in different ControlResourceSets, the first indicated TCI state and the second indicated TCI state may be specific to a higher layer parameter coresetPoolIndex with value 0 and a higher layer parameter coresetPoolIndex with value 1, respectively. If the wireless device is configured/indicated, by the base station, by a higher layer parameter PDCCH-Config that contains/comprises two different values of a higher layer parameter coresetPoolIndex in different ControlResourceSets, the higher layer parameter applyIndicatedTCIState may not be set to ‘both’ indicating both of the two indicated TCI states to be applied for the PUSCH transmission

When a wireless device is configured with a higher layer parameter dl-OrJointTCI-StateList, is configured by a higher layer parameter PDCCH-Config that contains two different values of coresetPoolIndex in ControlResourceSet, if the wireless device does not report its capability of default beam per coresetPoolIndex in frequency range 2:
when an offset between reception of a DCI format 1_0/1_1/1_2 in a CORESET associated with a coresetPoolIndex value equal to 0 and a PDSCH reception scheduled/activated by the DCI format 1_0/1_1/1_2 is less than a threshold (e.g., timeDurationForQCL) in frequency range 2, the wireless device may apply an indicated joint/DL TCI state specific to the coresetPoolIndex value equal to 0 to the scheduled/activated PDSCH reception.
the wireless device may not expect that an offset between reception of a DCI format 1_0/1_1/1_2 in a CORESET associated with a coresetPoolIndex value equal to 1 and a PDSCH reception scheduled/activated by the DCI format 1_0/1_1/1_2 is less than the threshold (e.g., timeDurationForQCL) in frequency range 2.

When a wireless device is configured with a higher layer parameter dl-OrJointTCI-StateList and is having two indicated TCI states (e.g., two indicated joint/DL TCI states) comprising a first TCI state and a second TCI state, the wireless device may be configured/provided with/by a higher layer parameter applyIndicatedTCIState per/for/to an aperiodic CSI-RS resource set or an aperiodic CSI-RS resource in an aperiodic CSI-RS resource set to inform that the wireless device applies the first TCI state or the second TCI state to the aperiodic CSI-RS resource set or to the aperiodic CSI-RS resource in the aperiodic CSI-RS resource set. The wireless device may be configured with a higher layer parameter followUnifiedTCIState for the aperiodic CSI-RS resource set for CSI or beam management (BM). A time/scheduling offset between the last symbol of a PDCCH carrying/with a DCI and a first/starting/earliest symbol of the aperiodic CSI-RS resource in the aperiodic CSI-RS resource set triggered by the DCI may be equal to or larger than a threshold (e.g., beam Switch Timing).

If the wireless device is configured by a higher layer parameter PDCCH-Config that contains/comprises two different values of a higher layer parameter CORESETPoolIndex in different CORESETS (e.g., ControlResourceSets), the first TCI state and the second TCI state may correspond to the two indicated TCI states specific to a higher layer parameter coresetPoolIndex with value 0 and a higher layer parameter coresetPoolIndex with value 1, respectively.

When a wireless device is configured with a higher layer parameter dl-OrJointTCI-StateList and is having two indicated TCI states (e.g., two indicated joint/DL TCI states) comprising a first TCI state and a second TCI state, and if a time/scheduling offset between the last symbol of a PDCCH carrying/with a DCI and a first/starting/earliest symbol of an aperiodic CSI-RS resource in an aperiodic CSI-RS resource set triggered by the DCI is smaller than a threshold (e.g., beam Switch Timing):
If there is no downlink signal in the same symbols as the aperiodic CSI-RS resource:
if the wireless device is in frequency range 1 (FR1), or the wireless device reports a capability of two default beams in frequency range 2 (FR2), the wireless device may apply the first TCI state or the second TCI state to an aperiodic CSI-RS via the aperiodic CSI-RS resource based on (or according to) a higher layer parameter applyIndicatedTCIState provided/indicated to/for the aperiodic CSI-RS resource or to the aperiodic CSI-RS resource set comprising the aperiodic CSI-RS resource.
Otherwise, the wireless device may apply the first TCI state to an aperiodic CSI-RS via the aperiodic CSI-RS resource.
else if there is a downlink signal with an indicated TCI state in the same symbols as the aperiodic CSI-RS resource, the wireless device may apply a QCL assumption (e.g., the indicated TCI state) of the downlink signal when receiving an aperiodic CSI-RS via the aperiodic CSI-RS resource. The downlink signal may refer to a PDSCH scheduled with an offset larger than or equal to a threshold timeDurationForQCL, a periodic CSI-RS, a semi-persistent CSI-RS, or an aperiodic CSI-RS scheduled with an offset larger than or equal to a threshold beamSwitch Timing reported by the wireless device. If there is a PDSCH applying two indicated joint/DL TCI states in the same symbols as the aperiodic CSI-RS resource, the wireless device may apply the first indicated joint/DL TCI state or the second indicated joint/DL TCI state to an aperiodic CSI-RS via the aperiodic CSI-RS resource according to the higher layer configuration applyIndicatedTCIState provided/indicated to the aperiodic CSI-RS resource or to the aperiodic CSI-RS resource set.

When a wireless device i) is configured with a higher layer parameter dl-OrJointTCI-StateList, ii) is configured by a higher layer parameter PDCCH-Config that contains/comprises two different values of a higher layer parameter CORESETPoolIndex in different CORESETS (e.g., ControlResourceSets), iii) is having two indicated TCI states (e.g., two indicated joint/DL TCI states) comprising a first TCI state and a second TCI state, and if a time/scheduling offset between the last symbol of a PDCCH carrying/with a DCI and a first/starting/earliest symbol of an aperiodic CSI-RS resource in an aperiodic CSI-RS resource set triggered by the DCI is smaller than a threshold (e.g., beam Switch Timing):
If there is no downlink signal in the same symbols as the aperiodic CSI-RS resource:
if the wireless device is in frequency range 1 (FR1), or the wireless device reports a capability of default beam per coreset pool index in frequency range 2 (FR2), the wireless device may apply the first TCI state or the second TCI state to an aperiodic CSI-RS via the aperiodic CSI-RS resource based on (or according to) a higher layer parameter applyIndicatedTCIState provided/indicated to/for the aperiodic CSI-RS resource or to the aperiodic CSI-RS resource set comprising the aperiodic CSI-RS resource.

Otherwise, the wireless device may apply the first TCI state associated with (or specific with or of) a higher layer parameter coresetPoolIndex with value 0 to an aperiodic CSI-RS via the aperiodic CSI-RS resource.
else if there is a downlink signal with an indicated TCI state in the same symbols as the aperiodic CSI-RS resource, the wireless device may apply a QCL assumption (e.g., the indicated TCI state) of the downlink signal when receiving an aperiodic CSI-RS via the aperiodic CSI-RS resource. The downlink signal may refer to a PDSCH scheduled with an offset larger than or equal to a threshold timeDurationForQCL, a periodic CSI-RS, a semi-persistent CSI-RS, or an aperiodic CSI-RS scheduled with an offset larger than or equal to a threshold beamSwitch Timing reported by the wireless device.

For a CORESET with index 0,
if a wireless device is provided/indicated with a TCI state and indicated/configured with a higher layer parameter followUnifiedTCI-State for the CORESET, the wireless device may assume that a DM-RS antenna port for PDCCH receptions in the CORESET and a DM-RS antenna port for PDSCH receptions scheduled by DCI formats provided by the PDCCH receptions in the CORESET are quasi co-located with reference signal(s) provided/indicated by the indicated TCI state,
else if the wireless device is provided/indicated/configured with a higher layer parameter di-OrJointTCI-StateList and is indicated a first TCI state and a second TCI state, and provided/indicated/configured with a higher layer parameter apply-IndicatedTCIState for the CORESET:
if the higher layer parameter apply-IndicatedTCIState=‘first’, the wireless device may assume that a DM-RS antenna port for PDCCH receptions in the CORESET is quasi co-located with reference signal(s) provided/indicated by the first TCI state,
if the higher layer parameter apply-IndicatedTCIState=‘second’, the wireless device may assume that a DM-RS antenna port for PDCCH receptions in the CORESET is quasi co-located with reference signal(s) provided/indicated by the second TCI state,
if the higher layer parameter apply-IndicatedTCIState=‘both’, the wireless device may assume that a DM-RS antenna port for PDCCH receptions in the CORESET is quasi co-located with reference signals provided/indicated by the first TCI state and the second TCI state.
else, the wireless device may assume that a DM-RS antenna port for PDCCH receptions in the CORESET is quasi co-located with
reference signal(s) provided/indicated/configured by a TCI state that is indicated by a MAC CE activation command for the CORESET, if any, or
a SS/PBCH block the wireless device identified during a most recent random access procedure that is not initiated by a PDCCH order that triggers a contention-free random access procedure, if no MAC CE activation command indicating a TCI state for the CORESET is received after the most recent random access procedure, or a SS/PBCH block the wireless device identified during a most recent configured grant PUSCH transmission for a small data transmission (SDT).

If a wireless device is provided/configured/indicated with a higher layer parameter dl-OrJointTCI-StateList and is indicated a first TCI state and a second TCI state, and is provided/indicated/configured with a higher layer parameter apply-IndicatedTCIState for a CORESET, other than a CORESET with index 0,
if the CORESET is associated only with USS sets and/or Type3-PDCCH CSS sets
if the higher layer parameter apply-IndicatedTCIState=‘first’, the wireless device may assume that a DM-RS antenna port for PDCCH receptions in the CORESET is quasi co-located with reference signal(s) provided/indicated by the first TCI state,
if the higher layer parameter apply-IndicatedTCIState=‘second’, the wireless device may assume that a DM-RS antenna port for PDCCH receptions in the CORESET is quasi co-located with reference signal(s) provided/indicated by the second TCI state,
if the higher layer parameter apply-IndicatedTCIState=‘both’, the wireless device may assume that a DM-RS antenna port for PDCCH receptions in the CORESET is quasi co-located with reference signals provided/indicated by the first TCI state and the second TCI state.
if the CORESET is associated at least with CSS sets other than Type3-PDCCH CSS sets,
if the higher layer parameter apply-IndicatedTCIState=‘first’, the wireless device may assume that a DM-RS antenna port for PDCCH receptions in the CORESET is quasi co-located with reference signal(s) provided/indicated by the first TCI state,
if the higher layer parameter apply-IndicatedTCIState=‘second’, the wireless device may assume that a DM-RS antenna port for PDCCH receptions in the CORESET is quasi co-located with reference signal(s) provided/indicated by the second TCI state,
if the higher layer parameter apply-IndicatedTCIState=‘both’, the wireless device may assume that a DM-RS antenna port for PDCCH receptions in the CORESET is quasi co-located with reference signals provided/indicated by the first TCI state and the second TCI state,
if the higher layer parameter apply-IndicatedTCIState=‘none’, the wireless device may assume that a DM-RS antenna port for PDCCH receptions in the CORESET is quasi co-located with reference signal(s) provided/indicated/configured by a TCI state indicated by a MAC CE activation command for the CORESET

If a wireless device is provided/configured/indicated with a higher layer parameter dl-OrJointTCI-StateList and
is not provided/configured/indicated with a higher layer parameter coresetPoolIndex or is provided/configured/indicated with a higher layer parameter coresetPoolIndex with a value of 0 for first CORESETs on an active DL BWP of a serving cell,
is provided/configured/indicated with a higher layer parameter coresetPoolIndex with a value of 1 for second CORESETs on the active DL BWP of the serving cells, and
for the first and second CORESETs that do not include a CORESET with index 0, and a) are associated only with USS sets and/or Type3-PDCCH CSS sets, or b) are associated with CSS sets other than Type3-PDCCH CSS sets and provided/configured/indicated with a higher layer parameter followUnifiedTCI-State,
the wireless device may assume that DM-RS antenna ports for PDCCH receptions in the first CORESETs and second CORESETs, and DM-RS antenna ports for PDSCH receptions scheduled by DCI formats provided by PDCCH receptions in the first CORESETs and second CORESETs, are quasi co-located with reference signals provided by indicated TCI state specific to the first CORESETs (or coresetPoolIndex=0) and second CORESETs (or coresetPoolIndex=1), respectively,
the wireless device may transmit PUSCH scheduled by DCI formats provided by PDCCH receptions in the first CORESETs and second CORESETs using a spatial domain filter corresponding to TCI state or TCI UL state specific to the first CORESETs (or coresetPoolIndex=0) and second CORESETs (or coresetPoolIndex=1), respectively.

When a wireless device is configured/indicated, by a base station, with a higher layer parameter di-OrJointTCI-StateList or a higher layer parameter TCI-UL-State and is having two indicated TCI states (or two indicated uplink TCI states) comprising a first indicated TCI state and a second indicated TCI state:
the wireless device having a PUSCH transmission scheduled or activated by a DCI format 0_0 may apply the first indicated TCI state to the PUSCH transmission,
the wireless device configured, by the base station, with a PUSCH transmission corresponding to a Type 1 configured grant may be expected to be configured with a higher layer parameter applyIndicatedTCIState.
If the higher layer parameter applyIndicatedTCIState is set to ‘first’, the wireless device may apply the first indicated TCI state to the PUSCH transmission. The wireless device may apply the first indicated TCI state to each PUSCH transmission occasion of the PUSCH transmission.
If the higher layer parameter applyIndicatedTCIState is set to ‘second’, the wireless device may apply the second indicated TCI state to the PUSCH transmission. The wireless device may apply the second indicated TCI state to each PUSCH transmission occasion of the PUSCH transmission.
If the higher layer parameter applyIndicatedTCIState is set to ‘both’, the wireless device may apply the both of the two indicated TCI states to the PUSCH transmission. If the higher layer parameter applyIndicatedTCIState is set to ‘both’ (or if both of the two indicated TCI states are indicated to be applied for the PUSCH transmission), the wireless device may apply:
the first indicated TCI state to PUSCH transmission occasion(s) or PUSCH antenna port(s), of the PUSCH transmission, associated with a first SRS resource set for codebook/non-codebook transmission, and
the second indicated TCI state to PUSCH transmission occasion(s) or PUSCH antenna port(s), of the PUSCH transmission, associated with a second SRS resource set for codebook/non-codebook transmission.
If the wireless device is configured/indicated, by the base station, by a higher layer parameter PDCCH-Config that contains/comprises two different values of a higher layer parameter coresetPoolIndex in different ControlResourceSets, the first indicated TCI state and the second indicated TCI state may be specific to a higher layer parameter coresetPoolIndex with value 0 and a higher layer parameter coresetPoolIndex with value 1, respectively. If the wireless device is configured/indicated, by the base station, by a higher layer parameter PDCCH-Config that contains/comprises two different values of a higher layer parameter coresetPoolIndex in different ControlResourceSets, the higher layer parameter applyIndicatedTCIState may not be set to ‘both’ indicating both of the two indicated TCI states to be applied for the PUSCH transmission.

When a wireless device is configured with a higher layer parameter dl-OrJointTCI-StateList or a higher layer parameter TCI-UL-State and two SRS resource sets are configured in a higher layer parameter srs-ResourceSetToAddModList or a higher layer parameter srs-ResourceSetToAddModListDCI-0-2 with a higher layer parameter usage in SRS-ResourceSet set to ‘codebook’ or ‘noncodebook’, and a higher layer parameter multipanelScheme is set to ‘SDMscheme’ or ‘SFNscheme’, and a higher layer parameter rrc-ConfiguredUplinkGrant of a configured uplink grant (e.g., Type 1 configured uplink grant) does not contain/comprise a higher layer parameter srs-ResourceIndicator2 or a higher layer parameter precodingAndNumberOfLayers2, PUSCH transmission occasion(s) of the configured uplink grant may be associated with a first SRS resource set of the two SRS resource sets if the first indicated TCI state (or TCI-UL state) is applied to the higher layer parameter rrc-ConfiguredUplinkGrant (or to the configured uplink grant) and may be associated with a second SRS resource set of the two SRS resource sets if the second indicated TCI state (or TCI-UL state) is applied to the higher layer parameter rrc-ConfiguredUplinkGrant (or to the configured uplink grant).

When a higher layer parameter multipanelScheme is set to ‘SDMScheme’ and two SRS resource sets are configured/indicated, by a base station, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, two SRIs and two TPMIs may be given/provided/indicated by two SRS resource indicator fields and two Precoding-information-and-number-of-layers fields for/in a DCI format 0_1 and a DCI format 0_2:
When codepoint “10” of SRS Resource Set indicator is indicated in the DCI format 0_1/0_2:
a first TPMI of the two TPMIs may indicate a transmission precoder to be applied over layers {0 . . . v₁−1}, where v₁ is a number of layers indicated by the first TPMI, that corresponds to an SRS resource selected by a first SRI of the two SRSs when multiple SRS resources are configured for a first SRS resource set or if single SRS resource is configured for the first SRS resource set, and
a second TPMI of the two TPMIs may indicate a transmission precoder to be applied over layers {v₁ . . . v₂+v₁−1}, where vais a number of layers indicated by the second TPMI, that corresponds to an SRS resource selected by a second SRI of the two SRIs when multiple SRS resources are configured for a second SRS resource set or if single SRS resource is configured for the second SRS resource set, v₁≤maxRankSdm and v₂≤maxRankSdm or maxRankSdmDCI-0-2 and maxRankSdm or maxRankSdmDCI-0-2 may define the maximum number of layers applied over the first SRS resource set and the second SRS resource sets, separately.
When codepoint “00” or “01” of SRS Resource Set indicator is indicated in the DCI format 0_1/0_2, the second SRI and second TPMI may be reserved, and the first TPMI may indicate a precoder to be applied over layers {0 . . . v−1}, where v≤maxRank, where maxRank may define the maximum number of layers.
Codepoint “11” of SRS Resource Set indicator in the DCI format 0_1/0_2 may be reserved.
For one or two TPMIs, the transmission precoder may be selected from an uplink codebook that has a number of antenna ports equal to a higher layer parameter nrofSRS-Ports in a higher layer parameter SRS-Config for the indicated SRI(s).
When two SRIs are indicated, the wireless device may expect that the number of SRS antenna ports associated with two indicated SRIs is the same. When the wireless device is configured/indicated with a higher layer parameter txConfig set to ‘codebook’, the wireless device may be configured/indicated with at least one SRS resource. Each of the indicated one or two SRIs in slot n may be associated with the most recent transmission of an SRS resource, in associated SRS resource set, identified by an SRI of the two SRIs, where the SRS resource is prior to a PDCCH reception with the DCI format 0_1/0_2 carrying the SRI. When two SRS resource sets are configured/indicated in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, the wireless device may not be expected to be configured with a different number of SRS resources in the two SRS resource sets.

When a higher layer parameter multipanelScheme is set to ‘SFNScheme’ and two SRS resource sets are configured/indicated, by a base station, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, two SRIs and two TPMIs may be given/provided/indicated by two SRS resource indicator fields and two Precoding-information-and-number-of-layers fields for/in a DCI format 0_1 and a DCI format 0_2:

When codepoint “10” of SRS Resource Set indicator is indicated in the DCI format 0_1/0_2:
a first TPMI of the two TPMIs may indicate a transmission precoder to be applied over layers {0 . . . v−1}, and a second TPMI of the two TPMIs may indicate a transmission precoder to be applied over layers {0 . . . v−1}, where v≤maxRankSfn or maxRankSfnDCI-0-2 and maxRankSfn or maxRankSfnDCI-0-2 may define the maximum number of layers applied over the first SRS resource set and the second SRS resource sets, separately.
When codepoint “00” or “01” of SRS Resource Set indicator is indicated in the DCI format 0_1/0_2, the second SRI and second TPMI may be reserved, and the first TPMI may indicate a precoder to be applied over layers {0 . . . v−1}, where v≤maxRank, where maxRank may define the maximum number of layers.
Codepoint “11” of SRS Resource Set indicator in the DCI format 0_1/0_2 may be reserved.
For one or two TPMIs, the transmission precoder may be selected from an uplink codebook that has a number of antenna ports equal to a higher layer parameter nrofSRS-Ports in a higher layer parameter SRS-Config for the indicated SRI(s).
When two SRIs are indicated, the wireless device may expect that the number of SRS antenna ports associated with two indicated SRIs is the same. When the wireless device is configured/indicated with a higher layer parameter txConfig set to ‘codebook’, the wireless device may be configured/indicated with at least one SRS resource. Each of the indicated one or two SRIs in slot n may be associated with the most recent transmission of an SRS resource, in associated SRS resource set, identified by an SRI of the two SRIs, where the SRS resource is prior to a PDCCH reception with the DCI format 0_1/0_2 carrying the SRI. When two SRS resource sets are configured/indicated in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, the wireless device may not be expected to be configured with a different number of SRS resources in the two SRS resource sets.

When a higher layer parameter multipanelScheme is set to ‘SDMScheme’ and two SRS resource sets are configured/indicated, by a base station, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘nonCodebook’, two SRIs may be given/provided/indicated by two SRS resource indicator fields for/in a DCI format 0_1 and a DCI format 0_2:
When codepoint “10” of SRS Resource Set indicator is indicated in the DCI format 0_1/0_2:
a first SRI of the two SRIs may indicate resource(s) to be associated with layers {0 . . . v₁−1}, where v₁ is a number of layers indicated by the first SRI and a second SRI of the two SRIs may indicate resource(s) to be associated with layers {v₁ . . . v₂+v₁−1}, v₁≤Lₘₐₓ and v₂≤Lₘₐₓ.
When codepoint “00” or “01” of SRS Resource Set indicator is indicated in the DCI format 0_1/0_2, the second SRI may be reserved, and the first SRI may indicate resource(s) associated with layers {0 . . . v−1}, where v≤Lₘₐₓ.

When a higher layer parameter multipanelScheme is set to ‘SFNScheme’ and two SRS resource sets are configured/indicated, by a base station, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘nonCodebook’, two SRIs may be given/provided/indicated by two SRS resource indicator fields for/in a DCI format 0_1 and a DCI format 0_2:
When codepoint “10” of SRS Resource Set indicator is indicated in the DCI format 0_1/0_2:
a first SRI of the two SRIs may indicate resource(s) to be associated with layers {0 . . . v−1} and a second SRI of the two SRIs may indicate resource(s) to be associated with layers {0 . . . v−1}, v≤Lₘₐₓ.
When codepoint “00” or “01” of SRS Resource Set indicator is indicated in the DCI format 0_1/0_2, the second SRI may be reserved, and the first SRI may indicate resource(s) associated with layers {0 . . . v−1}, where v≤Lₘₐₓ. When two SRIs are indicated, the wireless device may expect that the number of SRS antenna ports associated with two indicated SRIs to be the same.
When the wireless device is configured/indicated with a higher layer parameter txConfig set to ‘nonCodebook’, the wireless device may be configured/indicated with at least one SRS resource. Each of the indicated one or two SRIs in slot n may be associated with the most recent transmission of an SRS resource, in associated SRS resource set, identified by an SRI of the two SRIs, where the SRS resource is prior to a PDCCH reception with the DCI format 0_1/0_2 carrying the SRI. When two SRS resource sets are configured/indicated in a higher layer parameter srs-ResourceSetToAddModList or a higher layer parameter srs-ResourceSetToAddModListDCI-0-2 with a higher layer parameter usage in a higher layer parameter SRS-ResourceSet set to ‘nonCodebook’, the wireless device may not be expected to be configured with a different number of SRS resources in the two SRS resource sets.

When a wireless device is configured/indicated, by a base station, with a higher layer parameter di-OrJointTCI-StateList or a higher layer parameter TCI-UL-State and is having two indicated TCI states (or two indicated joint/uplink TCI states) comprising a first indicated TCI state and a second indicated TCI state, and two SRS resource sets are configured/indicated, by the base station, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’ or ‘nonCodebook’, for a PUSCH repetition Type A or Type B, or for a PUSCH transmission when the higher layer parameter multipanelScheme is set to ‘SDMscheme’ or ‘SFNscheme’, the association of the first indicated TCI state and the second indicated TCI state to PUSCH transmission occasions or to corresponding PUSCH antenna ports may be determined as follows:
if a DCI format 0_1 or a DCI format 0_2 indicates codepoint “00” or “01” for an SRS resource set indicator, the first indicated TCI state or second indicated TCI state may be applied, by the wireless device, to all PUSCH transmission occasions, respectively.
if a DCI format 0_1 or a DCI format 0_2 indicates codepoint “10” or “11” for an SRS resource set indicator, and the higher layer parameter multipanelScheme is not configured,
the first indicated TCI state may be applied, by the wireless device, to PUSCH transmission occasion(s) associated with a first SRS resource set of the two SRS resource sets and the second indicated TCI state may be applied to PUSCH transmission occasion(s) associated with a second SRS resource set of the SRS resource sets, where the association of PUSCH transmission occasions to the two SRS resource sets may be determined based on whether a higher layer parameter cyclicMapping or a higher layer parameter sequentialMapping in a higher layer parameter PUSCH-Config is enabled.
if a DCI format 0_1 or a DCI format 0_2 indicates codepoint “10” for an SRS resource set indicator and the higher layer parameters multipanelScheme is configured and set to ‘SDMscheme’ or ‘SFNscheme’,
the first indicated TCI state may be applied, by the wireless device, to first PUSCH antenna port(s), of a PUSCH transmission occasion, associated with the first SRS resource set, and the second indicated TCI state may be applied, by the wireless device, to second PUSCH antenna port(s), of the PUSCH transmission occasion, associated with the second SRS resource set. The first PUSCH antenna port(s) and the second PUSCH antenna port(s) may be the same or different.

When a wireless device is configured/indicated/provided with a higher layer parameter di-OrJointTCI-StateList or a higher layer parameter TCI-UL-State and is having two indicated TCI states (or two indicated uplink TCI states) comprising a first indicated TCI state and a second indicated TCI state, for a periodic, semi-persistent or aperiodic SRS resource set with a higher layer parameter usage, in SRS-ResourceSet, set to ‘codebook’, ‘nonCodebook’ or ‘antennaSwitching’ or for an aperiodic SRS resource set with a higher layer parameter usage, in SRS-ResourceSet, set to ‘beamManagement’
The wireless device may be configured/indicated/provided by/with a higher layer parameter applyIndicatedTCIState, to the SRS resource set, to indicate whether the wireless device applies the first indicated TCI state or the second indicated TCI state to the SRS resource set.
When a wireless device is configured/indicated/provided by a higher layer parameter PDCCH-Config that contains two different values of a higher layer parameter coresetPoolIndex in a higher layer parameter ControlResourceSet, the first indicated TCI state and second indicated TCI state correspond to the indicated TCI states (or uplink TCI states) specific to a higher layer parameter coresetPoolIndex with value 0 and a higher layer parameter coresetPoolIndex with value 1, respectively.
When a wireless device is configured/indicated/provided by/with a higher layer parameter PDCCH-Config that contains/comprises two different values of a higher layer parameter coresetPoolIndex in a higher layer parameter ControlResourceSet, and is not configured/indicated/provided with a higher layer parameter applyIndicatedTCIState for an aperiodic SRS resource set, if the aperiodic SRS resource set is triggered by PDCCH on a CORESET associated with a coresetPoolIndex value, the wireless device may apply, to the aperiodic SRS resource set, an indicated TCI state (or uplink TCI state) specific to the coresetPoolIndex value.
When two SRS resource sets comprising a first SRS resource set and a second SRS resource with a higher layer parameter usage in a higher layer parameter SRS-ResourceSet set to ‘codebook’ or ‘nonCodebook’ are configured/indicated/provided, the wireless device may not expect that the first indicated TCI state is applied to the second SRS resource set and that the second indicated TCI state is applied to the first SRS resource set.

A wireless device may be configured/indicated/provided by/with a higher layer parameter applyIndicatedTCIState, to a PUCCH resource, to indicate whether the wireless device applies the first indicated TCI state or the second indicated TCI state or both of the two indicated TCI states to the PUCCH resource. The higher layer parameter applyIndicatedTCIState may be an indication for applying one or both of the two indicated TCI states to the PUCCH resource.
If the higher layer parameter applyIndicatedTCIState is set to ‘first’, the wireless device may transmit, via the PUCCH resource, a PUCCH transmission with/using a spatial domain filter corresponding to the first indicated TCI state,
If the higher layer parameter applyIndicatedTCIState is set to ‘second’, the wireless device may transmit, via the PUCCH resource, a PUCCH transmission with/using a spatial domain filter corresponding to the second indicated TCI state,
If the higher layer parameter applyIndicatedTCIState is set to ‘both’, the wireless device may transmit, via the PUCCH resource, a PUCCH transmission with/using a spatial domain filter corresponding to the first indicated TCI state and a spatial domain filter corresponding to the second indicated TCI state.

If the wireless device
is not provided with a higher layer parameter coresetPoolIndex or is provided with a higher layer parameter coresetPoolIndex with a value of 0 for first CORESETs on an active downlink BWP of a cell, and
is provided with a higher layer parameter coresetPoolIndex with a value of 1 for second CORESETs on the active downlink BWP of the cell
the first indicated TCI state and the second indicated TCI state may be specific to the first CORESETs (or to the higher layer parameter coresetPoolIndex with a value of 0) and the second CORESETs (or to the higher layer parameter coresetPoolIndex with a value of 1), respectively.

A wireless device may be indicated, by a base station, to transmit a PUCCH transmission over a number of slots (e.g.,

$${N}_{PUCCH}^{r e p e a t}$$

slots) using/via a PUCCH resource. If the PUCCH resource is indicated by a DCI format and the PUCCH resource includes (or is configured with) a higher layer parameter pucch-RepetitionNrofSlots, the number of slots may be indicated by the higher layer parameter pucch-RepetitionNrofSlots. If the PUCCH resource is not indicated by a DCI format or the PUCCH resource does not include (or is not configured with) a higher layer parameter pucch-RepetitionNrofSlots, the number of slots may be indicated by a higher layer parameter nrofSlots.

When a PUCCH resource used for repetitions of a PUCCH transmission by a wireless device includes a first TCI state and a second TCI state (e.g., applyIndicatedTCIState=‘both’) and the wireless device is not provided a higher layer parameter multipanelSfnScheme, the wireless device
uses the first indicated TCI state and the second indicated TCI state for first and second repetitions of the PUCCH transmission, respectively, when the number of slots (e.g.,

$${N}_{PUCCH}^{r e p e a t}$$

slots) is equal to two,
alternates between the first indicated TCI state and the second indicated TCI state per

$${N}_{PUCCH}^{switch}$$

repetitions of the PUCCH transmission, where

$${N}_{PUCCH}^{s w i t c h} = 1$$

if a higher layer parameter mappingPattern=‘cyclicMapping’; else (e.g., if a higher layer parameter mappingPattern=‘sequentialMapping’,

$${N}_{PUCCH}^{s w i t c h} = 2.$$

When a wireless device transmits repetitions of a PUSCH transmission over/across K slots (e.g., K consecutive slots) and K=2, the first and second SRS resource sets may be applied, by the wireless device and/or the base station, to the first and second slot of 2 slots, respectively.

When a wireless device transmits repetitions of a PUSCH transmission over/across K slots (e.g., K consecutive slots)>2 slots, and when the higher layer parameter mappingPattern=‘cyclicMapping’, the first and second SRS resource sets may be applied, by the wireless device and/or the base station, to the first and second slot of K slots, respectively, and the same SRS resource set mapping pattern may continue to the remaining slots of K slots.

When a wireless device transmits repetitions of a PUSCH transmission over/across K slots (e.g., K consecutive slots)>2 slots, and when the higher layer parameter mappingPattern=‘sequentialMapping’, the first SRS resource set may be applied, by the wireless device and/or the base station, to the first and second slots of K slots, and the second SRS resource set may be applied, by the wireless device and/or the base station, to the third and fourth slot of K slots, and the same SRS resource set mapping pattern may continue to the remaining slots of K slots.

A DCI format 0_3 may be used for the scheduling of one PUSCH in one cell, or multiple PUSCHs in multiple cells with one PUSCH per cell.

The DCI format 0_3 may comprise a scheduled cell set indicator field. A number of bits of the scheduled cell set indicator field may be determined based on a number of cell sets which are configured/indicated by a higher layer parameter MC-DCI-SetofCellsToAddModList to be respectively scheduled by DCI format 0_3/1_3 from the cell on which DCI format 0_3 is carried by PDCCH. If the scheduled cell set indicator field is present, the scheduled cell set indicator field may be used to indicate a scheduled cell set according to a table; otherwise, the scheduled cell set may be a cell set configured to be scheduled by a DCI format 0_3/1_3 from the cell by a higher layer parameter MC-DCI-SetofCellsToAddModList.

The DCI format 0_3 may comprise a scheduled cells indicator field. A number of bits of the scheduled cells indicator field may be determined by the following:
bit if a higher layer parameter ScheduledCellCombo-ListDCI-0-3 for a scheduled cell set is not configured;
otherwise ┌log₂I_{UL}┐ bits indicating scheduled cell(s) in the scheduled cell set according to a table, where I_{UL} is the number of entries in the higher layer parameter ScheduledCellCombo-ListDCI-0-3. If only one entry is configured in the higher layer parameter ScheduledCellCombo-ListDCI-0-3, the scheduled cell(s) are the cell(s) configured by a higher layer parameter ScheduledCellCombo-ListDCI-0-3.

The DCI format 0_3 may comprise a frequency domain resource assignment. The frequency domain resource assignment may comprise block(s) (e.g., block number 1, block number 2, . . . , block number

$${N}_{c e l l}^{U L} ) .$$

If a higher layer parameter ScheduledCellCombo-ListDCI-0-3 for the scheduled cell set is configured with more than one entry,

$${N}_{c e l l}^{U L}$$

may be the number of the scheduled cell(s) indicated by the scheduled cells indicator field;
if a higher layer parameter ScheduledCellCombo-ListDCI-0-3 for the scheduled cell set is configured with only one entry,

$${N}_{c e l l}^{U L}$$

is a number of cell configured by a higher layer parameter ScheduledCellCombo-ListDCI-0-3;
otherwise,

$${N}_{c e l l}^{U L}$$

is the number of cells configured by a higher layer parameter ScheduledCell-ListDCI-0-3 in the scheduled cell set.
Each block of the block(s) may correspond to a frequency domain resource assignment for a respective cell, and the block(s) may be placed according to an ascending order of a serving cell index, with block number 1 corresponds to a frequency domain resource assignment for a first cell with the smallest serving cell index, with block number 2 corresponds to a frequency domain resource assignment for a second cell with the second smallest serving cell index, and the like.

If a higher layer parameter ScheduledCellCombo-ListDCI-0-3 for the scheduled cell set is not configured, each block of the block(s) may be used to indicate whether the corresponding cell is scheduled or not as follows:
if all bits of a block are set to 0 for resource allocation type 0 or set to 1 for resource allocation type 1 or set to 0 or 1 for dynamic switch resource allocation type, the cell corresponding to the block is not scheduled;
otherwise, the cell corresponding to the block is scheduled.

A DCI format 1_3 may be used for the scheduling of one PDSCH in one cell, or multiple PDSCHs in multiple cells with one PDSCH per cell.

The DCI format 1_3 may comprise a scheduled cell set indicator field. A number of bits of the scheduled cell set indicator field may be determined based on a number of cell sets which are configured/indicated by a higher layer parameter MC-DCI-SetofCellsToAddModList to be respectively scheduled by DCI format 0_3/1_3 from the cell on which DCI format 1_3 is carried by PDCCH. If the scheduled cell set indicator field is present, the scheduled cell set indicator field may be used to indicate a scheduled cell set according to a table; otherwise, the scheduled cell set may be a cell set configured to be scheduled by a DCI format 0_3/1_3 from the cell by a higher layer parameter MC-DCI-SetofCellsToAddModList.

The DCI format 1_3 may comprise a scheduled cells indicator field. A number of bits of the scheduled cells indicator field may be determined by the following:
bit if a higher layer parameter ScheduledCellCombo-ListDCI-1-3 for a scheduled cell set is not configured;
otherwise [log₂I_{DL}] bits indicating scheduled cell(s) in the scheduled cell set according to a table, where I_{DL} is the number of entries in the higher layer parameter ScheduledCellCombo-ListDCI-1-3. If only one entry is configured in the higher layer parameter ScheduledCellCombo-ListDCI-1-3, the scheduled cell(s) are the cell(s) configured by a higher layer parameter ScheduledCellCombo-ListDCI-1-3.

The DCI format 1_3 may comprise a frequency domain resource assignment. The frequency domain resource assignment may comprise block(s) (e.g., block number 1, block number 2, . . . , block number

$${N}_{c e l l}^{D L} ) .$$

If a higher layer parameter ScheduledCellCombo-ListDCI-1-3 for the scheduled cell set is configured with more than one entry,

$${N}_{c e l l}^{D L}$$

may be the number of the scheduled cell(s) indicated by the scheduled cells indicator field;
if a higher layer parameter ScheduledCellCombo-ListDCI-1-3 for the scheduled cell set is configured with only one entry,

$${N}_{c e l l}^{D L}$$

is a number of cells configured by a higher layer parameter ScheduledCellCombo-ListDCI-1-3;
otherwise,

$${N}_{c e l l}^{D L}$$

is the number of cells configured by a higher layer parameter ScheduledCell-ListDCI-1-3 in the scheduled cell set.
Each block of the block(s) may correspond to a frequency domain resource assignment for a respective cell, and the block(s) may be placed according to an ascending order of a serving cell index, with block number 1 corresponds to a frequency domain resource assignment for a first cell with the smallest serving cell index, with block number 2 corresponds to a frequency domain resource assignment for a second cell with the second smallest serving cell index, and the like.

If a higher layer parameter ScheduledCellCombo-ListDCI-1-3 for the scheduled cell set is not configured, each block of the block(s) may be used to indicate whether the corresponding cell is scheduled or not as follows:
if all bits of a block are set to 0 for resource allocation type 0 or set to 1 for resource allocation type 1 or set to 0 or 1 for dynamic switch resource allocation type, the cell corresponding to the block is not scheduled;
otherwise, the cell corresponding to the block is scheduled.

The DCI format 1_3 may comprise a transmission configuration indication (TCI) field. A number of the TCI field may be determined based on the following:
0 bit if a higher layer parameter tci-PresentInDCI is not enabled;
otherwise ┌log₂(I_{TCI})┐ bits, where I_{TCI} is a number of entries in a higher layer parameter tci-ListDCI-1-3. The TCI field may be used to indicate an entry in the higher layer parameter tci-ListDCI-1-3. Each entry in the higher layer parameter tci-ListDCI-1-3 may contain/comprise a ‘Transmission configuration indication’ index (or a TCI codepoint) for each cell in the scheduled cell set. ‘Transmission configuration indication’ indexes (or TCI codepoints) for all cells in an entry in/of the higher layer parameter tci-ListDCI-1-3 may be placed according to an ascending order of a serving cell index. Each ‘Transmission configuration indication’ index (or a TCI codepoint) may be 3 bits.

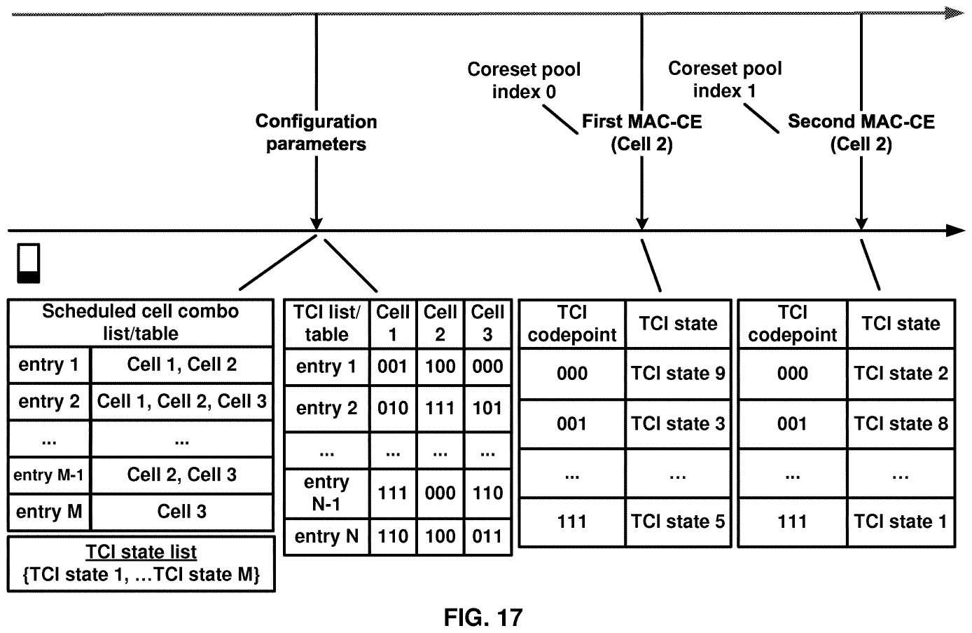

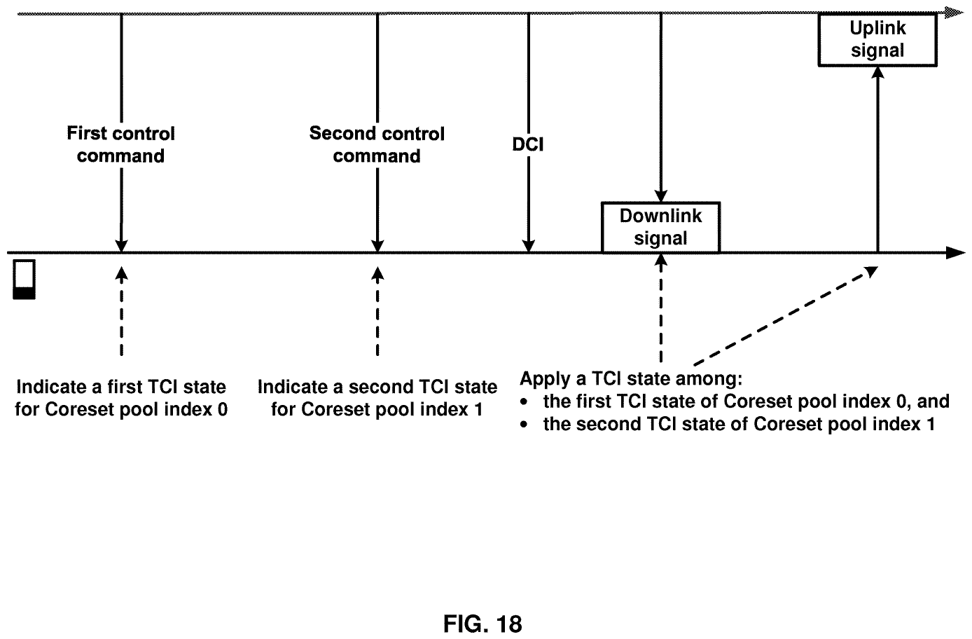

FIG. 17 and FIG. 18 illustrate examples of cell scheduling as per an aspect of an embodiment of the present disclosure.

In an example, a wireless device may receive one or more messages. In an example, the wireless device may receive the one or more messages from a base station. The base station may transmit the one or more messages. In an example, the wireless device may receive the one or more messages from a relay node. In an example, the wireless device may receive the one or more messages from another wireless device (e.g., TRP, vehicle, remote radio head, and the like). The one or more messages may comprise one or more configuration parameters (e.g., Configuration parameters in FIG. 17).

In an example, the one or more configuration parameters may be one or more RRC configuration parameters. In an example, the one or more configuration parameters may be one or more RRC reconfiguration parameters (e.g., RRCReconfiguration, reconfigurationWith Sync).

In an example, the one or more messages may be one or more RRC messages. In an example, the one or more messages may be one or more RRC reconfiguration messages (e.g., RRCReconfiguration, reconfigurationWithSync).

In an example, the one or more configuration parameters may be for one or more cells. The one or more cells may comprise a first cell.

The first cell may be, for example, a serving cell. In an example, at least one configuration parameter of the one or more configuration parameters may be for the first cell. In an example, the first cell may be a primary cell (PCell). In an example, the first cell may be a primary secondary cell (PSCell). In an example, the first cell may be a secondary cell (SCell). The first cell may be a secondary cell configured with PUCCH (e.g., PUCCH SCell).

In an example, the first cell may be a special Cell (SpCell). For dual connectivity (DC) operation, the SpCell may refer to (or indicate) the PCell of the MCG or the PSCell of the SCG, otherwise the SpCell may refer to (or indicate) the PCell.

In an example, the first cell may be a primary SCG cell (PSCell). For dual connectivity operation, the wireless device may, for example, perform a random-access procedure via the PSCell when performing the Reconfiguration with Sync procedure.

In an example, the first cell may be an unlicensed cell, e.g., operating in an unlicensed band. In an example, the first cell may be a licensed cell, e.g., operating in a licensed band. In an example, the first cell may operate in a first frequency range (FR1). The FR1 may, for example, comprise frequency bands below 6 GHz. In an example, the first cell may operate in a second frequency range (FR2). The FR2 may, for example, comprise frequency bands from 24 GHz to 52.6 GHz. In an example, the first cell may operate in a third frequency range (FR3). The FR3 may, for example, comprise frequency bands from 52.6 GHz to 71 GHz. The FR3 may, for example, comprise frequency bands starting from (or above) 52.6 GHz.

In an example, the wireless device may perform uplink transmissions (e.g., PUSCH, PUCCH, PUCCH) via/of the first cell in a first time and in a first frequency. The wireless device may perform downlink receptions (e.g., PDCCH, PDSCH) via/of the first cell in a second time and in a second frequency. In an example, the first cell may operate in a time-division duplex (TDD) mode. In the TDD mode, the first frequency and the second frequency may be the same. In the TDD mode, the first time and the second time may be different. In an example, the first cell may operate in a frequency-division duplex (FDD) mode. In the FDD mode, the first frequency and the second frequency may be different. In the FDD mode, the first time and the second time may be the same.

In an example, the wireless device may be in an RRC connected mode/state. In an example, the wireless device may be in an RRC idle mode/state. In an example, the wireless device may be in an RRC inactive mode/state.

In an example, the first cell may comprise a plurality of BWPs. The one or more configuration parameters may indicate, for the first cell, the plurality of BWPs. The plurality of BWPs may comprise one or more uplink BWPs comprising an uplink BWP of the first cell. The plurality of BWPs may comprise one or more downlink BWPs comprising a downlink BWP of the first cell.

In an example, a BWP of the plurality of BWPs may be in one of an active state and an inactive state (or in a deactivated state). In an example, in the active state of a downlink BWP of the one or more downlink BWPs, the wireless device may monitor a downlink channel/signal (e.g., PDCCH, DCI, CSI-RS, PDSCH) on/for/via the downlink BWP. In an example, in the active state of a downlink BWP of the one or more downlink BWPs, the wireless device may receive a PDSCH on/via/for the downlink BWP. In an example, in the inactive state of a downlink BWP of the one or more downlink BWPs, the wireless device may not monitor a downlink channel/signal (e.g., PDCCH, DCI, CSI-RS, PDSCH) on/via/for the downlink BWP. In the inactive state of a downlink BWP of the one or more downlink BWPs, the wireless device may stop monitoring (or receiving) a downlink channel/signal (e.g., PDCCH, DCI, CSI-RS, PDSCH) on/via/for the downlink BWP. In an example, in the inactive state of a downlink BWP of the one or more downlink BWPs, the wireless device may not receive a PDSCH on/via/for the downlink BWP. In the inactive state of a downlink BWP of the one or more downlink BWPs, the wireless device may stop receiving a PDSCH on/via/for the downlink BWP.

In an example, in the active state of an uplink BWP of the one or more uplink BWPs, the wireless device may transmit an uplink signal/channel (e.g., PUCCH, preamble, PUSCH, PRACH, PUCCH, etc.) on/via the uplink BWP. In an example, in the inactive state of an uplink BWP of the one or more uplink BWPs, the wireless device may not transmit an uplink signal/channel (e.g., PUCCH, preamble, PUSCH, PRACH, PUCCH, etc.) on/via the uplink BWP.

In an example, the wireless device may activate the downlink BWP of the one or more downlink BWPs of the first cell. In an example, the activating the downlink BWP may comprise setting (or switching to) the downlink BWP as an active downlink BWP of the first cell. In an example, the activating the downlink BWP may comprise setting the downlink BWP in the active state. In an example, the activating the downlink BWP may comprise switching the downlink BWP from the inactive state to the active state.

In an example, the wireless device may activate the uplink BWP of the one or more uplink BWPs of the first cell. In an example, the activating the uplink BWP may comprise that the wireless device sets (or switches to) the uplink BWP as an active uplink BWP of the first cell. In an example, the activating the uplink BWP may comprise setting the uplink BWP in the active state. In an example, the activating the uplink BWP may comprise switching the uplink BWP from the inactive state to the active state.

In an example, the one or more configuration parameters may be for the (active) downlink BWP of the first cell. In an example, at least one configuration parameter of the one or more configuration parameters may be for the downlink BWP of the first cell.

In an example, the one or more configuration parameters may be for the (active) uplink BWP of the first cell. In an example, at least one configuration parameter of the one or more configuration parameters may be for the uplink BWP of the first cell.

The one or more configuration parameters may comprise a list-of-set-of-cells parameter (e.g., MC-DCI-SetofCellsToAddModList) for multi-cell PDSCH/PUSCH scheduling from the first cell (e.g., the serving cell).

The list-of-set-of-cells parameter may indicate one or more sets of cells (e.g., MC-DCI-SetOfCells).

The list-of-set-of-cells parameter may indicate a list of configurations of one or more sets of cells.

The one or more configuration parameters may indicate, for the one or more sets of cells, one or more set of cells identifiers/identities/indexes (e.g., setOfCellsId). The one or more configuration parameters may indicate, for each set of cells of the one or more sets of cells, a respective set of cell identifier of the one or more set of cells identifiers.

Each set of cells of the one or more sets of cells may indicate/comprise respective cells (e.g., indicated by scheduledCellListDCI-1-3, scheduledCellListDCI-0-3). The one or more configuration parameters may comprise, for each set of cells of the one or more sets of cells, a scheduling cell list parameter (e.g., scheduledCellListDCI-1-3, scheduledCellListDCI-0-3) indicating the respective cells. For example, a first set of cells of the one or more sets of cells may indicate/comprise Cell 1 and Cell 2. A second set of cells of the one or more sets of cells may indicate/comprise Cell 3, Cell 4, and Cell 5. A third set of cells of the one or more sets of cells may indicate/comprise Cell 2, Cell 5, and Cell 6.

A scheduling cell list parameter (e.g., scheduledCellListDCI-1-3, scheduledCellListDCI-0-3) of a set of cells of the one or more sets of cells may indicate/configure a list of possible co-scheduled cells in the set of cells for downlink scheduling or uplink scheduling via a DCI format. The DCI format may be, for example, a DCI format 1_3 for the downlink scheduling. The DCI format may be, for example, a DCI format 0_3 for the uplink scheduling. The one or more configuration parameters may comprise, for the set of cells, the scheduling cell list parameter. The set of cells may comprise at least two cells. The at least two cells in the list may be in an ascending order of serving cell index(es) of the at least two cells.

A maximum number (e.g., maxNrofDCI-SetOfCells) of the one or more sets of cells may be reported by the wireless device to the base station.

The one or more sets of cells may comprise a set of cells (or a scheduled cell set). For example, in FIG. 17, the set of cells are/comprise/indicate Cell 1, Cell 2, and Cell 3. For example, in FIG. 17, the at least two cells in the set of cells are/comprise/indicate Cell 1, Cell 2, and Cell 3.

The set of cells may be (or may be interchangeably used with) a scheduled cell set.

The one or more configuration parameters may comprise a list of scheduled cell combinations parameter (e.g., ScheduledCellCombo-ListDCI-1-3, ScheduledCellCombo-ListDCI-0-3) indicating a table (e.g., Scheduled cell combo list/table in FIG. 17) for combinations of co-scheduled cells (or the set of cells or cells in the set of cells) for downlink scheduling or uplink scheduling via a DCI format. The DCI format may be, for example, a DCI format 1_3 for the downlink scheduling. The DCI format may be, for example, a DCI format 0_3 for the uplink scheduling. The table (e.g., Scheduled cell combo list/table in FIG. 17) may comprise one or more entries (or rows). For example, the one or more entries in FIG. 17 are entry 1, entry 2, . . . , entry M−1, and entry M. The one or more entries may be (or may be interchangeably used with) one or more rows.

Each entry of the one or more entries in the table (e.g., Scheduled cell combo list/table in FIG. 17) may indicate respective cell(s). For example, in FIG. 17, entry 1 indicates Cell 1 and Cell 2. Entry 2 indicates Cell 1, Cell 2, and Cell 3. Entry M−1 indicates Cell 2 and Cell 3. Entry M indicates Cell 3.

The one or more configuration parameters comprise a TCI list parameter (e.g., tci-ListDCI-1-3) indicating a (joint) TCI table (e.g., TCI list/table in FIG. 17) for downlink scheduling via DCI format 1_3.

The TCI table (e.g., TCI list/table in FIG. 17) may comprise one or more entries (or rows). For example, the one or more entries in FIG. 17 are entry 1, entry 2, . . . , entry N−1, and entry N. The one or more entries may be (or may be interchangeably used with) one or more rows.

Each entry of the one or more entries in the TCI table (e.g., TCI list/table in FIG. 17) may indicate respective TCI state codepoints (or TCI indexes) for the set of cells (or the scheduled cell set). For example, in FIG. 17, entry 1 indicates/comprises TCI codepoint 001 for Cell 1, TCI codepoint 100 for Cell 2, and TCI codepoint 000 for Cell 3. Entry 2 indicates/comprises TCI codepoint 010 for Cell 1, TCI codepoint 111 for Cell 2, and TCI codepoint 101 for Cell 3. Entry N−1 indicates/comprises TCI codepoint 111 for Cell 1, TCI codepoint 000 for Cell 2, and TCI codepoint 110 for Cell 3. Entry N indicates/comprises TCI codepoint 110 for Cell 1, TCI codepoint 100 for Cell 2, and TCI codepoint 011 for Cell 3.

The one or more configuration parameters may comprise a DCI-format parameter (e.g., dci-FormatsMC) of a search space set of the first cell. The search space set may be, for example, a user-specific search space (USS) set. The DCI-format parameter may indicate that the wireless device monitors, via/in the search space set of the first cell, downlink control channels for DCI format 0_3 and/or DCI format 1_3. The search space set may be mapped to (or associated with) a coreset. The one or more configuration parameters may indicate, for the search space set, the coreset. The first cell (or an active downlink BWP of the first cell) may comprise the coreset.

The one or more configuration parameters may indicate a plurality of TCI states for a cell. The one or more cells may comprise the cell. The one or more configuration parameters may comprise a TCI state list parameter (e.g., provided by a higher layer (e.g., RRC) parameter di-OrJoint-TCIStateList, or tci-States ToAddModList) indicating a TCI state list (e.g., TCI state list in FIG. 17). The TCI state list may comprise the plurality of TCI states. The one or more configuration parameters may comprise one or more PDSCH configuration parameters (e.g., PDSCH-Config), for example, comprising the TCI state list parameter that indicates the plurality of TCI states. For example, in FIG. 17, the plurality of TCI states in the TCI state list are TCI state 1, . . . , TCI state M.

The TCI state list parameter may be, for example, a list of downlink-or-joint TCI states parameter (e.g., dl-OrJoint-TCIStateList). The TCI state list parameter may be, for example, a list of TCI states parameter (e.g., tci-StatesToAddModList).

The one or more configuration parameters may indicate, for the plurality of TCI states, a plurality of TCI state indexes/identifiers/identities (e.g., TCI-StateId). The one or more configuration parameters may indicate, for each TCI state of the plurality of TCI states, a respective TCI state index of the plurality of TCI state indexes. Each TCI state of the plurality of TCI states may be indicated/identified by a respective TCI state index of the plurality of TCI state indexes. For example, the one or more configuration parameters may indicate, for a first TCI state of the plurality of TCI states, a first TCI state index of the plurality of TCI state indexes. The one or more configuration parameters may indicate, for a second TCI state of the plurality of TCI states, a second TCI state index of the plurality of TCI state indexes.

The one or more configuration parameters may indicate the plurality of TCI states that indicate a unified TCI state for the cell.

The one or more configuration parameters may comprise the one or more PDSCH configuration parameters, for example, for/of a downlink BWP (e.g., an active downlink BWP) of the cell. The one or more configuration parameters indicate the plurality of TCI states for the downlink BWP of the cell.

The one or more configuration parameters may comprise the one or more PDSCH configuration parameters, for example, for a second downlink BWP of a second cell. The one or more cells may comprise the second cell. The one or more configuration parameters indicate the plurality of TCI states for the second downlink BWP of the second cell. The one or more configuration parameters may comprise, for/of the downlink BWP of the cell, a reference unified TCI state list parameter (e.g., unifiedTCI-StateRef) indicating the second downlink BWP of the second cell. The reference unified TCI state list parameter may comprise a BWP index (e.g., BWP-Id) identifying/indicating the second downlink BWP. The reference unified TCI state list parameter may comprise a cell index (e.g., ServCellIndex) identifying/indicating the second cell. The second downlink BWP of the second cell may be a reference BWP of a reference cell for the downlink BWP of the cell. The downlink BWP of the cell may be a target BWP of a target cell. The one or more PDSCH configuration parameters of the downlink BWP of the cell may not comprise a higher layer (e.g., RRC) parameter dl-OrJoint-TCIStateList, for example, based on the one or more configuration parameters comprising, for the downlink BWP of the cell, the reference unified TCI state list parameter.

The one or more configuration parameters may comprise a unified-TCI-state-type parameter (e.g., unifiedtci-State Type). The one or more configuration parameters may comprise one or more serving cell parameters (e.g., ServingCellConfig) comprising the unified-TCI-state-type parameter. The unified-TCI-state-type parameter may indicate the unified TCI state type of the cell.

For example, the unified-TCI-state-type parameter may be set to “Joint”. The wireless device may use/apply the plurality of TCI states (e.g., provided/indicated by dl-OrJoint-TCIStateList) for both uplink transmissions (e.g., PUSCH/PUCCH/SRS transmissions) of/via the cell and downlink receptions (e.g., PDCCH/PDSCH/CSI-RS receptions) of/via the cell, for example, based on the one or more configuration parameters comprising the unified-TCI-state-type parameter set to “Joint”. The plurality of TCI states may be, for example, a plurality of joint TCI states.

For example, the unified-TCI-state-type parameter may be set to “Separate”. The wireless device may use/apply the plurality of TCI states (e.g., provided/indicated by a higher layer parameter dl-OrJoint-TCIStateList) for downlink receptions (e.g., PDCCH/PDSCH/CSI-RS receptions) of/via the cell, for example, based on the one or more configuration parameters comprising the unified-TCI-state-type parameter set to “Separate”. The wireless device may not use/apply the plurality of TCI states for uplink transmissions (e.g., PUSCH/PUCCH/SRS transmissions) of/via the cell, for example, based on the one or more configuration parameters comprising the unified-TCI-state-type parameter set to “Separate”. The plurality of TCI states may be, for example, a plurality of downlink TCI states.

The one or more configuration parameters may indicate a second plurality of TCI states. The one or more configuration parameters may comprise an uplink TCI state list parameter (e.g., provided/indicated by a higher layer parameter ul-TCI-StateList) indicating an uplink TCI state list. The uplink TCI state list may comprise the second plurality of TCI states. The one or more configuration parameters may comprise one or more uplink BWP configuration parameters comprising the uplink TCI state list parameter that indicates the second plurality of TCI states. For example, in FIG. 17, the second plurality of TCI states are TCI state 1, . . . , TCI state M.

The uplink TCI state list parameter may be, for example, a list of uplink TCI states parameter (e.g., ul-TCI-StateList).

The one or more configuration parameters may comprise the one or more uplink BWP configuration parameters, for example, for an uplink BWP (e.g., an active uplink BWP) of the cell. The one or more configuration parameters indicate the second plurality of TCI states for the uplink BWP of the cell.

The one or more configuration parameters may comprise the one or more uplink BWP configuration parameters, for example, for a second uplink BWP of a second cell. The one or more configuration parameters indicate the second plurality of TCI states for the second uplink BWP of the second cell. The one or more configuration parameters may comprise, for the uplink BWP of the cell, a reference unified TCI state list parameter (e.g., unifiedtci-State Type) indicating the second uplink BWP of the second cell. The reference unified TCI state list parameter may comprise a BWP index (e.g., BWP-Id) identifying/indicating the second uplink BWP. The reference unified TCI state list parameter may comprise a cell index (e.g., ServCellIndex) identifying/indicating the second cell. The second uplink BWP of the second cell may be a reference BWP of a reference cell for the uplink BWP of the cell. The uplink BWP of the cell may be a target BWP of a target cell. The one or more uplink BWP configuration parameters of the uplink BWP of the cell may not comprise a higher layer (e.g., RRC) parameter ul-TCI-StateList, for example, based on the one or more configuration parameters comprising, for the uplink BWP of the cell, the reference unified TCI state list parameter.

The wireless device may use/apply the second plurality of TCI states for uplink transmissions (e.g., PUSCH/PUCCH/SRS transmissions) of/via the cell, for example, based on the one or more configuration parameters comprising the unified-TCI-state-type parameter set to “Separate”. The wireless device may not use/apply the second plurality of TCI states for downlink receptions (e.g., PDCCH/PDSCH/CSI-RS receptions) of/via the cell, for example, based on the one or more configuration parameters comprising the unified-TCI-state-type parameter set to “Separate”. The second plurality of TCI states may be, for example, a plurality of uplink TCI states.

In an example, the wireless device may use, for downlink receptions via the downlink BWP of the cell, the plurality of TCI states, for example based on the one or more configuration parameters indicating the plurality of TCI states for the downlink BWP of the cell.

In an example, the wireless device may use, for uplink transmissions receptions via the uplink BWP of the cell, the plurality of TCI states, for example based on the one or more configuration parameters indicating the plurality of TCI states for the downlink BWP of the cell.

In an example, the wireless device may use, for downlink receptions via the downlink BWP of the cell, the plurality of TCI states of the second downlink BWP of the second cell, for example, based on the reference unified TCI state list parameter indicating, for the downlink BWP of the cell, the second downlink BWP of the second cell.

In an example, the wireless device may use, for uplink transmissions receptions via the uplink BWP of the cell, the plurality of TCI states of the second downlink BWP of the second cell, for example, based on the reference unified TCI state list parameter indicating, for the downlink BWP of the cell, the second downlink BWP of the second cell.

In an example, the wireless device may use, for uplink transmissions receptions via the uplink BWP of the cell, the second plurality of TCI states, for example based on the one or more configuration parameters indicating the second plurality of TCI states for the uplink BWP of the cell.

In an example, the wireless device may use, for uplink transmissions receptions via the uplink BWP of the cell, the second plurality of TCI states of the second uplink BWP of the second cell, for example, based on the reference unified TCI state list parameter indicating, for the uplink BWP of the cell, the second uplink BWP of the second cell.

The cell may be served by a plurality of TRPs comprising a first TRP and a second TRP. The wireless device may be served by the plurality of TRPs via the cell.

The wireless device may receive, via the cell, a first downlink reception (e.g., PDSCH, PDCCH, CSI-RS) from the first TRP. The first TRP may transmit, to the wireless device, the first downlink reception. The wireless device may receive, via the cell, a second downlink reception (e.g., PDSCH, PDCCH, CSI-RS) from the second TRP. The second TRP may transmit, to the wireless device, the second downlink reception.

The wireless device may transmit, via the cell, a first uplink transmission (e.g., PUSCH, PUCCH, SRS) to the first TRP. The first TRP may receive, from the wireless device, the first uplink transmission. The wireless device may transmit, via the cell, a second uplink transmission (e.g., PUSCH, PUCCH, SRS) to the second TRP. The second TRP may receive, from the wireless device, the second uplink transmission.

In an example, the one or more configuration parameters may indicate a plurality of control resource sets (coresets). The one or more configuration parameters may indicate the plurality of coresets for the (active) downlink BWP of the cell. The (active) downlink BWP may comprise the plurality of coresets.

In an example, the one or more configuration parameters may indicate, for the plurality of coresets, two coreset pool indexes comprising a first coreset pool index (e.g., CoresetPoolIndex=0) and a second coreset pool index (e.g., CoresetPoolIndex=1). The plurality of coresets may comprise one or more first coresets associated with the first coreset pool index and one or more second coresets associated with the second coreset pool index. The one or more configuration parameters may indicate, for the one or more first coresets, the first coreset pool index. The one or more configuration parameters may not indicate, for the one or more first coresets, a coreset pool index. The one or more configuration parameters may not indicate, for each coreset of the one or more first coresets, a coreset pool index. The one or more configuration parameters may indicate, for one or more second coresets of the plurality of coresets, the second coreset pool index. The one or more configuration parameters may indicate, for each coreset of the plurality of coresets, a respective coreset pool index of the two coreset pool indexes. The one or more configuration parameters may indicate, for the cell (or for the downlink BWP of the cell, the two coreset pool indexes.

In an example, the wireless device may receive at least two activation commands (e.g., MAC-CE, DCI, RRC, one or more control commands, one or more downlink control commands/messages, one or more control commands/messages, Unified TCI States Activation/Deactivation MAC CE, Enhanced Unified TCI States Activation/Deactivation MAC CE, The Enhanced Unified TCI States Activation/Deactivation MAC-CE for Joint TCI State Mode, Enhanced Unified TCI States Activation/Deactivation MAC-CE for Separate TCI State Mode and the like).

The wireless device may receive at least two activation commands, for example, when the one or more configuration parameters indicate two different values of coreset pool index for coreset(s) in the downlink BWP of the cell. The one or more configuration parameters may comprise one or more PDCCH configuration parameters (e.g., PDCCH-Config) that contain/comprise two different values of a higher layer parameter CORESETPoolIndex in different coresets (e.g., ControlResourceSets) of the downlink BWP of the cell. The at least two activation commands may comprise a first activation command (e.g., First MAC-CE in FIG. 17) and a second activation command (e.g., Second MAC-CE in FIG. 17).

For example, the at least two activation commands may indicate activation of a subset of TCI states of the plurality of TCI states (e.g., DLorJoint-TCIStateList). The subset of TCI states may be, for example, a subset of joint TCI states of the plurality of joint TCI states. The subset of TCI states may be, for example, a subset of downlink TCI states of the plurality of downlink TCI states.

For example, the at least two activation commands may indicate activation of a subset of TCI states of the second plurality of TCI states (e.g., ul-TCI-StateList). The subset of TCI states may be, for example, a subset of uplink TCI states of the plurality of uplink TCI states.

When the one or more configuration parameters comprise one or more PDCCH configuration parameters (e.g., PDCCH-Config) that contain/comprise two different values of a higher layer parameter CORESETPoolIndex in different coresets (e.g., ControlResourceSets), the subset of TCI states may comprise one or more first TCI states associated with a first coreset pool index (e.g., CoresetPoolIndex=0, Coreset pool index 0 in FIG. 17) and one or more second TCI states associated with a second coreset pool index (e.g., CoresetPoolIndex=1). For example, the first activation command of the one or more activation commands may indicate activation of the one or more first TCI states for the first coreset pool index (e.g., CoresetPoolIndex=0). The first activation command may comprise a field set to the first coreset pool index. The one or more first TCI states may be for (or associated) with the first TRP. The second activation command of the one or more activation commands may indicate activation of the one or more second TCI states for the second coreset pool index (e.g., CoresetPoolIndex=1, Coreset Pool index 1 in FIG. 17). The second activation command may comprise a field set to the second coreset pool index. The one or more second TCI states may be for (or associated) with the second TRP.

The base station may activate and/or deactivate the subset of TCI states, for example, by sending/transmitting the at least two activation commands.

The wireless device may map the subset of TCI states to one or more TCI codepoints of/for the cell. The one or more activation commands may indicate mapping of the subset of TCI states to the one or more TCI codepoints. The wireless device may map respective TCI state(s) of the subset of TCI states to a respective TCI codepoint of the one or more TCI codepoints. The one or more TCI codepoints may indicate/comprise the subset of TCI states. Each TCI codepoint of the one or more TCI codepoints may indicate (or may be mapped to) respective TCI state(s) of the subset of TCI states. Each TCI codepoint of the one or more TCI codepoints may indicate/comprise (or be mapped to) one or more TCI states.

When the one or more configuration parameters comprise one or more PDCCH configuration parameters (e.g., PDCCH-Config) that contain/comprise two different values of a higher layer parameter CORESETPoolIndex in different coresets (e.g., ControlResourceSets), the wireless device may map the one or more first TCI states to one or more first TCI codepoints. The one or more TCI codepoints may comprise the one or more first TCI codepoints. The first activation command may indicate mapping of the one or more first TCI states to the one or more first TCI codepoints. The wireless device may map each TCI state of the one or more first TCI states to a respective TCI codepoint of the one or more first TCI codepoints. The one or more first TCI codepoints may indicate/comprise the one or more first TCI states. Each TCI codepoint of the one or more first TCI codepoints may indicate (or may be mapped to) respective TCI state of the one or more first TCI states. Each TCI codepoint of the one or more first TCI codepoints may indicate/comprise (or be mapped to) one TCI state.

For example, in FIG. 17, the one or more first TCI states may be TCI state 9, TCI state 3, and TCI state 49. The one or more first TCI codepoints may/be comprise a first TCI codepoint (e.g., TCI codepoint 000), a second TCI codepoint (e.g., TCI codepoint 001), . . . , and an eight TCI codepoint (e.g., TCI codepoint 111). The first TCI codepoint (e.g., TCI codepoint 000) may comprise/indicate the TCI state 9. The second TCI codepoint (e.g., TCI codepoint 001) may comprise/indicate the TCI state 3. The eight TCI codepoint (e.g., TCI codepoint 111) may comprise/indicate the TCI state 5. For example, each TCI codepoint of the one or more first TCI codepoints may indicate a single TCI state (e.g., one joint TCI state, one uplink TCI state, one downlink TCI state, and the like).

When the one or more configuration parameters comprise one or more PDCCH configuration parameters (e.g., PDCCH-Config) that contain/comprise two different values of a higher layer parameter CORESETPoolIndex in different coresets (e.g., ControlResourceSets), the wireless device may map the one or more second TCI states to one or more second TCI codepoints. The one or more TCI codepoints may comprise the one or more second TCI codepoints. The second activation command may indicate mapping of the one or more second TCI states to the one or more second TCI codepoints. The wireless device may map each TCI state of the one or more second TCI states to a respective TCI codepoint of the one or more second TCI codepoints. The one or more second TCI codepoints may indicate/comprise the one or more second TCI states. Each TCI codepoint of the one or more second TCI codepoints may indicate (or may be mapped to) respective TCI state of the one or more second TCI states. Each TCI codepoint of the one or more second TCI codepoints may indicate/comprise (or be mapped to) one TCI state.

For example, in FIG. 17, the one or more second TCI states may be TCI state 2, TCI state 8, and TCI state 1. The one or more second TCI codepoints may/be comprise a first TCI codepoint (e.g., TCI codepoint 000), a second TCI codepoint (e.g., TCI codepoint 001), . . . , and an eight TCI codepoint (e.g., TCI codepoint 111). The first TCI codepoint (e.g., TCI codepoint 000) may comprise/indicate the TCI state 2. The second TCI codepoint (e.g., TCI codepoint 001) may comprise/indicate the TCI state 8. The eight TCI codepoint (e.g., TCI codepoint 111) may comprise/indicate the TCI state 1. For example, each TCI codepoint of the one or more second TCI codepoints may indicate a single TCI state (e.g., one joint TCI state, one uplink TCI state, one downlink TCI state, and the like).

The first activation command may comprise a plurality of fields.

A first field of the plurality of fields of the first activation command may be same as the first field (e.g., Serving Cell ID) of the plurality of fields of the activation command.

A second field of the plurality of fields of the first activation command may be same as the second field (e.g., BWP ID) of the plurality of fields of the activation command.

A third field (e.g., TCI state IDᵢ) of the plurality of fields of the first activation command may comprise a TCI state index/identifier/identity (e.g., TCI-StateId) identifying a TCI state of the plurality of TCI states. The plurality of TCI state indexes may comprise the TCI state index. In TCI state IDᵢ, i may be an index of a codepoint of a Transmission configuration indication (TCI) field in a DCI. TCI state IDᵢ may denote/be a TCI state indicated for the i^{th} codepoint in/of a Transmission Configuration Indication field in a DCI. For example, TCI state ID₀ may denote the TCI state indicated for a TCI codepoint 000. TCI state ID₁ may denote the TCI state indicated for a TCI codepoint 001. The first activation command may comprise TCI state index(es) of the one or more first TCI states. The first activation command may comprise a respective TCI state index, of the TCI state index(es), of each TCI state of the one or more first TCI states. The plurality of TCI state indexes may comprise the TCI state index(es) of the one or more first TCI states.

A TCI codepoint to which a TCI state is mapped may be determined, by the wireless device and/or the base station, by an ordinal position of the TCI codepoint among ordinal position(s) of TCI codepoint(s), i.e. the first TCI codepoint with TCI state ID₀ may be mapped to the codepoint value 0 (e.g., TCI codepoint 000), the second TCI codepoint with TCI state ID₁ may be mapped to the codepoint value 1 (e.g., TCI codepoint 001) and so on.

The first TCI codepoint (e.g., TCI codepoint 000) may comprise/indicate the TCI state 9. The TCI state 9 may be mapped to the first TCI codepoint (e.g., TCI codepoint 000). The second TCI codepoint (e.g., TCI codepoint 001) may comprise/indicate the TCI state 3. The TCI state 3 may be mapped to the second TCI codepoint (e.g., TCI codepoint 001), and so on. The eight TCI codepoint (e.g., TCI codepoint 111) may comprise/indicate the TCI state 5. The TCI state 5 may be mapped to the eight TCI codepoint (e.g., TCI codepoint 111), and so on.

A fourth field (e.g., Coreset pool index) of the plurality of fields of the first activation command may be/comprise a coreset pool index. When the fourth field is set/equal to zero (e.g., CoresetPoolIndex=0), the first activation command may indicate/activate the one or more first TCI states for the first coreset pool index that is equal to zero. The one or more first TCI states may be associated with (or may correspond to) the first coreset pool index that is equal to zero. The wireless device may receive downlink receptions associated with the first coreset pool index, for example, based on the one or more first TCI states. The wireless device may transmit uplink transmissions associated with the first coreset pool index, for example, based on the one or more first TCI states.

The second activation command may comprise a plurality of fields.

A first field of the plurality of fields of the second activation command may be same as the first field (e.g., Serving Cell ID) of the plurality of fields of the activation command.

A second field of the plurality of fields of the second activation command may be same as the second field (e.g., BWP ID) of the plurality of fields of the activation command.

A third field (e.g., TCI state IDᵢ) of the plurality of fields of the second activation command may comprise a TCI state index/identifier/identity (e.g., TCI-StateId) identifying a TCI state of the plurality of TCI states. The plurality of TCI state indexes may comprise the TCI state index. In TCI state IDᵢ, i may be an index of a codepoint of a Transmission configuration indication (TCI) field in a DCI. TCI state IDᵢ may denote/be a TCI state indicated for the i^{th} codepoint in/of a Transmission Configuration Indication field in a DCI. For example, TCI state ID₀ may denote the TCI state indicated for a TCI codepoint 000. TCI state ID1 may denote the TCI state indicated for a TCI codepoint 001. The second activation command may comprise TCI state index(es) of the one or more second TCI states. The second activation command may comprise a respective TCI state index, of the TCI state index(es), of each TCI state of the one or more second TCI states. The plurality of TCI state indexes may comprise the TCI state index(es) of the one or more second TCI states.

A TCI codepoint to which a TCI state is mapped may be determined, by the wireless device and/or the base station, by an ordinal position of the TCI codepoint among ordinal position(s) of TCI codepoint(s), i.e. the first TCI codepoint with TCI state ID₀ may be mapped to the codepoint value 0 (e.g., TCI codepoint 000), the second TCI codepoint with TCI state ID₁ may be mapped to the codepoint value 1 (e.g., TCI codepoint 001) and so on.

The first TCI codepoint (e.g., TCI codepoint 000) may comprise/indicate the TCI state 2. The TCI state 2 may be mapped to the first TCI codepoint (e.g., TCI codepoint 000). The second TCI codepoint (e.g., TCI codepoint 001) may comprise/indicate the TCI state 8. The TCI state 8 may be mapped to the second TCI codepoint (e.g., TCI codepoint 001), and so on. The eight TCI codepoint (e.g., TCI codepoint 111) may comprise/indicate the TCI state 1. The TCI state 1 may be mapped to the eight TCI codepoint (e.g., TCI codepoint 111), and so on.

A fourth field (e.g., Coreset pool index) of the plurality of fields of the second activation command may be/comprise a coreset pool index. When the fourth field is set/equal to one (e.g., CoresetPoolIndex=1), the second activation command may indicate/activate the one or more second TCI states for the second coreset pool index that is equal to one. The one or more second TCI states may be associated with (or may correspond to) the second coreset pool index that is equal to one. The wireless device may receive downlink receptions associated with the second coreset pool index, for example, based on the one or more second TCI states. The wireless device may transmit uplink transmissions associated with the second coreset pool index, for example, based on the one or more second TCI states.

The wireless device may receive at least two control commands.

The wireless device may receive the at least two control commands, for example, when the one or more configuration parameters indicate two different values of coreset pool index for coreset(s) in the downlink BWP of the cell. The one or more configuration parameters may comprise one or more PDCCH configuration parameters (e.g., PDCCH-Config) that contain/comprise two different values of a higher layer parameter CORESETPoolIndex in different coresets (e.g., ControlResourceSets) of the downlink BWP of the cell. The at least two control commands may comprise a first control command (e.g., First control command in FIG. 18) and a control command (e.g., Second control command in FIG. 18).

The first control command may be, for example, a first MAC-CE. The first control command may be, for example, a first DCI (e.g., DCI format 1_1, DCI format 1_2). The first control command may be, for example, a first downlink control command (e.g., activation command). The second control command may be, for example, a second MAC-CE. The second control command may be, for example, a second DCI (e.g., DCI format 1_1, DCI format 1_2). The second control command may be, for example, a second downlink control command (e.g., activation command).

The at least two control commands may indicate at least two TCI states of the subset of TCI states. The at least two TCI states may comprise a first TCI state and a second TCI state.

The first control command may indicate the first TCI state of the at least two TCI states. The one or more first TCI states associated with the first coreset pool index may comprise the first TCI state. The first TCI state may be associated with (or may be specific with or may be of) a higher layer parameter coresetPoolIndex with value 0. The first TCI state may be for (or associated with) the first TRP. The first control command may indicate the first TCI state, for example, for the first coreset pool index.

In an example, the first control command may indicate, for downlink receptions (e.g., PDCCH, PDSCH, CSI-RS) associated with the first coreset pool index and via the cell, the first TCI state.

In an example, the first control command may indicate, for uplink transmissions (e.g., PUCCH, PUSCH, SRS) associated with the first coreset pool index and via the cell, the first TCI state.

In an example, the first control command may indicate, for both uplink transmissions (e.g., PUCCH, PUSCH, SRS) associated with the first coreset pool index and downlink receptions (e.g., PDCCH, PDSCH, CSI-RS) associated with the first coreset pool index, the first TCI state.

The second control command may indicate the second TCI state of the at least two TCI states. The one or more second TCI states associated with the second coreset pool index may comprise the second TCI state. The second TCI state may be associated with (or may be specific with or may be of) a higher layer parameter coresetPoolIndex with value 1. The second TCI state may be for (or associated with) the second TRP. The second control command may indicate the second TCI state, for example, for the second coreset pool index.

In an example, the second control command may indicate, for downlink receptions (e.g., PDCCH, PDSCH, CSI-RS) associated with the second coreset pool index and via the cell, the second TCI state.

In an example, the second control command may indicate, for uplink transmissions (e.g., PUCCH, PUSCH, SRS) associated with the second coreset pool index and via the cell, the second TCI state.

In an example, the second control command may indicate, for both uplink transmissions (e.g., PUCCH, PUSCH, SRS) associated with the second coreset pool index and downlink receptions (e.g., PDCCH, PDSCH, CSI-RS) associated with the second coreset pool index, the second TCI state.

In an example, a number of the one or more first TCI codepoints may be equal to one (e.g., a single TCI codepoint). The single TCI codepoint may indicate the first TCI state. The first control command indicating the first TCI state may be the first activation command activating the one or more first TCI states based on the number of the one or more first TCI codepoints being equal to one. The first TCI state may be the one or more first TCI states based on the number of the one or more first TCI codepoints being equal to one. The first activation command may indicate the first TCI state based on the number of the one or more first TCI codepoints being equal to one.

In an example, a number of the one or more first TCI codepoints may be more than one. The first control command indicating the first TCI state may be different from the first activation command activating the one or more first TCI states based on the number of the one or more first TCI codepoints being more than one. The wireless device may receive the first control command after receiving the first activation command. The first control command (e.g., DCI) may comprise a TCI field indicating the first TCI state. A value of the TCI field may be equal to a first TCI codepoint, of the one or more first TCI codepoints, indicating the first TCI state. The first TCI state may be mapped to the first TCI codepoint. The wireless device may receive, via a first coreset with the first coreset pool index, the first control command.

In an example, a number of the one or more second TCI codepoints may be equal to one (e.g., a single TCI codepoint). The single TCI codepoint may indicate the second TCI state. The second control command indicating the second TCI state may be the second activation command activating the one or more second TCI states based on the number of the one or more second TCI codepoints being equal to one. The second TCI state may be the one or more second TCI states based on the number of the one or more second TCI codepoints being equal to one. The second activation command may indicate the second TCI state based on the number of the one or more second TCI codepoints being equal to one.

In an example, a number of the one or more second TCI codepoints may be more than one. The second control command indicating the second TCI state may be different from the second activation command activating the one or more second TCI states based on the number of the one or more second TCI codepoints being more than one. The wireless device may receive the second control command after receiving the second activation command. The second control command (e.g., DCI) may comprise a TCI field indicating the second TCI state. A value of the TCI field may be equal to a second TCI codepoint, of the one or more second TCI codepoints, indicating the second TCI state. The second TCI state may be mapped to the second TCI codepoint. The wireless device may receive, via a second coreset with the second coreset pool index, the second control command.

The at least two TCI states may be, for example, at least two joint TCI states. The first TCI state may be, for example, a first joint TCI state. The second TCI state may be, for example, a second joint TCI state.

The at least two TCI states may be, for example, at least two downlink TCI states. The first TCI state may be, for example, a first downlink TCI state. The second TCI state may be, for example, a second downlink TCI state.

The at least two TCI states may be, for example, at least two uplink TCI states. The first TCI state may be, for example, a first uplink TCI state. The second TCI state may be, for example, a second uplink TCI state.

The first TCI state may comprise/indicate a first reference signal (e.g., CSI-RS, SSB/PBCH block, DM-RS, SRS, and the like). The first TCI state may comprise/indicate a first quasi co-location type (e.g., QCL TypeA, QCL TypeB, QCL TypeC, QCL TypeD).

The second TCI state may comprise/indicate a second reference signal (e.g., CSI-RS, SSB/PBCH block, DM-RS, SRS, and the like). The second TCI state may comprise/indicate a second quasi co-location type (e.g., QCL TypeA, QCL TypeB, QCL TypeC, QCL TypeD).

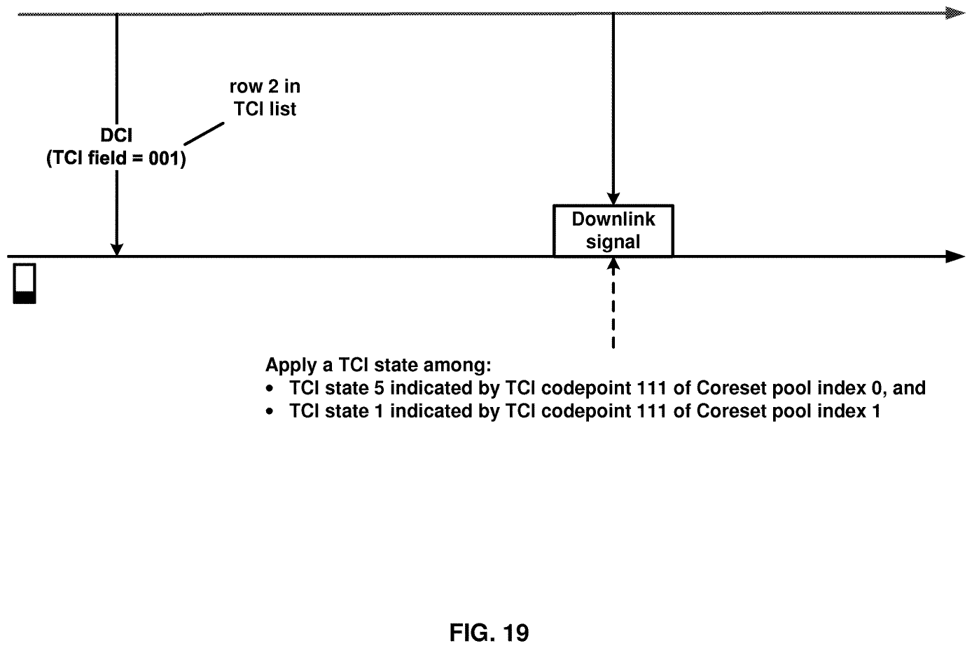

The wireless device may receive, via the first cell, a DCI (e.g., DCI in FIG. 18 and FIG. 19). The wireless device may receive, via/in the search space set of the first cell, the DCI. The wireless device may receive, via/in the coreset associated with the search space set, the DCI.

The DCI may be, for example, a DCI format 1_3.

The DCI may schedule one or more PDSCH receptions via one or more cells. The one or more cells may comprise the cell. The DCI may schedule each PDSCH reception of the one or more PDSCH receptions via a respective cell of the one or more cells. For example, the DCI may schedule a first PDSCH reception of the one or more PDSCH receptions via a first cell of the one or more cells. The DCI may schedule a second PDSCH reception of the one or more PDSCH receptions via a second cell of the one or more cells.

The DCI may be, for example, a DCI format 0_3.

The DCI may schedule one or more PUSCH transmissions via one or more cells. The one or more cells may comprise the cell. The DCI may schedule each PUSCH transmission of the one or more PUSCH transmissions via a respective cell of the one or more cells. For example, the DCI may schedule a first PUSCH transmission of the one or more PUSCH transmissions via a first cell of the one or more cells. The DCI may schedule a second PUSCH transmission of the one or more PUSCH transmissions via a second cell of the one or more cells.

The first cell may be, for example, a scheduling cell. The one or more cells may be, for example, one or more scheduled cells.

In an example, the one or more cells may comprise the first cell.

In an example, the one or more cells may not comprise the first cell.

The DCI may schedule a PDSCH reception via the cell. The one or more PDSCH receptions may comprise the PDSCH reception via the cell.

The DCI may schedule the PDSCH reception, for example, based on the DCI indicating resources for the PDSCH reception via the cell. The DCI may schedule the PDSCH reception, for example, based on the DCI comprising one or more fields (e.g., TDRA field, MCS field, FDRA field, BWP index, HARQ process index, and the like) used by the wireless device for the PDSCH reception via the cell.

The DCI may schedule a PUSCH transmission via the cell. The one or more PUSCH transmissions may comprise the PUSCH transmission via the cell.

The DCI may schedule the PUSCH transmission, for example, based on the DCI indicating resources for the PUSCH transmission via the cell. The DCI may schedule the PUSCH transmission, for example, based on the DCI comprising one or more fields (e.g., TDRA field, MCS field, FDRA field, BWP index, HARQ process index, and the like) used by the wireless device for the PUSCH transmission via the cell.

In an example, a number of the one or more sets of cells (e.g., MC-DCI-SetOfCells) may be greater than one. The DCI may comprise a scheduled cell set indicator field, for example, based on (or when) the number of the one or more sets of cells being greater than one. A value of the scheduled cell set indicator field may indicate a set of cells (or a scheduled cell set) among the one or more sets of cells. The value of the scheduled cell set indicator field may be equal to, for example, a set of cells identifier/identity/index (e.g., setOfCellsId) indicating/identfying the set of cells. The one or more set of cells identifiers/identities/indexes (e.g., setOfCellsId) may comprise the set of cells identifier/identity/index.

A set of cells may be (or may be interchangeably for example used with) a scheduled cell set).

In an example, a number of the one or more sets of cells (e.g., MC-DCI-SetOfCells) may be equal to one. The one or more sets of cells may be a set of cells. The DCI may not comprise a scheduled cell set indicator field, for example, based on (or when) the number of the one or more sets of cells being equal to one. The list-of-set-of-cells parameter may indicate the set of cells. The set of cells may be the one or more sets of cells indicated by the list-of-set-of-cells parameter.

The set of cells may comprise/indicate at least two cells (e.g., indicated by scheduledCellListDCI-1-3, indicated by scheduledCellListDCI-0-3). The one or more configuration parameters may comprise, for the set of cells, a scheduling cell list parameter (e.g., scheduledCellListDCI-1-3, scheduledCellListDCI-0-3) indicating the at least two cells. For example, in FIG. 17, the set of cells are/comprise/indicate Cell 1, Cell 2, and Cell 3. For example, in FIG. 17, the at least two cells in the set of cells are/comprise/indicate Cell 1, Cell 2, and Cell 3.

The one or more configuration parameters may comprise a list of scheduled cell combinations parameter (e.g., ScheduledCellCombo-ListDCI-1-3) indicating a table (e.g., Scheduled cell combo list/table in FIG. 17) for combinations of the at least two cells in the set of cells (or the set of cells or co-scheduled cells) for downlink scheduling via the DCI with a DCI format (e.g., DCI format 1_3).

The one or more configuration parameters may comprise a list of scheduled cell combinations parameter (e.g., ScheduledCellCombo-ListDCI-0-3) indicating a table (e.g., Scheduled cell combo list/table in FIG. 17) for combinations of the at least two cells in the set of cells (or the set of cells or co-scheduled cells) for uplink scheduling via the DCI with a DCI format (e.g., DCI format 0_3).

The table (e.g., Scheduled cell combo list/table in FIG. 17) may comprise one or more entries (or rows).

In an example, a number of entries/rows in the table indicated by the list of scheduled cell combinations parameter may be more/greater than one. A number of the one or more entries in the table may be more/greater than one. The DCI may comprise a scheduled cells indicator field, for example, based on (or when) the number being more/greater than one. A value of the scheduled cells indicator field may indicate an entry in the table. The one or more entries may comprise the entry. The entry may indicate the one or more cells scheduled by the DCI (e.g., DCI format 1_3, DCI format 0_3). The entry may indicate the one or more cells in/of the set of cells (or the scheduled cell set). The at least two cells in the set of cells may comprise the one or more cells.

For example, when the scheduled cells indicator field in the DCI indicates entry 2 in Scheduled cell combo list/table in FIG. 17, the one or more cells are Cell 1, Cell 2, and Cell 3. When the scheduled cells indicator field in the DCI indicates entry M−1 in Scheduled cell combo list/table in FIG. 17, the one or more cells are Cell 2 and Cell 3. When the scheduled cells indicator field in the DCI indicates entry M in Scheduled cell combo list/table in FIG. 17, the one or more cells is Cell 3.

The DCI may comprise one or more frequency domain resource assignment (FDRA) fields for the one or more cells. Each FDRA field of the one or more FDRA fields may be for a respective cell of the one or more cells.

A number of the one or more FDRA fields may be equal to a number of the one or more cells indicated by the scheduled cells indicator field.

In an example, a number of entries/rows in the table indicated by the list of scheduled cell combinations parameter may be equal to one. A number of the one or more entries in the table may be equal to one. The DCI may not comprise a scheduled cells indicator field, for example, based on (or when) the number being equal to one. The one or more entries in the table may be an entry. The entry may be a single entry in the table. The entry may indicate the one or more cells scheduled by the DCI (e.g., DCI format 1_3, DCI format 0_3). The list of scheduled cell combinations parameter may indicate the entry that indicates the one or more cells. The entry may indicate the one or more cells in/of the set of cells (or the scheduled cell set). The at least two cells in the set of cells may comprise the one or more cells. A number of the one or more FDRA fields may be equal to a number of the one or more cells indicated by the list of scheduled cell combinations parameter.

In an example, the one or more configuration parameters may not comprise a list of scheduled cell combinations parameter (e.g., ScheduledCellCombo-ListDCI-1-3, ScheduledCellCombo-ListDCI-0-3) for the set of cells (or the scheduled cell set). The DCI may not comprise a scheduled cells indicator field, for example, based on the one or more configuration parameters not comprising a list of scheduled cell combinations parameter.

The DCI may comprise at least two frequency domain resource assignment (FDRA) fields for the set of cells (or the at least two cells in the set of cells). Each FDRA field of the at least two FDRA fields may be for a respective cell of the at least two cells. The DCI may comprise the at least two FDRA fields for the set of cells, for example, based on the one or more configuration parameters not comprising a list of scheduled cell combinations parameter. A number of the at least two FDRA fields may be equal to a number of cells in the set of cells. A number of the at least two FDRA fields may be equal to a number of the at least two cells.

The at least two FDRA fields may indicate the one or more cells scheduled by the DCI. The at least two FDRA fields of the DCI may indicate that the one or more cells among the at least two cells in the set of cells are scheduled.

Each FDRA field of the at least two FDRA fields may indicate whether a respective cell in/of the set of cells is scheduled by the DCI or not. Each FDRA field of the at least two FDRA fields may indicate whether a respective cell of the at least two cells is scheduled by the DCI or not. Each FDRA field of the at least two FDRA fields may correspond to (or may be associated with) a respective cell in/of the set of cells (or of the at least two cells).

The DCI may not schedule a cell in the set of cells (or of the at least two cells), for example, based on an FDRA field, of the at least two FDRA fields, of the cell being set to zero (e.g., ‘0’) for resource allocation type 0, or set to one (e.g., ‘1’) for resource allocation type 1, or set to zero (e.g., ‘0’) or one (‘1’) for dynamic switch resource allocation type.

The DCI may schedule a cell in the set of cells (or of the at least two cells), for example, based on an FDRA field, of the at least two FDRA fields, of the cell not being set to zero (e.g., ‘0’) for resource allocation type 0, or not being set to one (e.g., ‘1’) for resource allocation type 1, or not being set to zero (e.g., ‘0’) and one (‘1’) for dynamic switch resource allocation type.

The DCI may schedule a cell in the set of cells (or of the at least two cells), for example, based on an FDRA field, of the at least two FDRA fields, of the cell being set to a value different from zero (e.g., ‘0’) for resource allocation type 0, or being set to a value different from one (e.g., ‘1’) for resource allocation type 1, or being set to a value different from zero (e.g., ‘0’) and one (‘1’) for dynamic switch resource allocation type.

The wireless device may receive, via the cell (or via the active downlink BWP of the cell), the PDSCH reception (e.g., Downlink signal in FIG. 18 and FIG. 19).

The wireless device may transmit, via the cell (or via the active uplink BWP of the cell), the PUSCH transmission (e.g., Uplink signal in FIG. 18).

In an example, the one or more configuration parameters may comprise the TCI state list parameter (e.g, dl-OrJointTCI-StateList). The one or more configuration parameters may comprise the list of downlink-or-joint TCI states parameter (e.g., dl-OrJoint-TCIStateList). The one or more configuration parameters may not comprise list of TCI states parameter (e.g., tci-States ToAddModList).

The one or more configuration parameters may not comprise the uplink TCI state list parameter (e.g., ul-TCI-StateList), for example, when the unified-TCI-state-type parameter is set to “Joint”. The one or more configuration parameters may comprise the uplink TCI state list parameter (e.g., ul-TCI-StateList), for example, when the unified-TCI-state-type parameter is set to “Separate”.

When the one or more configuration parameters comprise the list of downlink-or-joint TCI states parameter (e.g, dl-OrJointTCI-StateList) for/of the cell, the wireless device may receive the DCI (e.g., DCI in FIG. 18), for example, after the at least two control commands indicating the at least two TCI states for the cell. When the one or more configuration parameters comprise the list of downlink-or-joint TCI states parameter (e.g, dl-OrJointTCI-StateList) for/of the cell, the wireless device may receive the DCI (e.g., DCI in FIG. 18), for example, after the first control command indicating the first TCI state for the first coreset pool index and the second control command indicating the second TCI state for the second coreset pool index.

When the one or more configuration parameters comprise the list of downlink-or-joint TCI states parameter (e.g, dl-OrJointTCI-StateList) for/of the cell, the wireless device may receive the DCI (e.g., DCI in FIG. 18), for example, after application of the at least two TCI states indicated by the at least two control commands. When the one or more configuration parameters comprise the list of downlink-or-joint TCI states parameter (e.g, dl-OrJointTCI-StateList) for/of the cell, the wireless device may receive the DCI (e.g., DCI in FIG. 18), for example, after application of the first TCI state indicated by the first control command and application of the second TCI state indicated by the second control command. The DCI may be different from the at least two control commands. The DCI may be different from each control command of the at least two control commands.

The wireless device may receive, via the cell (or via the active downlink BWP of the cell), the PDSCH reception, for example, based on (or using) the first TCI state associated with (or specific to or indicated for) the first coreset pool index. The wireless device may use/apply the first TCI state associated with (or specific to or indicated for) the first coreset pool index for/to the PDSCH reception via the cell.

Receiving the PDSCH reception based on the first TCI state may comprise/be receiving the PDSCH reception using the first TCI state. Receiving the PDSCH reception based on the first TCI state may comprise/be applying the first TCI state to/for the PDSCH reception.

The first TCI state may be (or may be interchangeably used with) a default TCI state. The first coreset pool index may be (or may be interchangeably used with) a default coreset pool index.

The wireless device may receive, via the cell, the PDSCH reception based on the first TCI state associated with (or specific to or indicated for) the first coreset pool index, for example, in response to the wireless device being indicated with (or having) the first TCI state associated with (or specific to or indicated for) the first coreset pool index and the second TCI state associated with (or specific to or indicated for) the second coreset pool index.

The wireless device may receive, via the cell, the PDSCH reception based on the first TCI state associated with (or specific to or indicated for) the first coreset pool index, for example, in response to the one or more configuration parameters indicating, for the cell (or for the downlink BWP of the cell), the two coreset pool indexes.

When (or if or based on) the one or more configuration parameters comprise the TCI state list parameter (e.g, dl-OrJointTCI-StateList) for/of the cell, the wireless device may receive, via the cell, the PDSCH reception scheduled by the DCI (e.g., DCI format 1_3) based on the first TCI state associated with (or specific to or indicated for) the first coreset pool index.

When (or if or based on) the one or more configuration parameters comprise the TCI state list parameter (e.g, dl-OrJointTCI-StateList) for/of the cell and indicate the two coreset pool indexes for the cell, the wireless device may receive, via the cell, the PDSCH reception scheduled by the DCI (e.g., DCI format 1_3) based on the first TCI state associated with (or specific to or indicated for) the first coreset pool index.

The wireless device may not receive, via the cell (or via the active downlink BWP of the cell), the PDSCH reception, for example, based on (or using) the second TCI state associated with (or specific to or indicated for) the second coreset pool index. The wireless device may not use/apply the second TCI state associated with (or specific to or indicated for) the second coreset pool index for/to the PDSCH reception via the cell.

The wireless device may not receive, via the cell, the PDSCH reception based on the second TCI state associated with (or specific to or indicated for) the second coreset pool index, for example, in response to the one or more configuration parameters indicating, for the cell (or for the downlink BWP of the cell), the two coreset pool indexes.

When (or if or based on) the one or more configuration parameters comprise the TCI state list parameter (e.g, dl-OrJointTCI-StateList) for/of the cell, the wireless device may not receive, via the cell, the PDSCH reception scheduled by the DCI (e.g., DCI format 1_3) based on the second TCI state associated with (or specific to or indicated for) the second coreset pool index.

When (or if or based on) the one or more configuration parameters comprise the TCI state list parameter (e.g, dl-OrJointTCI-StateList) for/of the cell and indicate the two coreset pool indexes for the cell, the wireless device may not receive, via the cell, the PDSCH reception scheduled by the DCI (e.g., DCI format 1_3) based on the second TCI state associated with (or specific to or indicated for) the second coreset pool index.

The wireless device may transmit, via the cell (or via the active uplink BWP of the cell), the PUSCH transmission, for example, based on (or using) the first TCI state associated with (or specific to or indicated for) the first coreset pool index. The wireless device may use/apply the first TCI state associated with (or specific to or indicated for) the first coreset pool index for/to the PUSCH transmission via the cell.

Transmitting the PUSCH transmission based on the first TCI state may comprise/be transmitting the PUSCH transmission using the first TCI state. Transmitting the PUSCH transmission based on the first TCI state may comprise/be applying the first TCI state to/for the PUSCH transmission.

The first TCI state may be (or may be interchangeably used with) a default TCI state. The first coreset pool index may be (or may be interchangeably used with) a default coreset pool index.

The wireless device may transmit, via the cell, the PUSCH transmission based on the first TCI state associated with (or specific to or indicated for) the first coreset pool index, for example, in response to the wireless device being indicated with (or having) the first TCI state associated with (or specific to or indicated for) the first coreset pool index and the second TCI state associated with (or specific to or indicated for) the second coreset pool index.

The wireless device may transmit, via the cell, the PUSCH transmission based on the first TCI state associated with (or specific to or indicated for) the first coreset pool index, for example, in response to the one or more configuration parameters indicating, for the cell (or for the downlink BWP of the cell), the two coreset pool indexes.

When (or if or based on) the one or more configuration parameters comprise the TCI state list parameter (e.g, dl-OrJointTCI-StateList) and/or the uplink TCI state list parameter (e.g., ul-TCI-StateList) for/of the cell, the wireless device may transmit, via the cell, the PUSCH transmission scheduled by the DCI (e.g., DCI format 0_3) based on the first TCI state associated with (or specific to or indicated for) the first coreset pool index.

When (or if or based on) the one or more configuration parameters comprise the TCI state list parameter (e.g, dl-OrJointTCI-StateList) and/or the uplink TCI state list parameter (e.g., ul-TCI-StateList) for/of the cell and indicate the two coreset pool indexes for the cell, the wireless device may transmit, via the cell, the PUSCH transmission scheduled by the DCI (e.g., DCI format 0_3) based on the first TCI state associated with (or specific to or indicated for) the first coreset pool index.

The wireless device may not transmit, via the cell (or via the active uplink BWP of the cell), the PUSCH transmission, for example, based on (or using) the second TCI state associated with (or specific to or indicated for) the second coreset pool index. The wireless device may not use/apply the second TCI state associated with (or specific to or indicated for) the second coreset pool index for/to the PUSCH transmission via the cell.

The wireless device may not transmit, via the cell, the PUSCH transmission based on the second TCI state associated with (or specific to or indicated for) the second coreset pool index, for example, in response to the one or more configuration parameters indicating, for the cell (or for the downlink BWP of the cell), the two coreset pool indexes.

When (or if or based on) the one or more configuration parameters comprise the TCI state list parameter (e.g, dl-OrJointTCI-StateList) and/or the uplink TCI state list parameter (e.g., ul-TCI-StateList) for/of the cell, the wireless device may not transmit, via the cell, the PUSCH transmission scheduled by the DCI (e.g., DCI format 0_3) based on the second TCI state associated with (or specific to or indicated for) the second coreset pool index.

When (or if or based on) the one or more configuration parameters comprise the TCI state list parameter (e.g, dl-OrJointTCI-StateList) and/or the uplink TCI state list parameter (e.g., ul-TCI-StateList) for/of the cell and indicate the two coreset pool indexes for the cell, the wireless device may not transmit, via the cell, the PUSCH transmission scheduled by the DCI (e.g., DCI format 0_3) based on the second TCI state associated with (or specific to or indicated for) the second coreset pool index.

The one or more configuration parameters may indicate, for the coreset that the wireless device receives the DCI (e.g., DCI format 1_3) scheduling the PDSCH reception, a coreset pool index.

In an example, the coreset pool index of the coreset may be equal to the first coreset pool index. The wireless device may receive, via the cell, the PDSCH reception based on the first TCI state associated with (or specific to or indicated for) the first coreset pool index, for example, in response to the one or more configuration parameters indicating, for the coreset that the wireless device receives the DCI (e.g., DCI format 1_3) scheduling the PDSCH reception, the coreset pool index that is equal to the first coreset pool index. The wireless device may receive, via the cell, the PDSCH reception based on the first TCI state associated with (or specific to or indicated for) the first coreset pool index, for example, in response to the one or more configuration parameters indicating, for the coreset, the first coreset pool index. The wireless device may not receive, via the cell, the PDSCH reception based on the second TCI state associated with (or specific to or indicated for) the second coreset pool index, for example, in response to the one or more configuration parameters indicating, for the coreset that the wireless device receives the DCI (e.g., DCI format 1_3) scheduling the PDSCH reception, the coreset pool index that is equal to the first coreset pool index.

In an example, the coreset pool index of the coreset may be equal to the second coreset pool index. The wireless device may receive, via the cell, the PDSCH reception based on the second TCI state associated with (or specific to or indicated for) the second coreset pool index, for example, in response to the one or more configuration parameters indicating, for the coreset that the wireless device receives the DCI (e.g., DCI format 1_3) scheduling the PDSCH reception, the coreset pool index that is equal to the second coreset pool index. The wireless device may receive, via the cell, the PDSCH reception based on the second TCI state associated with (or specific to or indicated for) the second coreset pool index, for example, in response to the one or more configuration parameters indicating, for the coreset, the second coreset pool index. The wireless device may not receive, via the cell, the PDSCH reception based on the first TCI state associated with (or specific to or indicated for) the first coreset pool index, for example, in response to the one or more configuration parameters indicating, for the coreset that the wireless device receives the DCI (e.g., DCI format 1_3) scheduling the PDSCH reception, the coreset pool index that is equal to the second coreset pool index.

The one or more configuration parameters may indicate, for the coreset that the wireless device receives the DCI (e.g., DCI format 0_3) scheduling the PUSCH transmission, a coreset pool index.

In an example, the coreset pool index of the coreset may be equal to the first coreset pool index. The wireless device may transmit, via the cell, the PUSCH transmission based on the first TCI state associated with (or specific to or indicated for) the first coreset pool index, for example, in response to the one or more configuration parameters indicating, for the coreset that the wireless device receives the DCI (e.g., DCI format 0_3) scheduling the PUSCH transmission, the coreset pool index that is equal to the first coreset pool index. The wireless device may transmit, via the cell, the PUSCH transmission based on the first TCI state associated with (or specific to or indicated for) the first coreset pool index, for example, in response to the one or more configuration parameters indicating, for the coreset, the first coreset pool index. The wireless device may not transmit, via the cell, the PUSCH transmission based on the second TCI state associated with (or specific to or indicated for) the second coreset pool index, for example, in response to the one or more configuration parameters indicating, for the coreset that the wireless device receives the DCI (e.g., DCI format 0_3) scheduling the PUSCH transmission, the coreset pool index that is equal to the first coreset pool index.

In an example, the coreset pool index of the coreset may be equal to the second coreset pool index. The wireless device may transmit, via the cell, the PUSCH transmission based on the second TCI state associated with (or specific to or indicated for) the second coreset pool index, for example, in response to the one or more configuration parameters indicating, for the coreset that the wireless device receives the DCI (e.g., DCI format 0_3) scheduling the PUSCH transmission, the coreset pool index that is equal to the second coreset pool index. The wireless device may transmit, via the cell, the PUSCH transmission based on the second TCI state associated with (or specific to or indicated for) the second coreset pool index, for example, in response to the one or more configuration parameters indicating, for the coreset, the second coreset pool index. The wireless device may not transmit, via the cell, the PUSCH transmission based on the first TCI state associated with (or specific to or indicated for) the first coreset pool index, for example, in response to the one or more configuration parameters indicating, for the coreset that the wireless device receives the DCI (e.g., DCI format 0_3) scheduling the PUSCH transmission, the coreset pool index that is equal to the second coreset pool index.

In an example, the one or more configuration parameters may comprise a parameter (e.g., applyIndicatedTCIState, applyIndicatedTCI-StateDCI-1-3, and the like) with a value. The one or more configuration parameters may comprise one or more serving cell configuration parameters of the cell. In an example, the one or more serving cell configuration parameters may comprise the parameter. In an example, the one or more PDSCH configuration parameters may comprise the parameter.

The parameter (or the value of the parameter) may indicate whether to apply the first TCI state associated with (or specific to or indicated for) the first coreset pool index or the second TCI state associated with (or specific to or indicated for) the second coreset pool index to/for PDSCH reception(s) scheduled/activated by a DCI format (e.g., DCI format 1_3). The DCI format may be different from a DCI format 1_0.

In an example, the value of the parameter may be equal to a first value (e.g., 0, ‘first’). The wireless device may receive, via the cell, the PDSCH reception based on the first TCI state associated with (or specific to or indicated for) the first coreset pool index, for example, in response to the value of the parameter being equal to the first value. The wireless device may receive, via the cell, the PDSCH reception based on the first TCI state associated with (or specific to or indicated for) the first coreset pool index, for example, in response to the value of the parameter being equal to the first value that indicates to apply the first TCI state. The wireless device may not receive, via the cell, the PDSCH reception based on the second TCI state associated with (or specific to or indicated for) the second coreset pool index, for example, in response to the value of the parameter being equal to the first value.

In an example, the value of the parameter may be equal to a second value (e.g., 1, ‘second’). The wireless device may receive, via the cell, the PDSCH reception based on the second TCI state associated with (or specific to or indicated for) the second coreset pool index, for example, in response to the value of the parameter being equal to the second value. The wireless device may receive, via the cell, the PDSCH reception based on the second TCI state associated with (or specific to or indicated for) the second coreset pool index, for example, in response to the value of the parameter being equal to the second value that indicates to apply the second TCI state. The wireless device may not receive, via the cell, the PDSCH reception based on the first TCI state associated with (or specific to or indicated for) the first coreset pool index, for example, in response to the value of the parameter being equal to the second value.

In an example, the one or more configuration parameters may comprise a parameter (e.g., applyIndicatedTCIState, applyIndicatedTCI-StateDCI-0-3, and the like) with a value. The one or more configuration parameters may comprise one or more serving cell configuration parameters of the cell. In an example, the one or more serving cell configuration parameters may comprise the parameter. In an example, the one or more PUSCH configuration parameters may comprise the parameter.

The parameter (or the value of the parameter) may indicate whether to apply the first TCI state associated with (or specific to or indicated for) the first coreset pool index or the second TCI state associated with (or specific to or indicated for) the second coreset pool index to/for PUSCH transmission(s) scheduled/activated by a DCI format (e.g., DCI format 0_3). The DCI format may be different from a DCI format 0_0.

In an example, the value of the parameter may be equal to a first value (e.g., 0, ‘first’). The wireless device may transmit, via the cell, the PUSCH transmission based on the first TCI state associated with (or specific to or indicated for) the first coreset pool index, for example, in response to the value of the parameter being equal to the first value. The wireless device may transmit, via the cell, the PUSCH transmission based on the first TCI state associated with (or specific to or indicated for) the first coreset pool index, for example, in response to the value of the parameter being equal to the first value that indicates to apply the first TCI state. The wireless device may not transmit, via the cell, the PUSCH transmission based on the second TCI state associated with (or specific to or indicated for) the second coreset pool index, for example, in response to the value of the parameter being equal to the first value.

In an example, the value of the parameter may be equal to a second value (e.g., 1, ‘second’). The wireless device may transmit, via the cell, the PUSCH transmission based on the second TCI state associated with (or specific to or indicated for) the second coreset pool index, for example, in response to the value of the parameter being equal to the second value. The wireless device may transmit, via the cell, the PUSCH transmission based on the second TCI state associated with (or specific to or indicated for) the second coreset pool index, for example, in response to the value of the parameter being equal to the second value that indicates to apply the second TCI state. The wireless device may not transmit, via the cell, the PUSCH transmission based on the first TCI state associated with (or specific to or indicated for) the first coreset pool index, for example, in response to the value of the parameter being equal to the second value.

In an example, the parameter (or the field) indicating whether to apply the first TCI state or the second TCI state to/for PUSCH transmission(s) scheduled by the DCI format 0_3 may be different from the parameter (or the field) indicating whether to apply the first TCI state or the second TCI state to/for PDSCH reception(s) scheduled by the DCI format 1_3.

In an example, the parameter (or the field) indicating whether to apply the first TCI state or the second TCI state to/for PUSCH transmission(s) scheduled by the DCI format 0_3 may be the same as the parameter (or the field) indicating whether to apply the first TCI state or the second TCI state to/for PDSCH reception(s) scheduled by the DCI format 1_3.

In an example, the one or more configuration parameters may comprise a parameter (e.g., applyIndicatedTCIState, applyIndicatedTCI-StateDCI-1-3, and the like). The parameter may be present in the one or more configuration parameters.

The wireless device may receive, via the cell, the PDSCH reception based on the first TCI state associated with (or specific to or indicated for) the first coreset pool index, for example, in response to the one or more configuration parameters comprising the parameter. The wireless device may receive, via the cell, the PDSCH reception based on the first TCI state associated with (or specific to or indicated for) the first coreset pool index, for example, in response to the parameter being present in the one or more configuration parameters.

The wireless device may receive, via the cell, the PDSCH reception based on the second TCI state associated with (or specific to or indicated for) the second coreset pool index, for example, in response to the one or more configuration parameters comprising the parameter. The wireless device may receive, via the cell, the PDSCH reception based on the second TCI state associated with (or specific to or indicated for) the second coreset pool index, for example, in response to the parameter being present in the one or more configuration parameters.

In an example, the one or more configuration parameters may not comprise a parameter (e.g., applyIndicatedTCIState, applyIndicatedTCI-StateDCI-1-3, and the like). The parameter may be absent (or may not be present) in the one or more configuration parameters.

The wireless device may receive, via the cell, the PDSCH reception based on the first TCI state associated with (or specific to or indicated for) the first coreset pool index, for example, in response to the one or more configuration parameters not comprising the parameter. The wireless device may receive, via the cell, the PDSCH reception based on the first TCI state associated with (or specific to or indicated for) the first coreset pool index, for example, in response to the parameter being absent in the one or more configuration parameters.

The wireless device may receive, via the cell, the PDSCH reception based on the second TCI state associated with (or specific to or indicated for) the second coreset pool index, for example, in response to the one or more configuration parameters not comprising the parameter. The wireless device may receive, via the cell, the PDSCH reception based on the second TCI state associated with (or specific to or indicated for) the second coreset pool index, for example, in response to the parameter being absent in the one or more configuration parameters.

In an example, the one or more configuration parameters may comprise a parameter (e.g., applyIndicatedTCIState, applyIndicatedTCI-StateDCI-0-3, and the like). The parameter may be present in the one or more configuration parameters.

The wireless device may transmit, via the cell, the PUSCH transmission based on the first TCI state associated with (or specific to or indicated for) the first coreset pool index, for example, in response to the one or more configuration parameters comprising the parameter. The wireless device may transmit, via the cell, the PUSCH transmission based on the first TCI state associated with (or specific to or indicated for) the first coreset pool index, for example, in response to the parameter being present in the one or more configuration parameters.

The wireless device may transmit, via the cell, the PUSCH transmission based on the second TCI state associated with (or specific to or indicated for) the second coreset pool index, for example, in response to the one or more configuration parameters comprising the parameter. The wireless device may transmit, via the cell, the PUSCH transmission based on the second TCI state associated with (or specific to or indicated for) the second coreset pool index, for example, in response to the parameter being present in the one or more configuration parameters.

In an example, the one or more configuration parameters may not comprise a parameter (e.g., applyIndicatedTCIState, applyIndicatedTCI-StateDCI-0-3, and the like). The parameter may be absent (or may not be present) in the one or more configuration parameters.

The wireless device may transmit, via the cell, the PUSCH transmission based on the first TCI state associated with (or specific to or indicated for) the first coreset pool index, for example, in response to the one or more configuration parameters not comprising the parameter. The wireless device may transmit, via the cell, the PUSCH transmission based on the first TCI state associated with (or specific to or indicated for) the first coreset pool index, for example, in response to the parameter being absent in the one or more configuration parameters.

The wireless device may transmit, via the cell, the PUSCH transmission based on the second TCI state associated with (or specific to or indicated for) the second coreset pool index, for example, in response to the one or more configuration parameters not comprising the parameter. The wireless device may transmit, via the cell, the PUSCH transmission based on the second TCI state associated with (or specific to or indicated for) the second coreset pool index, for example, in response to the parameter being absent in the one or more configuration parameters.

In an example, the one or more configuration parameters may not comprise the list of downlink-or-joint TCI states parameter (e.g., dl-OrJoint-TCIStateList). In an example, the one or more configuration parameters may not comprise the list of TCI states parameter (e.g., tci-StatesToAddModList).

The DCI may comprise a TCI field. A value of the TCI field may indicate an entry/row in the TCI table (e.g., TCI list/table in FIG. 17). The one or more entries in the TCI table may comprise the entry. The entry may comprise/indicate at least two TCI codepoints (or at least two TCI indexes) for the set of cells (or for the at least two cells in the set of cells). The entry may comprise/indicate, for each cell of the at least two cells in the set of cells, a respective TCI codepoint of the at least two TCI codepoints (or a respective TCI index of the at least two TCI indexes)

For example, the value of the TCI field (e.g., TCI field=‘001’ in FIG. 19) may indicate entry 2 in the TCI table in FIG. 17. Entry 2 indicates/comprises TCI codepoint 010 for Cell 1, TCI codepoint 111 for Cell 2, and TCI codepoint 101 for Cell 3.

The at least two TCI codepoints in the entry may comprise a TCI codepoint of the cell. For example, in FIG. 17, when the cell is Cell 2 and the value of the TCI field of the DCI indicates entry 2 in the TCI table, the TCI codepoint is TCI codepoint 111. When the cell is Cell 2 and the value of the TCI field of the DCI indicates entry N in the TCI table, the TCI codepoint is TCI codepoint 100. When the cell is Cell 1 and the value of the TCI field of the DCI indicates entry 1 in the TCI table, the TCI codepoint is TCI codepoint 001.

The one or more TCI codepoints of the cell may comprise the TCI codepoint. The one or more first TCI codepoints associated/indicated/activated with/for the first coreset pool index or the one or more second TCI codepoints associated/indicated/activated with/for the second coreset pool index may comprise the TCI codepoint.

The DCI may indicate the TCI codepoint for the PDSCH reception via the cell.

The TCI codepoint may be (or may be interchangeably used with) a TCI index (or a TCI state index).

When the one or more first TCI codepoints associated/indicated/activated with/for the first coreset pool index may comprise the TCI codepoint, the TCI codepoint may indicate a first TCI state among the one or more first TCI states activated for (or corresponding to) the first coreset pool index. The TCI codepoint may not indicate a second TCI state among the one or more second TCI states activated for (or corresponding to) the second coreset pool index. The one or more second TCI codepoints associated/indicated/activated with/for the second coreset pool index may not comprise the TCI codepoint. For example, in FIG. 17, when the cell is Cell 2, TCI codepoint 111 in entry 2 of the TCI table indicates TCI state 5 indicated/activated/associated for/with the first coreset pool index. TCI codepoint 111 in entry 2 of the TCI table does not indicate TCI state 1 indicated/activated/associated for/with the second coreset pool index.

When the one or more second TCI codepoints associated/indicated/activated with/for the second coreset pool index may comprise the TCI codepoint, the TCI codepoint may indicate a second TCI state among the one or more second TCI states activated for (or corresponding to) the second coreset pool index. The TCI codepoint may not indicate a first TCI state among the one or more first TCI states activated for (or corresponding to) the first coreset pool index. The one or more first TCI codepoints associated/indicated/activated with/for the first coreset pool index may not comprise the TCI codepoint. For example, in FIG. 17, when the cell is Cell 2, TCI codepoint 111 in entry 2 of the TCI table indicates TCI state 1 indicated/activated/associated for/with the second coreset pool index. TCI codepoint 111 in entry 2 of the TCI table does not indicate TCI state 5 indicated/activated/associated for/with the first coreset pool index.

The first TCI state may comprise/indicate a first reference signal (e.g., CSI-RS, SSB/PBCH block, DM-RS, SRS, and the like). The first TCI state may comprise/indicate a first quasi co-location type (e.g., QCL TypeA, QCL TypeB, QCL TypeC, QCL TypeD).

The second TCI state may comprise/indicate a second reference signal (e.g., CSI-RS, SSB/PBCH block, DM-RS, SRS, and the like). The second TCI state may comprise/indicate a second quasi co-location type (e.g., QCL TypeA, QCL TypeB, QCL TypeC, QCL TypeD).

The wireless device may receive, via the cell (or via the active downlink BWP of the cell), the PDSCH reception, for example, based on (or using) the first TCI state (e.g., TCI state 5 in FIG. 19) among the one or more first TCI states associated with (or indicated/activated for) the first coreset pool index. The wireless device may use/apply the first TCI state, among the one or more first TCI states associated with (or indicated/activated for) the first coreset pool index, for/to the PDSCH reception via the cell.

The wireless device may receive, via the cell (or via the active downlink BWP of the cell), the PDSCH reception, for example, based on (or using) the first TCI state indicated by the TCI codepoint among the one or more first TCI codepoints associated with (or indicated/activated for) the first coreset pool index. The wireless device may use/apply the first TCI state, indicated by the TCI codepoint among the one or more first TCI states associated with (or indicated/activated for) the first coreset pool index, for/to the PDSCH reception via the cell. The one or more first TCI codepoints associated with (or indicated/activated for) the first coreset pool index may comprise the TCI codepoint in the entry in the TCI table.

The wireless device may receive the PDSCH reception based on (or using) the first TCI state among the one or more first TCI states associated with (or indicated/activated for) the first coreset pool index, for example, in response to the one or more configuration parameters indicating, for the cell (or for the downlink BWP of the cell), the two coreset pool indexes.

The wireless device may receive the PDSCH reception based on (or using) the first TCI state, indicated by the TCI codepoint among the one or more first TCI codepoints associated with (or indicated/activated for) the first coreset pool index, for example, in response to the one or more configuration parameters indicating, for the cell (or for the downlink BWP of the cell), the two coreset pool indexes. The one or more first TCI codepoints associated with (or indicated/activated for) the first coreset pool index may comprise the TCI codepoint in the entry in the TCI table, for example, based on the one or more configuration parameters indicating, for the cell (or for the downlink BWP of the cell), the two coreset pool indexes.

When (or if or based on) the one or more configuration parameters do not comprise the TCI state list parameter (e.g, dl-OrJointTCI-StateList) for/of the cell and indicate the two coreset pool indexes for the cell, the wireless device may receive, via the cell, the PDSCH reception scheduled by the DCI (e.g., DCI format 1_3) based on the first TCI state among the one or more first TCI states associated with (or indicated/activated for) the first coreset pool index.

When (or if or based on) the one or more configuration parameters do not comprise the TCI state list parameter (e.g, dl-OrJointTCI-StateList) for/of the cell and indicate the two coreset pool indexes for the cell, the wireless device may receive the PDSCH reception scheduled by the DCI (e.g., DCI format 1_3) based on the first TCI state indicated by the TCI codepoint among the one or more first TCI codepoints associated with (or indicated/activated for) the first coreset pool index. The one or more first TCI codepoints associated with (or indicated/activated for) the first coreset pool index may comprise the TCI codepoint in the entry in the TCI table.

The wireless device may not receive, via the cell (or via the active downlink BWP of the cell), the PDSCH reception, for example, based on (or using) the second TCI state among the one or more second TCI states associated with (or indicated/activated for) the second coreset pool index. The wireless device may not use/apply the second TCI state, among the one or more second TCI states associated with (or indicated/activated for) the second coreset pool index, for/to the PDSCH reception via the cell.

The wireless device may not receive, via the cell (or via the active downlink BWP of the cell), the PDSCH reception, for example, based on (or using) the second TCI state indicated by the TCI codepoint among the one or more second TCI codepoints associated with (or indicated/activated for) the second coreset pool index. The wireless device may not use/apply the second TCI state, indicated by the TCI codepoint among the one or more second TCI states associated with (or indicated/activated for) the second coreset pool index, for/to the PDSCH reception via the cell. The one or more second TCI codepoints associated with (or indicated/activated for) the second coreset pool index may not comprise the TCI codepoint in the entry in the TCI table.

The wireless device may not receive the PDSCH reception based on (or using) the second TCI state among the one or more second TCI states associated with (or indicated/activated for) the second coreset pool index, for example, in response to the one or more configuration parameters indicating, for the cell (or for the downlink BWP of the cell), the two coreset pool indexes.

The wireless device may not receive the PDSCH reception based on (or using) the second TCI state, indicated by the TCI codepoint among the one or more second TCI codepoints associated with (or indicated/activated for) the second coreset pool index, for example, in response to the one or more configuration parameters indicating, for the cell (or for the downlink BWP of the cell), the two coreset pool indexes. The one or more second TCI codepoints associated with (or indicated/activated for) the second coreset pool index may not comprise the TCI codepoint in the entry in the TCI table, for example, based on the one or more configuration parameters indicating, for the cell (or for the downlink BWP of the cell), the two coreset pool indexes.

When (or if or based on) the one or more configuration parameters do not comprise the TCI state list parameter (e.g, dl-OrJointTCI-StateList) for/of the cell and indicate the two coreset pool indexes for the cell, the wireless device may not receive, via the cell, the PDSCH reception scheduled by the DCI (e.g., DCI format 1_3) based on the second TCI state among the one or more second TCI states associated with (or indicated/activated for) the second coreset pool index.

When (or if or based on) the one or more configuration parameters do not comprise the TCI state list parameter (e.g, di-OrJointTCI-StateList) for/of the cell and indicate the two coreset pool indexes for the cell, the wireless device may not receive the PDSCH reception scheduled by the DCI (e.g., DCI format 1_3) based on the second TCI state indicated by the TCI codepoint among the one or more second TCI codepoints associated with (or indicated/activated for) the second coreset pool index. The one or more second TCI codepoints associated with (or indicated/activated for) the second coreset pool index may not comprise the TCI codepoint in the entry in the TCI table.

The one or more configuration parameters may indicate, for the coreset that the wireless device receives the DCI (e.g., DCI format 1_3) scheduling the PDSCH reception, a coreset pool index.

In an example, the coreset pool index of the coreset may be equal to the first coreset pool index.

The wireless device may receive the PDSCH reception based on (or using) the first TCI state among the one or more first TCI states associated with (or indicated/activated for) the first coreset pool index, for example, in response to the one or more configuration parameters indicating, for the coreset that the wireless device receives the DCI (e.g., DCI format 1_3) scheduling the PDSCH reception, the coreset pool index that is equal to the first coreset pool index. The wireless device may not receive the PDSCH reception based on (or using) the second TCI state among the one or more second TCI states associated with (or indicated/activated for) the second coreset pool index, for example, in response to the one or more configuration parameters indicating, for the coreset that the wireless device receives the DCI (e.g., DCI format 1_3) scheduling the PDSCH reception, the coreset pool index that is equal to the first coreset pool index.

The wireless device may receive the PDSCH reception based on (or using) the first TCI state, indicated by the TCI codepoint among the one or more first TCI codepoints associated with (or indicated/activated for) the first coreset pool index, for example, in response to the one or more configuration parameters indicating, for the coreset that the wireless device receives the DCI (e.g., DCI format 1_3) scheduling the PDSCH reception, the coreset pool index that is equal to the first coreset pool index. The wireless device may not receive the PDSCH reception based on (or using) the second TCI state, indicated by the TCI codepoint among the one or more second TCI codepoints associated with (or indicated/activated for) the second coreset pool index, for example, in response to the one or more configuration parameters indicating, for the coreset that the wireless device receives the DCI (e.g., DCI format 1_3) scheduling the PDSCH reception, the coreset pool index that is equal to the first coreset pool index.

The wireless device may receive the PDSCH reception based on (or using) the first TCI state among the one or more first TCI states associated with (or indicated/activated for) the first coreset pool index, for example, in response to the one or more configuration parameters indicating, for the coreset that the wireless device receives the DCI (e.g., DCI format 1_3) scheduling the PDSCH reception, the first coreset pool index.

The wireless device may receive the PDSCH reception based on (or using) the first TCI state, indicated by the TCI codepoint among the one or more first TCI codepoints associated with (or indicated/activated for) the first coreset pool index, for example, in response to the one or more configuration parameters indicating, for the coreset that the wireless device receives the DCI (e.g., DCI format 1_3) scheduling the PDSCH reception, the first coreset pool index.

In an example, the coreset pool index of the coreset may be equal to the second coreset pool index.

The wireless device may receive the PDSCH reception based on (or using) the second TCI state among the one or more second TCI states associated with (or indicated/activated for) the second coreset pool index, for example, in response to the one or more configuration parameters indicating, for the coreset that the wireless device receives the DCI (e.g., DCI format 1_3) scheduling the PDSCH reception, the coreset pool index that is equal to the second coreset pool index. The wireless device may not receive the PDSCH reception based on (or using) the first TCI state among the one or more first TCI states associated with (or indicated/activated for) the first coreset pool index, for example, in response to the one or more configuration parameters indicating, for the coreset that the wireless device receives the DCI (e.g., DCI format 1_3) scheduling the PDSCH reception, the coreset pool index that is equal to the second coreset pool index.

The wireless device may receive the PDSCH reception based on (or using) the second TCI state, indicated by the TCI codepoint among the one or more second TCI codepoints associated with (or indicated/activated for) the second coreset pool index, for example, in response to the one or more configuration parameters indicating, for the coreset that the wireless device receives the DCI (e.g., DCI format 1_3) scheduling the PDSCH reception, the coreset pool index that is equal to the second coreset pool index. The wireless device may not receive the PDSCH reception based on (or using) the first TCI state, indicated by the TCI codepoint among the one or more first TCI codepoints associated with (or indicated/activated for) the first coreset pool index, for example, in response to the one or more configuration parameters indicating, for the coreset that the wireless device receives the DCI (e.g., DCI format 1_3) scheduling the PDSCH reception, the coreset pool index that is equal to the second coreset pool index.

The wireless device may receive the PDSCH reception based on (or using) the second TCI state among the one or more second TCI states associated with (or indicated/activated for) the second coreset pool index, for example, in response to the one or more configuration parameters indicating, for the coreset that the wireless device receives the DCI (e.g., DCI format 1_3) scheduling the PDSCH reception, the second coreset pool index.

The wireless device may receive the PDSCH reception based on (or using) the second TCI state, indicated by the TCI codepoint among the one or more second TCI codepoints associated with (or indicated/activated for) the second coreset pool index, for example, in response to the one or more configuration parameters indicating, for the coreset that the wireless device receives the DCI (e.g., DCI format 1_3) scheduling the PDSCH reception, the second coreset pool index.

In an example, the one or more configuration parameters may comprise a parameter (e.g., applyIndicatedTCIState, applyIndicatedTCI-StateDCI-1-3, and the like) with a value. The one or more configuration parameters may comprise one or more serving cell configuration parameters of the cell. In an example, the one or more serving cell configuration parameters may comprise the parameter. In an example, the one or more PDSCH configuration parameters may comprise the parameter.

The parameter (or the value of the parameter) may indicate whether to apply the first TCI state among the one or more first TCI states associated with (or indicated/activated for) the first coreset pool index or the second TCI state among the one or more second TCI states associated with (or indicated/activated for) the second coreset pool index to/for PDSCH reception(s) scheduled/activated by a DCI format (e.g., DCI format 1_3). The DCI format may be different from a DCI format 1_0.

The parameter (or the value of the parameter) may indicate whether the TCI codepoint indicates the first TCI state among the one or more first TCI states associated with (or indicated/activated for) the first coreset pool index or the second TCI state among the one or more second TCI states associated with (or indicated/activated for) the second coreset pool index to apply to/for PDSCH reception(s) scheduled/activated by a DCI format (e.g., DCI format 1_3).

The parameter (or the value of the parameter) may indicate whether the one or more first TCI codepoints associated with (or indicated/activated for) the first coreset pool index comprises the TCI codepoint or the one or more second TCI codepoints associated with (or indicated/activated for) the second coreset pool index comprises the TCI codepoint.

In an example, the value of the parameter may be equal to a first value (e.g., 0, ‘first’). The wireless device may receive, via the cell, the PDSCH reception based on the first TCI state among the one or more first TCI states associated with (or indicated/activated for) the first coreset pool index, for example, in response to the value of the parameter being equal to the first value. The wireless device may not receive, via the cell, the PDSCH reception based on the second TCI state among the one or more second TCI states associated with (or indicated/activated for) the second coreset pool index, for example, in response to the value of the parameter being equal to the first value.

The wireless device may receive, via the cell, the PDSCH reception based on the first TCI state indicated by the TCI codepoint among the one or more first TCI codepoints associated with (or indicated/activated for) the first coreset pool index, for example, in response to the value of the parameter being equal to the first value. The wireless device may not receive, via the cell, the PDSCH reception based on the second TCI state indicated by the TCI codepoint among the one or more second TCI codepoints associated with (or indicated/activated for) the second coreset pool index, for example, in response to the value of the parameter being equal to the first value.

In an example, the value of the parameter may be equal to a second value (e.g., 1, ‘second’). The wireless device may receive, via the cell, the PDSCH reception based on the second TCI state among the one or more second TCI states associated with (or indicated/activated for) the second coreset pool index, for example, in response to the value of the parameter being equal to the second value. The wireless device may not receive, via the cell, the PDSCH reception based on the first TCI state among the one or more first TCI states associated with (or indicated/activated for) the first coreset pool index, for example, in response to the value of the parameter being equal to the second value.

The wireless device may receive, via the cell, the PDSCH reception based on the second TCI state indicated by the TCI codepoint among the one or more second TCI codepoints associated with (or indicated/activated for) the second coreset pool index, for example, in response to the value of the parameter being equal to the second value. The wireless device may not receive, via the cell, the PDSCH reception based on the first TCI state indicated by the TCI codepoint among the one or more first TCI codepoints associated with (or indicated/activated for) the first coreset pool index, for example, in response to the value of the parameter being equal to the second value.

In an example, the one or more configuration parameters may comprise a parameter (e.g., applyIndicatedTCIState, applyIndicatedTCI-StateDCI-1-3, and the like). The parameter may be present in the one or more configuration parameters.

The wireless device may receive, via the cell, the PDSCH reception based on the first TCI state among the one or more first TCI states associated with (or indicated/activated for) the first coreset pool index, for example, in response to the one or more configuration parameters comprising the parameter (or the parameter being present in the one or more configuration parameters). The wireless device may not receive, via the cell, the PDSCH reception based on the second TCI state among the one or more second TCI states associated with (or indicated/activated for) the second coreset pool index, for example, in response to the one or more configuration parameters comprising the parameter (or the parameter being present in the one or more configuration parameters).

The wireless device may receive, via the cell, the PDSCH reception based on the first TCI state indicated by the TCI codepoint among the one or more first TCI codepoints associated with (or indicated/activated for) the first coreset pool index, for example, in response to the one or more configuration parameters comprising the parameter (or the parameter being present in the one or more configuration parameters). The wireless device may not receive, via the cell, the PDSCH reception based on the second TCI state indicated by the TCI codepoint among the one or more second TCI codepoints associated with (or indicated/activated for) the second coreset pool index, for example, in response to the one or more configuration parameters comprising the parameter (or the parameter being present in the one or more configuration parameters).

The wireless device may receive, via the cell, the PDSCH reception based on the second TCI state among the one or more second TCI states associated with (or indicated/activated for) the second coreset pool index, for example, in response to the one or more configuration parameters comprising the parameter (or the parameter being present in the one or more configuration parameters). The wireless device may not receive, via the cell, the PDSCH reception based on the first TCI state among the one or more first TCI states associated with (or indicated/activated for) the first coreset pool index, for example, in response to the one or more configuration parameters comprising the parameter (or the parameter being present in the one or more configuration parameters).

The wireless device may receive, via the cell, the PDSCH reception based on the second TCI state indicated by the TCI codepoint among the one or more second TCI codepoints associated with (or indicated/activated for) the second coreset pool index, for example, in response to the one or more configuration parameters comprising the parameter (or the parameter being present in the one or more configuration parameters). The wireless device may not receive, via the cell, the PDSCH reception based on the first TCI state indicated by the TCI codepoint among the one or more first TCI codepoints associated with (or indicated/activated for) the first coreset pool index, for example, in response to the one or more configuration parameters comprising the parameter (or the parameter being present in the one or more configuration parameters).

In an example, the one or more configuration parameters may not comprise a parameter (e.g., applyIndicatedTCIState, applyIndicatedTCI-StateDCI-1-3, and the like). The parameter may be absent (or may not be present) in the one or more configuration parameters.

The wireless device may receive, via the cell, the PDSCH reception based on the first TCI state among the one or more first TCI states associated with (or indicated/activated for) the first coreset pool index, for example, in response to the one or more configuration parameters not comprising the parameter (or the parameter being absent in the one or more configuration parameters). The wireless device may not receive, via the cell, the PDSCH reception based on the second TCI state among the one or more second TCI states associated with (or indicated/activated for) the second coreset pool index, for example, in response to the one or more configuration parameters not comprising the parameter (or the parameter being absent in the one or more configuration parameters).

The wireless device may receive, via the cell, the PDSCH reception based on the first TCI state indicated by the TCI codepoint among the one or more first TCI codepoints associated with (or indicated/activated for) the first coreset pool index, for example, in response to the one or more configuration parameters not comprising the parameter (or the parameter being absent in the one or more configuration parameters). The wireless device may not receive, via the cell, the PDSCH reception based on the second TCI state indicated by the TCI codepoint among the one or more second TCI codepoints associated with (or indicated/activated for) the second coreset pool index, for example, in response to the one or more configuration parameters not comprising the parameter (or the parameter being absent in the one or more configuration parameters).

When the wireless device receives the PDSCH reception based on (or using) the first TCI state, at least one DM-RS port (or DM-RS antenna port) of the PDSCH reception may be quasi co-located with the first reference signal indicated by the first TCI state. The at least one DM-RS port of the PDSCH reception may be quasi co-located with the first reference signal with respect to the first quasi co-location type indicated by the first TCI state.

The wireless device may receive the PDSCH reception with/using a first spatial domain reception/receiving filter. The wireless device may receive the PDSCH reception with/using the first spatial domain reception/receiving filter that is determined based on the first reference signal indicated by the first TCI state. The wireless device may receive the PDSCH reception with/using the first spatial domain reception/receiving filter that is the same (or substantially same) as a spatial domain reception/receiving filter used to receive the first reference signal indicated by the first TCI state. The wireless device may determine the first spatial domain reception/receiving filter used to receive the PDSCH reception, for example, based on the first reference signal indicated by the first TCI state.

When the wireless device receives the PDSCH reception based on (or using) the second TCI state, at least one DM-RS port (or DM-RS antenna port) of the PDSCH reception may be quasi co-located with the second reference signal indicated by the second TCI state. The at least one DM-RS port of the PDSCH reception may be quasi co-located with the second reference signal with respect to the second quasi co-location type indicated by the second TCI state.

The wireless device may receive the PDSCH reception with/using a second spatial domain reception/receiving filter. The wireless device may receive the PDSCH reception with/using the second spatial domain reception/receiving filter that is determined based on the second reference signal indicated by the second TCI state. The wireless device may receive the PDSCH reception with/using the second spatial domain reception/receiving filter that is the same (or substantially same) as a spatial domain reception/receiving filter used to receive the second reference signal indicated by the second TCI state. The wireless device may determine the second spatial domain reception/receiving filter used to receive the PDSCH reception, for example, based on the second reference signal indicated by the second TCI state.

When the wireless device transmits the PUSCH transmission based on (or using) the first TCI state, the wireless device may use/apply the first TCI state for/to the PUSCH transmission via the cell. The wireless device may transmit the PUSCH transmission with/using a first spatial domain

transmission/transmit filter. The wireless device may transmit the PUSCH transmission with/using the first spatial domain transmission/transmit filter that is determined based on the first reference signal indicated by the first TCI state. The wireless device may transmit the PUSCH transmission with/using the first spatial domain transmission/transmit filter that is the same (or substantially same) as a spatial domain reception/receiving filter used to receive the first reference signal indicated by the first TCI state. The wireless device may determine the first spatial domain transmission/transmit filter used to transmit the PUSCH transmission, for example, based on the first reference signal indicated by the first TCI state. The wireless device may determine the first spatial domain transmission/transmit filter used to transmit the PUSCH transmission, for example, based on the spatial domain reception/receiving filter used to receive the first reference signal indicated by the first TCI state.

The wireless device may transmit the PUSCH transmission with/using a first transmission power that is determined based on the first TCI state. The wireless device may determine/calculate the first transmission power based on one or more first power control parameters (e.g., pathloss reference signal, pathloss compensation factor, target received power, closed-loop index) associated with (or mapped to or included in or indicated by) the first TCI state. The one or more configuration parameters may indicate/map the one or more first power control parameters for/to the first TCI state.

When the wireless device transmits the PUSCH transmission based on (or using) the second TCI state, the wireless device may use/apply the second TCI state for/to the PUSCH transmission via the cell.

The wireless device may transmit the PUSCH transmission with/using a second spatial domain transmission/transmit filter. The wireless device may transmit the PUSCH transmission with/using the second spatial domain transmission/transmit filter that is determined based on the second reference signal indicated by the second TCI state. The wireless device may transmit the PUSCH transmission with/using the second spatial domain transmission/transmit filter that is the same (or substantially same) as a spatial domain reception/receiving filter used to receive the second reference signal indicated by the second TCI state. The wireless device may determine the second spatial domain transmission/transmit filter used to transmit the PUSCH transmission, for example, based on the second reference signal indicated by the second TCI state. The wireless device may determine the second spatial domain transmission/transmit filter used to transmit the PUSCH transmission, for example, based on the spatial domain reception/receiving filter used to receive the second reference signal indicated by the second TCI state.

The wireless device may transmit the PUSCH transmission with/using a second transmission power that is determined based on the second TCI state. The wireless device may determine/calculate the second transmission power based on one or more second power control parameters (e.g., pathloss reference signal, pathloss compensation factor, target received power, closed-loop index) associated with (or mapped to or included in or indicated by) the second TCI state. The one or more configuration parameters may indicate/map the one or more second power control parameters for/to the second TCI state.

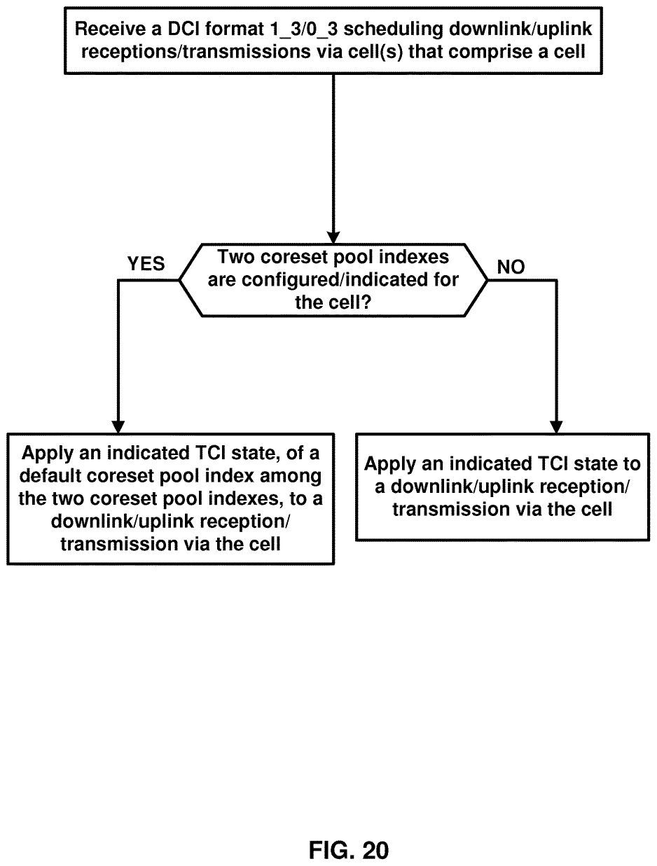

FIG. 20 illustrates an example flow chart of cell scheduling as per an aspect of an embodiment of the present disclosure.

A wireless device may receive one or more messages comprising one or more configuration parameters. A base station may transmit, to the wireless device, the one or more messages.

The one or more configuration parameters may indicate a plurality of transmission configuration indicator (TCI) states for a cell.

The one or more configuration parameters may indicate a TCI table (or a TCI list) for a plurality of cells that comprise the cell.

The wireless device may receive a DCI (e.g., DCI format 1_3) scheduling one or more PDSCH receptions via one or more cells that comprise the cell. The base station may transmit the DCI. The DCI may schedule each PDSCH reception of the one or more PDSCH receptions via/for a respective cell of the one or more cells. The DCI may schedule a PDSCH reception of the one or more PDSCH receptions via/for the cell. The plurality of cells may comprise the one or more cells.

The wireless device may receive a DCI (e.g., DCI format 0_3) scheduling one or more PUSCH transmissions via one or more cells that comprise the cell. The base station may transmit the DCI. The DCI may schedule each PUSCH transmission of the one or more PUSCH transmissions via/for a respective cell of the one or more cells. The DCI may schedule a PUSCH transmission of the one or more PUSCH transmissions via/for the cell. The plurality of cells may comprise the one or more cells.

The one or more configuration parameters may not indicate two coreset pool indexes for the cell (or for an active downlink BWP of the cell).

The wireless device may receive a medium-access control (MAC) control element (CE) indicating mapping of a subset of TCI states of the plurality of TCI states to one or more TCI codepoints. The MAC-CE may indicate activation of the subset of TCI states. The subset of TCI states may comprise/be one or more TCI states of the plurality of TCI states. The base station may transmit the MAC-CE.

In an example, the one or more configuration parameters may comprise a list of downlink-or-joint TCI states parameter (e.g., dl-OrJointTCI-StateList) for/of the cell. The list of downlink-or-joint TCI states parameter may indicate the plurality of TCI states.

In an example, the one or more configuration parameters may comprise a list of uplik TCI states parameter (e.g., ul-TCI-StateList) for/of the cell. The list of uplink TCI states parameter may indicate the plurality of TCI states.

The wireless device may receive a control command (e.g., MAC-CE, DCI) indicating a TCI state among the subset of TCI states. The base station may transmit the control command.

The control command may be the MAC-CE, for example, when a number of the one or more TCI codepoints is one. The TCI state may be the subset of TCI states.

In an example, the control command may be a DCI format 1_1/1_2/1_3 different from the DCI. The control command may be a DCI format 1_1/1_2/1_3, for example, when a number of the one or more TCI codepoints is greater/more than one. The wireless device may receive the DCI format 1_1/1_2/1_3 before receiving the DCI.

In an example, the one or more configuration parameters may not comprise a list of downlink-or-joint TCI states parameter (e.g., dl-OrJointTCI-StateList) for/of the cell. The DCI (e.g., DCI format 1_3) may comprise a TCI field with a value. The value of the TCI field may indicate an entry/row in the TCI table. The entry/row may comprise a TCI codepoint (or a TCI index) for the cell. The DCI may indicate, for the TCI field in the DCI, the TCI codepoint. The TCI codepoint may indicate a TCI state.

The wireless device may receive, via the cell (or via the active downlink BWP of the cell), the PDSCH reception based on (or using) the (indicated) TCI state. The wireless device may receive, via the cell (or via the active downlink BWP of the cell), the PDSCH reception based on (or using) the (indicated) TCI state, for example, in response to the one or more configuration parameters not indicating two coreset pool indexes for the cell (or for the active downlink BWP of the cell). The base station may transmit via the cell (or via the active downlink BWP of the cell), the PDSCH transmission based on (or using) the (indicated) TCI state. The base station may transmit, via the cell (or via the active downlink BWP of the cell), the PDSCH transmission based on (or using) the (indicated) TCI state, for example, in response to the one or more configuration parameters not indicating two coreset pool indexes for the cell (or for the active downlink BWP of the cell).

The wireless device may transmit, via the cell (or via an active uplink BWP of the cell), the PUSCH transmission based on (or using) the (indicated) TCI state. The wireless device may transmit, via the cell (or via the active uplink BWP of the cell), the PUSCH transmission based on (or using) the (indicated) TCI state, for example, in response to the one or more configuration parameters not indicating two coreset pool indexes for the cell (or for the active downlink BWP of the cell). The base station may receive, via the cell (or via an active uplink BWP of the cell), the PUSCH transmission based on (or using) the (indicated) TCI state. The base station may receive, via the cell (or via the active uplink BWP of the cell), the PUSCH transmission based on (or using) the (indicated) TCI state, for example, in response to the one or more configuration parameters not indicating two coreset pool indexes for the cell (or for the active downlink BWP of the cell).

The one or more configuration parameters may indicate two coreset pool indexes for the cell (or for an active downlink BWP of the cell). The two coreset pool indexes may comprise a first coreset pool index (e.g., CoresetPoolIndex=0) and a second coreset pool index (e.g., CoresetPoolIndex=1).

The wireless device may receive a first medium-access control (MAC) control element (CE) indicating mapping of a first subset of TCI states of the plurality of TCI states to one or more first TCI codepoints. The first MAC-CE may indicate activation of the first subset of TCI states for the first coreset pool index. The first subset of TCI states may comprise/be one or more first TCI states of the plurality of TCI states. The base station may transmit the first MAC-CE.

The wireless device may receive a second medium-access control (MAC) control element (CE) indicating mapping of a second subset of TCI states of the plurality of TCI states to one or more second TCI codepoints. The second MAC-CE may indicate activation of the second subset of TCI states for the second coreset pool index. The second subset of TCI states may comprise/be one or more second TCI states of the plurality of TCI states. The base station may transmit the second MAC-CE.

The wireless device may receive a first control command (e.g., MAC-CE, DCI) indicating a first TCI state among the first subset of TCI states. The base station may transmit the first control command. The first control command may indicate the first TCI state for the first coreset pool index. The first control command may indicate the first TCI state for downlink receptions and/or uplink transmissions associated with the first coreset pool index.

The first control command may be the first MAC-CE, for example, when a number of the one or more first TCI codepoints is one. The first TCI state may be the first subset of TCI states.

In an example, the first control command may be a first DCI format 1_1/1_2/1_3 different from the DCI. The first control command may be a first DCI format 1_1/1_2/1_3, for example, when a number of the one or more first TCI codepoints is greater/more than one. The wireless device may receive the first DCI format 1_1/1_2/1_3 before receiving the DCI.

The wireless device may receive a second control command (e.g., MAC-CE, DCI) indicating a second TCI state among the second subset of TCI states. The base station may transmit the second control command. The second control command may indicate the second TCI state for the second coreset pool index. The second control command may indicate the second TCI state for downlink receptions and/or uplink transmissions associated with the second coreset pool index.

The second control command may be the second MAC-CE, for example, when a number of the one or more second TCI codepoints is one. The second TCI state may be the second subset of TCI states.

In an example, the second control command may be a second DCI format 1_1/1_2/1_3 different from the DCI. The second control command may be a second DCI format 1_1/1_2/1_3, for example, when a number of the one or more second TCI codepoints is greater/more than one. The wireless device may receive the second DCI format 1_1/1_2/1_3 before receiving the DCI.

The wireless device may receive, via the cell (or via the active downlink BWP of the cell), the PDSCH reception based on (or using) a (indicated) TCI state of a coreset pool index (e.g., a default coreset pool index) among the two coreset pool indexes. For example, the (indicated) TCI state may be the first TCI state when the coreset pool index is the first coreset pool index. The (indicated) TCI state may be the second TCI state when the coreset pool index is the second coreset pool index. The wireless device may receive, via the cell (or via the active downlink BWP of the cell), the PDSCH reception based on (or using) the (indicated) TCI state of the coreset pool index, for example, in response to the one or more configuration parameters indicating two coreset pool indexes for the cell (or for the active downlink BWP of the cell). The wireless device may apply the indicated TCI state of the coreset pool index to/for the PDSCH reception. The wireless device may determine the coreset pool index based on one or more criteria discussed in FIG. 18 and FIG. 19 (e.g., the first coreset pool index, a coreset pool index of the coreset that the wireless device receives the DCI, a parameter (e.g., applyIndicatedTCIState) indicates which TCI state to apply, presence/absence of a parameter (e.g., applyIndicatedTCIState) indicates which TCI state to apply, and the like).

The TCI codepoint, of the cell, in the entry/row may indicate the TCI state of the coreset pool index. The TCI codepoint may be among one or more TCI codepoints activated for the coreset pool index.

The base station may transmit, via the cell (or via the active downlink BWP of the cell), the PDSCH transmission based on (or using) the (indicated) TCI state of the coreset pool index (e.g., a default coreset pool index) among the two coreset pool indexes. The base station may transmit, via the cell (or via the active downlink BWP of the cell), the PDSCH transmission based on (or using) the (indicated) TCI state of the coreset pool index, for example, in response to the one or more configuration parameters indicating two coreset pool indexes for the cell (or for the active downlink BWP of the cell). The base station may apply the indicated TCI state of the coreset pool index to/for the PDSCH transmission. The base station may determine the coreset pool index based on one or more criteria discussed in FIG. 18 and FIG. 19 (e.g., the first coreset pool index, a coreset pool index of the coreset that the wireless device receives the DCI, a parameter (e.g., applyIndicatedTCIState) indicates which TCI state to apply, presence/absence of a parameter (e.g., applyIndicatedTCIState) indicates which TCI state to apply, and the like).

The wireless device may transmit, via the cell (or via the active uplink BWP of the cell), the PUSCH transmission based on (or using) a (indicated) TCI state of a coreset pool index (e.g., a default coreset pool index) among the two coreset pool indexes. For example, the (indicated) TCI state may be the first TCI state when the coreset pool index is the first coreset pool index. The (indicated) TCI state may be the second TCI state when the coreset pool index is the second coreset pool index. The wireless device may transmit, via the cell (or via the active uplink BWP of the cell), the PUSCH transmission based on (or using) the (indicated) TCI state of the coreset pool index, for example, in response to the one or more configuration parameters indicating two coreset pool indexes for the cell (or for the active downlink BWP of the cell). The wireless device may apply the indicated TCI state of the coreset pool index to/for the PUSCH transmission. The wireless device may determine the coreset pool index based on one or more criteria discussed in FIG. 18 and FIG. 19 (e.g., the first coreset pool index, a coreset pool index of the coreset that the wireless device receives the DCI, a parameter (e.g., applyIndicatedTCIState) indicates which TCI state to apply, presence/absence of a parameter (e.g., applyIndicatedTCIState) indicates which TCI state to apply, and the like).

The base station may receive, via the cell (or via the active uplink BWP of the cell), the PUSCH transmission based on (or using) the (indicated) TCI state of the coreset pool index (e.g., a default coreset pool index) among the two coreset pool indexes. The base station may receive, via the cell (or via the active uplink BWP of the cell), the PUSCH transmission based on (or using) the (indicated) TCI state of the coreset pool index, for example, in response to the one or more configuration parameters indicating two coreset pool indexes for the cell (or for the active downlink BWP of the cell). The base station may apply the indicated TCI state of the coreset pool index to/for the PUSCH transmission. The base station may determine the coreset pool index based on one or more criteria discussed in FIG. 18 and FIG. 19 (e.g., the first coreset pool index, a coreset pool index of the coreset that the wireless device receives the DCI, a parameter (e.g., applyIndicatedTCIState) indicates which TCI state to apply, presence/absence of a parameter (e.g., applyIndicatedTCIState) indicates which TCI state to apply, and the like).

A wireless device may receive one or more messages comprising one or more configuration parameters. A base station may transmit, to the wireless device, the one or more messages.

The one or more configuration parameters may indicate a transmission configuration indication (TCI) table for a plurality of cells. The plurality of cells may comprise a cell.

The one or more configuration parameters may indicate two control resource set (coreset) pool indexes for the cell. The two coreset pool indexes may comprise a first coreset pool index and a second coreset pool index. The two coreset pool indexes may be two different coreset pool indexes. The one or more configuration parameters may comprise one or more physical downlink control channel (PDCCH) configuration parameters indicating/comprising/containing the two different coreset pool indexes.

The wireless device may receive a downlink control information (DCI) scheduling one or more uplink transmissions (e.g., PUSCH/PUCCH/SRS transmissions) via one or more cells of the plurality of cells. The one or more cells may comprise the cell. The DCI may schedule each uplink transmission of the one or more uplink transmissions via a respective cell of the one or more cells. The DCI may schedule an uplink transmission of the one or more uplink transmissions via the cell of the one or more cells. The base station may transmit the DCI.

Based on the cell being associated with the two coreset pool indexes, the wireless device may transmit, via the cell, the uplink transmission using a first TCI state corresponding/specific to the first coreset pool index of the two coreset pool indexes. Based on the cell being associated with the two coreset pool indexes, the wireless device may not transmit, via the cell, the uplink transmission using a second TCI state corresponding/specific to the second coreset pool index of the two coreset pool indexes.

Based on the cell being associated with the two coreset pool indexes, the base station may receive, via the cell, the uplink transmission using the first TCI state corresponding/specific to the first coreset pool index of the two coreset pool indexes. Based on the cell being associated with the two coreset pool indexes, the base station may not receive, via the cell, the uplink transmission using the second TCI state corresponding/specific to the second coreset pool index of the two coreset pool indexes.

The wireless device may receive a downlink control information (DCI) scheduling one or more downlink receptions (e.g., PDSCH/PDCCH/CSI-RS receptions) via one or more cells of the plurality of cells. The one or more cells may comprise the cell. The DCI may schedule each downlink reception of the one or more downlink receptions via a respective cell of the one or more cells. The DCI may schedule a downlink reception of the one or more downlink receptions via the cell of the one or more cells. The base station may transmit the DCI.

Based on the cell being associated with the two coreset pool indexes, the wireless device may receive, via the cell, the downlink reception using a first TCI state corresponding/specific to the first coreset pool index of the two coreset pool indexes. Based on the cell being associated with the two coreset pool indexes, the wireless device may not receive, via the cell, the downlink reception using a second TCI state corresponding/specific to the second coreset pool index of the two coreset pool indexes.

Based on the cell being associated with the two coreset pool indexes, the base station may transmit, via the cell, the downlink reception using the first TCI state corresponding/specific to the first coreset pool index of the two coreset pool indexes. Based on the cell being associated with the two coreset pool indexes, the base station may not transmit, via the cell, the downlink reception using the second TCI state corresponding/specific to the second coreset pool index of the two coreset pool indexes.

The DCI may comprise a TCI field indicating an entry in the TCI table. The entry may comprise a TCI index (or a TCI codepoint) for the cell. The TCI index may indicate a TCI state among one or more first TCI states for (or corresponding to) a first coreset pool index of the two coreset pool indexes. Based on the cell being associated with the two coreset pool indexes, the TCI index may indicate the TCI state among the one or more first TCI states for (or corresponding to) the first coreset pool index of the two coreset pool indexes.

Based on the cell being associated with the two coreset pool indexes, the wireless device may receive, via the cell, the downlink reception using the TCI state, among the one or more first TCI states for (or corresponding to) the first coreset pool index of the two coreset pool indexes, indicated by the TCI index. Based on the cell being associated with the two coreset pool indexes, the base station may transmit, via the cell, the downlink reception using the TCI state, among the one or more first TCI states for (or corresponding to) the first coreset pool index of the two coreset pool indexes, indicated by the TCI index.

When a wireless device configured/indicated/provided, by a base station, with a higher layer parameter di-OrJointTCI-StateList and a higher layer parameter PDCCH-Config that contains/comprises/includes two different values of coresetPoolIndex in ControlResourceSet for a cell (e.g., a scheduled cell) receives a DCI format 0_3 scheduling a PUSCH transmission for/on/via the cell, the wireless device may apply an indicated TCI state specific to coresetPoolIndex value 0 to/for the PUSCH transmission.

When a wireless device receives a DCI format 0_3 scheduling a PUSCH transmission for/on/via a cell, if the wireless device is configured/indicated/provided with:
a higher layer parameter dl-OrJointTCI-StateList for the cell, and
a higher layer parameter PDCCH-Config that contains/comprises/includes two different values of coresetPoolIndex in ControlResourceSet for the cell,
the wireless device may apply an indicated TCI state specific to coresetPoolIndex value 0 to/for the PUSCH transmission.

When a wireless device receives, via a CORESET with a coreset pool index, a DCI format 0_3 scheduling a PUSCH transmission for/on/via a cell, if the wireless device is configured/indicated/provided with:
a higher layer parameter dl-OrJointTCI-StateList for the cell, and
a higher layer parameter PDCCH-Config that contains/comprises/includes two different values of coresetPoolIndex in ControlResourceSet for the cell,
the wireless device may apply, to/for the PUSCH transmission, an indicated TCI state specific to a coresetPoolindex value of the CORESET.

When a wireless device receives, via a CORESET with a coreset pool index, a DCI format 0_3 scheduling a PUSCH transmission for/on/via a cell, if the wireless device is configured/indicated/provided with:
a higher layer parameter dl-OrJointTCI-StateList for the cell, and
a higher layer parameter PDCCH-Config that contains/comprises/includes two different values of coresetPoolIndex in ControlResourceSet for the cell,
the wireless device may apply, to/for the PUSCH transmission, a TCI state indicated by a higher layer parameter applyIndicatedTCIState (or applyIndicatedTCIState-DCI-0-3).

When a wireless device configured/indicated/provided, by a base station, with a higher layer parameter dl-OrJointTCI-StateList and a higher layer parameter PDCCH-Config that contains/comprises/includes two different values of coresetPoolIndex in ControlResourceSet for a cell (e.g., a scheduled cell) receives a DCI format 1_3 scheduling a PDSCH reception for/on/via the cell, the wireless device may apply an indicated TCI state specific to coresetPoolIndex value 0 to/for the PDSCH reception.

When a wireless device receives a DCI format 1_3 scheduling a PDSCH reception for/on/via a cell, if the wireless device is configured/indicated/provided with:
a higher layer parameter dl-OrJointTCI-StateList for the cell, and
a higher layer parameter PDCCH-Config that contains/comprises/includes two different values of coresetPoolIndex in ControlResourceSet for the cell,
the wireless device may apply an indicated TCI state specific to coresetPoolIndex value 0 to/for the PDSCH reception.

When a wireless device receives, via a CORESET with a coreset pool index, a DCI format 1_3 scheduling a PDSCH reception for/on/via a cell, if the wireless device is configured/indicated/provided with:
a higher layer parameter dl-OrJointTCI-StateList for the cell, and
a higher layer parameter PDCCH-Config that contains/comprises/includes two different values of coresetPoolIndex in ControlResourceSet for the cell,
the wireless device may apply, to/for the PDSCH reception, an indicated TCI state specific to a coresetPoolIndex value of the CORESET.

When a wireless device receives, via a CORESET with a coreset pool index, a DCI format 1_3 scheduling a PDSCH reception for/on/via a cell, if the wireless device is configured/indicated/provided with:
a higher layer parameter dl-OrJointTCI-StateList for the cell, and
a higher layer parameter PDCCH-Config that contains/comprises/includes two different values of coresetPoolIndex in ControlResourceSet for the cell,
the wireless device may apply, to/for the PDSCH reception, a TCI state indicated by a higher layer parameter applyIndicatedTCIState (or applyIndicatedTCIState-DCI-1-3).

When a wireless device configured by a higher layer parameter PDCCH-Config that contains/comprises/includes two different values of coresetPoolIndex in ControlResourceSet for a cell (e.g., a scheduled cell) receives a DCI format 1_3 scheduling a PDSCH reception for the cell, the ‘Transmission configuration indication’ index, for/of the scheduled cell, in a higher layer parameter tci-ListDCI-1-3 indicates a TCI state among activated TCI states corresponding to (or among a set of TCI state IDs activated for) a coresetPoolIndex value 0 for the PDSCH reception.

When a wireless device configured by a higher layer parameter PDCCH-Config that contains/comprises/includes two different values of coresetPoolIndex in ControlResourceSet for a cell (e.g., a scheduled cell) receives a DCI format 1_3 scheduling a PDSCH reception for the cell, the ‘Transmission configuration indication’ index, for/of the scheduled cell, in a higher layer parameter tci-ListDCI-1-3 indicates a TCI codepoint among activated TCI codepoints corresponding to a coresetPoolIndex value 0 for the PDSCH reception.

When a wireless device receives a DCI format 1_3 scheduling a PDSCH reception for/on/via a cell, if the wireless device:
is not configured/indicated/provided with a higher layer parameter dl-OrJointTCI-StateList for the cell, and
is configured/indicated/provided with a higher layer parameter PDCCH-Config that contains/comprises/includes two different values of coresetPoolIndex in ControlResourceSet for the cell,
the ‘Transmission configuration indication’ index, for/of the scheduled cell, in a higher layer parameter tci-ListDCI-1-3 indicates a TCI state among activated TCI states corresponding to (or among a set of TCI state IDs activated for) a coresetPoolIndex value 0 for the PDSCH reception.

When a wireless device receives a DCI format 1_3 scheduling a PDSCH reception for/on/via a cell, if the wireless device:
is configured/indicated/provided with a higher layer parameter dl-OrJointTCI-StateList for the cell, and
is configured/indicated/provided with a higher layer parameter PDCCH-Config that contains/comprises/includes two different values of coresetPoolIndex in ControlResourceSet for the cell,
the ‘Transmission configuration indication’ index, for/of the scheduled cell, in a higher layer parameter tci-ListDCI-1-3 indicates a TCI state among activated TCI states corresponding to (or among a set of TCI state IDs activated for) a coresetPoolIndex value 0.

If a wireless device is configured/indicated, by a base station, by a higher layer parameter PDCCH-Config that contains/comprises two different values of coresetPoolIndex in ControlResourceSet on/for [a downlink BWP of] a serving cell in a PUCCH group, the wireless device may not expect to be configured, by the base station, with a higher layer parameter ScheduledCell-ListDCI-0-3 or a higher layer parameter ScheduledCell-ListDCI-1-3 on any serving cell within the PUCCH group.

If a wireless device is not configured/indicated, by a base station, by a higher layer parameter PDCCH-Config that contains/comprises two different values of coresetPoolIndex in ControlResourceSet on/for [a downlink BWP of] a serving cell in a PUCCH group, the wireless device may expect to be configured, by the base station, with a higher layer parameter ScheduledCell-ListDCI-0-3 or a higher layer parameter ScheduledCell-ListDCI-1-3 on a serving cell within the PUCCH group.

If a base station transmits, to a wireless device, one or more configuration parameters comprising a higher layer parameter PDCCH-Config that contains/comprises two different values of coresetPoolIndex in ControlResourceSet on/for [a downlink BWP of] a serving cell in a PUCCH group, the one or more configuration parameters may not comprise a higher layer parameter ScheduledCell-ListDCI-0-3 or a higher layer parameter ScheduledCell-ListDCI-1-3 on/for any serving cell within the PUCCH group. The base station may not include/add, in the one or more configuration parameters, the higher layer parameter ScheduledCell-ListDCI-0-3 or the higher layer parameter ScheduledCell-ListDCI-1-3 on/for any serving cell within the PUCCH group.

If a base station does not transmit, to a wireless device, one or more configuration parameters comprising a higher layer parameter PDCCH-Config that contains/comprises two different values of coresetPoolIndex in ControlResourceSet on/for [a downlink BWP of] a serving cell in a PUCCH group, the one or more configuration parameters may or may not comprise a higher layer parameter ScheduledCell-ListDCI-0-3 or a higher layer parameter ScheduledCell-ListDCI-1-3 on/for a serving cell within the PUCCH group. The base station may or may not include/add, in the one or more configuration parameters, the higher layer parameter ScheduledCell-ListDCI-0-3 or the higher layer parameter ScheduledCell-ListDCI-1-3 on/for a serving cell within the PUCCH group.

If a wireless device is configured/indicated, by a base station, by a higher layer parameter PDCCH-Config that contains/comprises two different values of coresetPoolIndex in ControlResourceSet on/for [a downlink BWP of] a serving cell, the wireless device may not expect to be configured, by the base station, with a higher layer parameter ScheduledCell-ListDCI-0-3 or a higher layer parameter ScheduledCell-ListDCI-1-3 indicating/including the serving cell.

If a wireless device is not configured/indicated, by a base station, by a higher layer parameter PDCCH-Config that contains/comprises two different values of coresetPoolIndex in ControlResourceSet on/for [a downlink BWP of] a serving cell, the wireless device may expect to be configured, by the base station, with a higher layer parameter ScheduledCell-ListDCI-0-3 or a higher layer parameter ScheduledCell-ListDCI-1-3 indicating/including the serving cell.

If a base station transmits, to a wireless device, one or more configuration parameters comprising a higher layer parameter PDCCH-Config that contains/comprises two different values of coresetPoolIndex in ControlResourceSet on/for [a downlink BWP of] a serving cell, the one or more configuration parameters may not comprise a higher layer parameter ScheduledCell-ListDCI-0-3 or a higher layer parameter ScheduledCell-ListDCI-1-3 indicating/including the serving cell. The base station may not include/add, in the one or more configuration parameters, the higher layer parameter ScheduledCell-ListDCI-0-3 or the higher layer parameter ScheduledCell-ListDCI-1-3 indicating/including the serving cell.

If a base station does not transmit, to a wireless device, one or more configuration parameters comprising a higher layer parameter PDCCH-Config that contains/comprises two different values of coresetPoolIndex in ControlResourceSet on/for [a downlink BWP of] a serving cell, the one or more configuration parameters may or may not comprise a higher layer parameter ScheduledCell-ListDCI-0-3 or a higher layer parameter ScheduledCell-ListDCI-1-3 indicating/including the serving cell. The base station may or may not include/add, in the one or more configuration parameters, the higher layer parameter ScheduledCell-ListDCI-0-3 or the higher layer parameter ScheduledCell-ListDCI-1-3 indicating/including the serving cell.

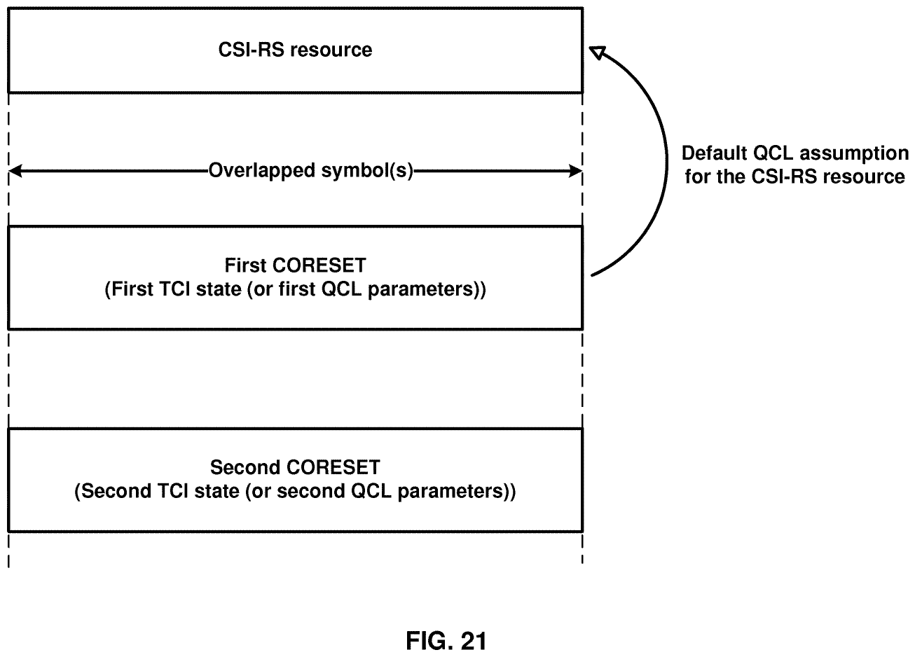

FIG. 21 illustrates an example flow chart of CSI-RS reception as per an aspect of an embodiment of the present disclosure.

The plurality of coresets of the (active) downlink BWP of the cell may comprise at least two coresets. The at least two coresets may comprise a first coreset (e.g., First CORESET in FIG. 21) and a second coreset (e.g., Second CORESET in FIG. 21).

The first coreset may be associated with (or mapped to or linked to) a first search space set. The one or more configuration parameters may indicate, for the first search space set, the first coreset. The one or more configuration parameters may indicate, for the first search space set, a first search space identifier/index.

The second coreset may be associated with (or mapped to or linked to) a second search space set. The one or more configuration parameters may indicate, for the second search space set, the second coreset. The one or more configuration parameters may indicate, for the second search space set, a second search space identifier/index.

The one or more configuration parameters may not comprise/indicate, for a CSI-RS resource set (e.g., NZP-CSI-RS-ResourceSet), a higher layer repetition parameter set to ‘on’. The one or more configuration parameters may not comprise/indicate a higher layer repetition parameter, of the CSI-RS resource set, set to ‘on’. The one or more configuration parameters may indicate, for the CSI-RS resource set, a repetition. The CSI-RS resource set may comprise/indicate an CSI-RS resource,

The CSI-RS resource (e.g., CSI-RS resource in FIG. 21) and the at least two control resource sets may overlap in time. The CSI-RS resource and the at least two control resource sets may overlap, for example, in at least one symbol (e.g., at least one OFDM symbol). The CSI-RS resource and the at least two control resource sets may be in the same symbols.

The CSI-RS resource may overlap in at least one symbol with each coreset of the at least two control resource sets.

The CSI-RS resource, the first search space set associated with the first coreset and the second search space set associated with the second coreset may be in the same symbols.

The CSI-RS resource may overlap in at least one symbol with the first search space set associated with the first coreset and the second search space set associated with the second coreset. The CSI-RS resource may overlap in at least one symbol with a first PDCCH monitoring occasion of the first search space set and a second PDCCH monitoring occasion of the second search space set associated with the second coreset.

The CSI-RS resource and the at least two coresets may be (configured), for example, in the same cell. The CSI-RS resource and the at least two coresets may be (configured), for example, in different cells in the same band (e.g., intra-band). The CSI-RS resource and at least one coreset of the at least two coresets may be (configured), for example, in the same cell. The CSI-RS resource and at least one coreset of the at least two coresets may be (configured), for example, in different cells in the same band (e.g., intra-band).

In an example, the first coreset and the second coreset may be in the same cell. The one or more configuration parameters may indicate, for the cell (or for the same cell), the first coreset and the second coreset. In an example, the first coreset and the second coreset may be in different cells in the same band (or in the same frequency band). The one or more configuration parameters may indicate, for different cells in the same band (or in the same frequency band), the first coreset and the second coreset.

The first coreset may have a first quasi co-location parameter (e.g., qcl-Type) set to one or more first quasi co-location properties (e.g., first ‘typeD’ properties). In an example, the one or more configuration parameters may indicate, for the first coreset, the first quasi co-location parameter. In an example, the wireless device may receive a first control command (e.g., MAC-CE, DCI) indicating a first TCI state for the first coreset. The first TCI state may indicate/have/comprise the first quasi co-location parameter. The one or more configuration parameters may indicate, for the first TCI state, the first quasi co-location parameter. The first TCI state may indicate/comprise the one or more first quasi co-location properties.

The one or more first quasi co-location properties may comprise/indicate, for example, a first spatial receiving/reception/receive parameter.

The wireless device may monitor, via the first coreset, downlink control channels based on (or using) the one or more first quasi co-location properties. The wireless device may receive/detect, via the first coreset, first PDCCH receptions (e.g., DCI) based on (or using) the one or more first quasi co-location properties.

The second coreset may have a second quasi co-location parameter (e.g., qcl-Type) set to one or more second quasi co-location properties (e.g., second ‘typeD’ properties). In an example, the one or more configuration parameters may indicate, for the second coreset, the second quasi co-location parameter. In an example, the wireless device may receive a second control command (e.g., MAC-CE, DCI) indicating a second TCI state for the second coreset. The second TCI state may indicate/have/comprise the second quasi co-location parameter. The one or more configuration parameters may indicate, for the second TCI state, the second quasi co-location parameter. The second TCI state may indicate/comprise the one or more second quasi co-location properties.

The one or more first quasi co-location properties and the one or more second quasi co-location properties may be different.

The one or more second quasi co-location properties may comprise/indicate, for example, a second spatial receiving/reception/receive parameter.

The wireless device may monitor, via the second coreset, downlink control channels based on (or using) the one or more second quasi co-location properties. The wireless device may receive/detect, via the second coreset, second PDCCH receptions (e.g., DCI) based on (or using) the one or more second quasi co-location properties.

The wireless device may monitor, in/via the first coreset with the one or more first quasi co-location properties, a first PDCCH candidate in a first PDCCH monitoring occasion, for example, on/via the active downlink BWP of the cell. The wireless device may monitor, in/via the second coreset with the one or more second quasi co-location properties, a second PDCCH candidate in a second PDCCH monitoring occasion, for example, on/via the active downlink BWP of the cell. The first PDCCH monitoring occasion and the second PDCCH monitoring occasion may overlap in time (or in at least one symbol).

Based on the CSI-RS resource and the at least two control resource sets overlapping in time (or in at least one symbol), the wireless device may receive, via the CSI-RS resource, a CSI-RS using the one or more first quasi co-location properties of the first coreset of the at least two coresets. Based on the CSI-RS resource and the at least two control resource sets being in the same symbols, the wireless device may receive, via the CSI-RS resource, the CSI-RS using the one or more first quasi co-location properties of the first coreset of the at least two coresets. The wireless device may not receive, via the CSI-RS resource, the CSI-RS using the one or more second quasi co-location properties of the second coreset of the at least two coresets.

In an example, the one or more configuration parameters may indicate, for the first coreset, a first coreset index/identifier. The one or more configuration parameters may indicate, for the second coreset, a second coreset index/identifier. The first coreset index/identifier may be lower/smaller than the second coreset index/identifier. When the CSI-RS resource and the at least two control resource sets are in the same symbols, the wireless device may receive, via the CSI-RS resource, the CSI-RS using the one or more first quasi co-location properties of the first coreset of the at least two coresets, for example, based on the first coreset index/identifier being lower/smaller than the second coreset index/identifier of the second coreset.

The one or more configuration parameters may indicate, for the cell, both the first search space set and the second search space set. The first search space index/identifier may be lower/smaller than the second search space index/identifier. When the CSI-RS resource and the at least two control resource sets are in the same symbols, the wireless device may receive, via the CSI-RS resource, the CSI-RS using the one or more first quasi co-location properties of the first coreset of the at least two coresets, for example, based on the first search space index/identifier of the first search space set associated with the first coreset being lower/smaller than the second search space index/identifier of the second search space set associated with the second coreset.

The one or more configuration parameters may indicate, for a first cell, the first search space set. The first cell may comprise the first coreset associated with the first search space set. The one or more configuration parameters may indicate a first serving cell index/identifier for the first cell. The one or more configuration parameters may indicate, for a second cell, the second search space set. The second cell may comprise the second coreset associated with the second search space set. The one or more configuration parameters may indicate a second serving cell index/identifier for the second cell. The first serving cell index/identifier of the first cell may be lower/smaller than the second serving cell index/identifier of the second cell. When the CSI-RS resource and the at least two control resource sets are in the same symbols, the wireless device may receive, via the CSI-RS resource, the CSI-RS using the one or more first quasi co-location properties of the first coreset of the at least two coresets, for example, based on the first serving cell index/identifier of the first cell comprising the first coreset being lower/smaller than the second serving cell index/identifier of the second cell comprising the second coreset.

In an example, the first search space set may be a CSS set. The second search space set may be a USS set. When the CSI-RS resource and the at least two control resource sets are in the same symbols, the wireless device may receive, via the CSI-RS resource, the CSI-RS using the one or more first quasi co-location properties of the first coreset of the at least two coresets, for example, based on the first search space set associated with the first coreset being a CSS set. When the CSI-RS resource and the at least two control resource sets are in the same symbols, the wireless device may receive, via the CSI-RS resource, the CSI-RS using the one or more first quasi co-location properties of the first coreset of the at least two coresets, for example, based on the second search space set associated with the second coreset being a USS set.

The one or more first quasi co-location properties of the first coreset may be a default quasi co-location assumption for reception of the CSI-RS.

In an example, the CSI-RS (or a CSI-RS port of the CSI-RS) and at least one DM-RS (or DM-RS port or DM-RS antenna port) of a PDCCH reception in/via the first coreset may be quasi co-located with a first quasi co-location type (e.g., type D). In an example, the CSI-RS and at least one DM-RS of a PDCCH reception in the first search space set associated with the first coreset may be quasi co-located with a first quasi co-location type (e.g., type D). In an example, the CSI-RS and at least one DM-RS of a PDCCH reception in each search space set associated with the first coreset may be quasi co-located with a first quasi co-location type (e.g., type D). The wireless device may receive, via the first coreset, the PDCCH reception with a first spatial domain receiving/reception filter that is the same (or substantially same) as a spatial domain receiving/reception filter of the CSI-RS. The wireless device may receive the CSI-RS with the first spatial domain receiving/reception filter that is used to receive the PDCCH reception via the first coreset. The wireless device may apply the first spatial domain receiving/reception filter to both the PDCCH reception in/via the first coreset and reception of the CSI-RS. The wireless device may apply the first spatial domain receiving/reception filter to both the PDCCH reception in/via the first coreset and reception of the CSI-RS in the overlapped symbol(s) (or in the at least one symbol).

In an example, the one or more configuration parameters may comprise a PDCCH repetition parameter (e.g., twoQCLTypeDforPDCCHRepetition). The one or more configuration parameters may indicate, for the first search space set of the first coreset, a first search space linking identifier (e.g., search SpaceLinkingId). The one or more configuration parameters may indicate, for the second search space set of the second coreset, a second search space linking identifier that is the same (or equal to) the first search space linking identifier.

The first search space set associated with (or corresponding to) the first coreset may be, for example, a common search space (CSS) set with a lowest search space set index in the cell with a lowest cell index among one or more cells comprising CSS sets.

The first search space set may be, for example, a user-specific search space (USS) set with a lowest search space set index in the cell with a lowest cell index among one or more cells comprising USS sets. The first search space set may be the USS set, for example, based on both the first search space set and the second search space set being USS sets.

Excluding the first search space set and any other search space set with the one or more first quasi co-location properties, the second search space set may be, for example, a common search space (CSS) set with a lowest search space set index in the cell with a lowest cell index among one or more cells comprising CSS sets.

Excluding the first search space set and any other search space set with the one or more first quasi co-location properties, the second search space set may be, for example, a user-specific search space (USS) set with a lowest search space set index in the cell with a lowest cell index among one or more cells comprising USS sets.

If a wireless device:
is configured for single cell operation or for operation with carrier aggregation in a same frequency band,
monitors PDCCH candidates in overlapping PDCCH monitoring occasions in multiple coresets that have been configured with same or different qcl-Type set to ‘typeD’ properties on active DL BWP(s) of one or more cells, and
is provided a higher layer parameter twoQCLTypeDforPDCCHRepetition, the wireless device may monitor PDCCHs only in a first coreset with qcl-Type set to first ‘typeD’ properties and, if any, in a second coreset with qcl-Type set to second ‘typeD’ properties that are different than the first ‘typeD’ properties, and in any other coreset from the multiple coresets with corresponding qcl-Type set to either the first ‘typeD’ properties or to the second ‘typeD’ properties.
the first coreset may corresponds to a CSS set with the lowest index in a cell with the lowest index containing CSS sets, if any; otherwise, to a USS set with the lowest index in a cell with lowest index
excluding CSS sets and USS sets associated with coresets with qcl-Type set to first ‘typeD’ properties, the second coreset may correspond to the CSS set with the lowest index in a cell with the lowest index containing CSS sets, if any; otherwise, to a USS set with the lowest index in a cell with lowest index, where the CSS set or the USS set may include a higher layer parameter search SpaceLinkingId with same value as any CSS set or any USS set associated with coresets with qcl-Type set to first ‘typeD’ properties.
the lowest USS set index may be determined over all USS sets with at least one PDCCH candidate in overlapping PDCCH monitoring occasions.

The higher layer parameter twoQCLTypeDforPDCCHRepetition may indicate whether a wireless device is expected to identify and monitor two QCL-TypeD properties for multiple overlapping coresets in the case of PDCCH repetition.

The one or more configuration parameters may indicate, for the first coreset, a first coreset pool index (e.g., CoresetPoolIndex=0). The one or more configuration parameters may indicate, for the second coreset, a second coreset pool index (e.g., CoresetPoolIndex=0).

When the CSI-RS resource and the at least two control resource sets are in the same symbols, the wireless device may receive, via the CSI-RS resource, the CSI-RS using the one or more first quasi co-location properties of the first coreset of the at least two coresets, for example, based on the one or more configuration parameters indicating, for the first coreset, the first coreset pool index. When the CSI-RS resource and the at least two control resource sets are in the same symbols, the wireless device may not receive, via the CSI-RS resource, the CSI-RS using the one or more second quasi co-location properties of the second coreset of the at least two coresets, for example, based on the one or more configuration parameters indicating, for the second coreset, the second coreset pool index.

The one or more configuration parameters may comprise a higher layer parameter twoQCLTypeDforMulti-DCI. The higher layer parameter twoQCLTypeDforMulti-DCI may indicate whether a wireless device is expected to identify and monitor two QCL-TypeD properties for multiple overlapping coresets associated with two different coreset pool indexes.

If a wireless device:
is configured for single cell operation or for operation with carrier aggregation in a same frequency band, and
monitors PDCCH candidates in overlapping PDCCH monitoring occasions in multiple coresets with a CoresetPoolIndex value 0 and that have been configured with same or different qcl-Type set to ‘typeD’ properties on active DL BWP(s) of one or more cells,
the wireless device may monitor PDCCHs only in a first coreset with the CoresetPoolIndex value 0, and in any other coreset from the multiple coresets that have been configured with qcl-Type set to the same first ‘typeD’ properties as the first coreset, on the active DL BWP of a cell from the one or more cells:
the first coreset may correspond to a CSS set with the lowest index in a cell with the lowest index containing CSS, if any; otherwise, to a USS set with the lowest index in a cell with lowest index,
the lowest USS set index may be determined over all USS sets with at least one PDCCH candidate in overlapping PDCCH monitoring occasions.

If a wireless device:
is configured for single cell operation or for operation with carrier aggregation in a same frequency band, and
monitors PDCCH candidates in overlapping PDCCH monitoring occasions in multiple coresets with a CoresetPoolIndex value 1 and that have been configured with same or different qcl-Type set to ‘typeD’ properties on active DL BWP(s) of one or more cells,
the wireless device may monitor PDCCHs only in a second coreset with the CoresetPoolIndex value 1, and in any other coreset from the multiple coresets that have been configured with qcl-Type set to the same second ‘typeD’ properties as the second coreset, on the active DL BWP of a cell from the one or more cells:
the second coreset may correspond to a CSS set with the lowest index in a cell with the lowest index containing CSS, if any; otherwise, to a USS set with the lowest index in a cell with lowest index,
the lowest USS set index may be determined over all USS sets with at least one PDCCH candidate in overlapping PDCCH monitoring occasions.

If a wireless device:
is configured for single cell operation or for operation with carrier aggregation in a same frequency band, and
monitors PDCCH candidates in overlapping PDCCH monitoring occasions in multiple CORESETs and that have been configured with same or different qcl-Type set to ‘typeD’ properties on active DL BWP(s) of one or more cells,
the wireless device may monitor PDCCHs only in a CORESET, and in any other CORESET from the multiple CORESETs that have been configured with qcl-Type set to same ‘typeD’ properties as the CORESET, on the active DL BWP of a cell from the one or more cells:
the CORESET may correspond to a CSS set with the lowest index in a cell with the lowest index containing CSS, if any; otherwise, to a USS set with the lowest index in a cell with lowest index,
the lowest USS set index may be determined over all USS sets with at least one PDCCH candidate in overlapping PDCCH monitoring occasions.
If the wireless device:
is not provided coresetPoolIndex for first CORESETs, or is provided coresetPoolIndex with value 0 for first CORESETs, and
is provided coresetPoolIndex with value 1 for second CORESETs, and
is provided a higher layer parameter twoQCLTypeDforMulti-DCI
the wireless device may apply procedures described above independently across the first CORESETs and the second CORESETs.

Based on a channel state information reference signal (CSI-RS) resource and at least two control resource sets being in the same symbols, a wireless device may receive, via/in the CSI-RS resource, a CSI-RS using one or more first quasi co-location properties of a first coreset of the at least two coresets.

Based on a channel state information reference signal (CSI-RS) resource and at least two control resource sets being in the same symbols, a base station may transmit, to a wireless device and via/in the CSI-RS resource, a CSI-RS using one or more first quasi co-location properties of a first coreset of the at least two coresets.

The CSI-RS may be used, by the wireless device and/or the base station, for time/frequency tracking, CSI computation, L1-RSRP computation, L1-SINR computation, mobility, and tracking during fast SCell activation.

For a CSI-RS resource associated with a NZP-CSI-RS-ResourceSet with a higher layer parameter repetition set to ‘on’, the wireless device may not expect to be configured with CSI-RS over symbol(s) during which the wireless device is also configured to monitor a CORESET, while for other NZP-CSI-RS-ResourceSet configurations, if the wireless device is configured with a CSI-RS resource and a search space set associated with a CORESET in the same OFDM symbol(s), the wireless device may assume that a CSI-RS via the CSI-RS resource and a PDCCH DM-RS transmitted in all the search space sets associated with CORESET are quasi co-located with ‘typeD’, if ‘typeD’ is applicable. If the CORESET is activated with two TCI states, the wireless device may assume that the first TCI state of the CORESET as the default QCL assumption for the CSI-RS. This may also apply to the case when the CSI-RS (or the CSI-RS resource) and the CORESET are in different intra-band component carriers, if ‘typeD’ is applicable. If the CSI-RS resource, the first CORESET with qcl-Type set to first ‘typeD’ properties and the second CORESET with qcl-Type set to second ‘typeD’ properties are in the same OFDM symbol(s), the wireless device may assume the first ‘typeD’ properties of the first CORESET as the default QCL assumption for the CSI-RS.

For a CSI-RS resource associated with a NZP-CSI-RS-ResourceSet with a higher layer parameter repetition set to ‘on’, the wireless device may not expect to be configured with CSI-RS over symbol(s) during which the wireless device is also configured to monitor a CORESET, while for other NZP-CSI-RS-ResourceSet configurations, if the wireless device is configured with a CSI-RS resource and a search space set associated with a CORESET in the same OFDM symbol(s), the wireless device may assume that a CSI-RS via the CSI-RS resource and a PDCCH DM-RS transmitted in all the search space sets associated with CORESET are quasi co-located with ‘typeD’, if ‘typeD’ is applicable. If the CORESET is activated with two TCI states, the wireless device may assume that the first TCI state of the CORESET as the default QCL assumption for the CSI-RS. This may also apply to the case when the CSI-RS (or the CSI-RS resource) and the CORESET are in different intra-band component carriers, if ‘typeD’ is applicable. If the CSI-RS resource, a first search space set associated with the first CORESET with qcl-Type set to first ‘typeD’ properties and a second search space set associated with the second CORESET with qcl-Type set to second ‘typeD’ properties are in the same OFDM symbol(s), the wireless device may assume the first ‘typeD’ properties of the first CORESET as the default QCL assumption for the CSI-RS.

What is claimed is:

1. A wireless device comprising:
one or more processors; and
memory storing instructions that, when executed by the one or more processors, cause the wireless device to:
receive one or more radio resource control (RRC) messages comprising one or more configuration parameters for a set of cells for multi-cell physical downlink shared channel (PDSCH) scheduling from a serving cell, wherein the one or more configuration parameters comprise:
a scheduled cell list parameter indicating a list of possible co-scheduled cells, in the set of cells, for downlink scheduling via a downlink control information (DCI) format, wherein serving cells in the list are in an ascending order of serving cell indexes of the serving cells; and
a transmission configuration indication (TCI) list parameter indicating a joint TCI table for downlink scheduling via the DCI format, wherein:
each entry in the joint TCI table comprises a respective TCI index for each cell in the set of cells; and
TCI indexes for the serving cells are placed according to an ascending order of the serving cell indexes;
receive a DCI with the DCI format, wherein the DCI:
comprises a TCI field indicating an entry in the joint TCI table, wherein a number of bits in the TCI field is determined based on a number of entries in the joint TCI table; and
indicates one or more TCI states for one or more serving cells in the set of cells based on the DCI scheduling a PDSCH reception via at least one serving cell in the set of cells; and
receive the PDSCH reception.

2. The wireless device of claim 1, wherein the one or more RRC messages comprise a cell set list parameter indicating configurations of a list of sets of cells for the multi-cell PDSCH scheduling from the serving cell, wherein the list of sets of cells comprises the set of cells.

3. The wireless device of claim 2, wherein the DCI comprises a scheduled cell set indicator field indicating the set of cells among the list of sets of cells.

4. The wireless device of claim 2, wherein the instructions further cause the wireless device to report, to a base station, a maximum number of sets of cells in the list of sets of cells.

5. The wireless device of claim 1, wherein the DCI format is used for scheduling:
one PDSCH in one cell; or
multiple PDSCHs in multiple cells with one PDSCH per cell.

6. The wireless device of claim 1, wherein the DCI further indicates, for each cell of the one or more serving cells, a respective TCI state of the one or more TCI states.

7. The wireless device of claim 1, wherein:
the entry in the joint TCI table comprises one or more TCI indexes indicating the one or more TCI states; and
each TCI index, of the one or more TCI indexes, indicates a respective TCI state of the one or more TCI states.

8. A method comprising:
receiving, by a wireless device, one or more radio resource control (RRC) messages comprising one or more configuration parameters for a set of cells for multi-cell physical downlink shared channel (PDSCH) scheduling from a serving cell, wherein the one or more configuration parameters comprise:
a scheduled cell list parameter indicating a list of possible co-scheduled cells, in the set of cells, for downlink scheduling via a downlink control information (DCI) format, wherein serving cells in the list are in an ascending order of serving cell indexes of the serving cells; and
a transmission configuration indication (TCI) list parameter indicating a joint TCI table for downlink scheduling via the DCI format, wherein:
each entry in the joint TCI table comprises a respective TCI index for each cell in the set of cells; and
TCI indexes for the serving cells are placed according to an ascending order of the serving cell indexes;
receiving a DCI with the DCI format, wherein the DCI:
comprises a TCI field indicating an entry in the joint TCI table, wherein a number of bits in the TCI field is determined based on a number of entries in the joint TCI table; and
indicates one or more TCI states for one or more serving cells in the set of cells based on the DCI scheduling a PDSCH reception via at least one serving cell in the set of cells; and
receiving the PDSCH reception.

9. The method of claim 8, wherein the one or more RRC messages comprise a cell set list parameter indicating configurations of a list of sets of cells for the multi-cell PDSCH scheduling from the serving cell, wherein the list of sets of cells comprises the set of cells.

10. The method of claim 9, wherein the DCI comprises a scheduled cell set indicator field indicating the set of cells among the list of sets of cells.

11. The method of claim 9, further comprising reporting, to a base station, a maximum number of sets of cells in the list of sets of cells.

12. The method of claim 8, wherein the DCI format is used for scheduling:
one PDSCH in one cell; or
multiple PDSCHs in multiple cells with one PDSCH per cell.

13. The method of claim 8, wherein the DCI further indicates, for each cell of the one or more serving cells, a respective TCI state of the one or more TCI states.

14. The method of claim 8, wherein:
the entry in the joint TCI table comprises one or more TCI indexes indicating the one or more TCI states; and
each TCI index, of the one or more TCI indexes, indicates a respective TCI state of the one or more TCI states.

15. A non-transitory computer-readable medium comprising instructions that, when executed by one or more processors of a wireless device, cause the wireless device to:
receive one or more radio resource control (RRC) messages comprising one or more configuration parameters for a set of cells for multi-cell physical downlink shared channel (PDSCH) scheduling from a serving cell, wherein the one or more configuration parameters comprise:
a scheduled cell list parameter indicating a list of possible co-scheduled cells, in the set of cells, for downlink scheduling via a downlink control information (DCI) format, wherein serving cells in the list are in an ascending order of serving cell indexes of the serving cells; and
a transmission configuration indication (TCI) list parameter indicating a joint TCI table for downlink scheduling via the DCI format, wherein:
each entry in the joint TCI table comprises a respective TCI index for each cell in the set of cells; and
TCI indexes for the serving cells are placed according to an ascending order of the serving cell indexes;
receive a DCI with the DCI format, wherein the DCI:
comprises a TCI field indicating an entry in the joint TCI table, wherein a number of bits in the TCI field is determined based on a number of entries in the joint TCI table; and
indicates one or more TCI states for one or more serving cells in the set of cells based on the DCI scheduling a PDSCH reception via at least one serving cell in the set of cells; and
receive the PDSCH reception.

16. The non-transitory computer-readable medium of claim 15, wherein the one or more RRC messages comprise a cell set list parameter indicating configurations of a list of sets of cells for the multi-cell PDSCH scheduling from the serving cell, wherein the list of sets of cells comprises the set of cells.

17. The non-transitory computer-readable medium of claim 16, wherein the DCI comprises a scheduled cell set indicator field indicating the set of cells among the list of sets of cells.

18. The non-transitory computer-readable medium of claim 16, wherein the instructions further cause the wireless device to report, to a base station, a maximum number of sets of cells in the list of sets of cells.

19. The non-transitory computer-readable medium of claim 15, wherein the DCI format is used for scheduling:
one PDSCH in one cell; or
multiple PDSCHs in multiple cells with one PDSCH per cell.

20. The non-transitory computer-readable medium of claim 15, wherein the DCI further indicates, for each cell of the one or more serving cells, a respective TCI state of the one or more TCI states.
